(19) United States
(12) Patent Application Publication
(10) Pub. No.: US 2016/0021303 A1
(43) Pub. Date: Jan. 21, 2016

(54) Enhanced low light photography system

(71) Applicants: Gary Edwin Sutton, La Jolla, CA (US); Douglas Gene Lockie, Los Gatos, CA (US)

(72) Inventors: Gary Edwin Sutton, La Jolla, CA (US); Douglas Gene Lockie, Los Gatos, CA (US)

(21) Appl. No.: 14/120,986

(22) Filed: Jul. 18, 2014

(51) Int. Cl. H04N 5/232; H04N 5/238; G03B 7/093

(52) U.S. Cl. CPC H04N 5/23229; G03B 7/093; H04N 5/23293; H04N 5/238

(57) ABSTRACT

One embodiment of the present invention comprises methods and apparatus for a camera that includes a curved sensor. This first embodiment samples the output of a group of pixels on the curved sensor. The output of the pixels is compared to a predetermined setting that establishes the maximum amount of unwanted motion that is to be allowed in an exposure. If the output is below the predetermined setting, a signal processor, which is connected to the output of the pixels, instructs a shutter means control to increase the duration of the exposure.

### CROSS-REFERENCE TO RELATED PENDING PATENT APPLICATIONS, CLAIMS FOR PRIORITY & INCORPORATION BY REFERENCE

The Present Continuation-in-Part patent application is based on U.S. Ser. No. 13/998,980, and is related to:
Pending U.S. Non-Provisional patent application Ser. No. 13/998,980, filed on 27 Dec. 2013 (CIPB CIPA REV ONE);
Pending U.S. Non-Provisional patent application Ser. No. 13/987,697, filed on 20 Aug. 2013 (CIPA DIV ONE);
Pending U.S. Non-Provisional application Ser. No. 13/694,152, filed on 30 Oct. 2012 (NP-CIPA);
Pending U.S. Non-Provisional application Ser. No. 13/507,674, filed on 17 Jul. 2012 (CIPE);
Pending U.S. Non-Provisional application Ser. No. 13/506,485, filed on 19 Apr. 2012; (CON D);
Pending U.S. Non-Provisional application Ser. No. 13/507,969, filed on 8 Aug. 2012 (CIPC DIV ONE);
Pending U.S. Non-Provisional application Ser. No. 13/135,402, filed on 30 Jun. 2011; (CIPC)
Pending U.S. Non-Provisional application Ser. No. 13/065,477, filed on 21 Mar. 2011; (CIPB)
Pending U.S. Non-Provisional application Ser. No. 12/930,165, filed on 28 Dec. 2010; (CIPA)
Pending U.S. Non-Provisional application Ser. No. 12/655,819, filed on 6 Jan. 2010; (Parent)
Provisional Patent Application 61/208,456, filed on 23 Feb. 2009, now abandoned.

In accordance with the provisions of Sections 119 and/or 120 of Title 35 of the United States Code of Laws, the Inventors claim the benefit of priority for any and all subject matter which is commonly disclosed in the Present patent application, and in any of the related patent applications and/or Grants identified above.

The subject matter of the patent applications identified above are hereby incorporated by reference.

### FIELD OF THE INVENTION

One embodiment of the present invention pertains to the sampling of the changes in light intensity experienced by pixels of a curved sensor. These changes, once detected, indicate the amount of unwanted motion of the image viewed by the sensor. If the light intensity is insufficient for a given shutter speed, and if a relatively small amount of movement is detected during the sampling, a longer shutter speed is activated to insure the capture of the image.

### INTRODUCTION

The title of this Continuation-in-Part patent application is Enhanced Low Light Photography System. The Inventors are:
Gary Edwin Sutton of 1865 Caminito Ascua, La Jolla, Calif. 92037; and
Douglas Gene Lockie of 19267 Mountain Way, Los Gatos, Calif. 95030.
Both Inventors are Citizens of the United States of America.

### FEDERALLY SPONSORED RESEARCH OR DEVELOPMENT

None.

### BACKGROUND OF THE INVENTION

### I. A Brief History of Cameras

### Evolution of the Three Primary Camera Types

Current photographic cameras evolved from the first “box” and “bellows” models into three basic formats by the late twentieth century.

The rangefinder came first. It was followed by the SLR, or, single lens reflex and finally the Compact “Point and Shoot” cameras. Most portable cameras today use rangefinder, SLR or “Point and Shoot” formats.

### Simple Conventional Cameras

FIG. 1 is a simplified view of a conventional camera, which includes an enclosure, an objective lens and a flat section of photographic film or a flat sensor.

A simple lens with a flat film or sensor faces several problems. Light travels over a longer pathway to the edges of the film or the sensor's image area, diluting those rays. Besides being weaker, as those rays travel farther to the sensor's edges, they suffer more “rainbow effect,” or chromatic aberration.

FIG. 2 presents a simplified view of the human eye, which includes a curved surface for forming an image. The human eye, for example, needs only a cornea and a single lens to form an image. But on average, one human retina contains twenty-five million rods and six million cones. Today's high end cameras use lenses with from six to twenty elements. Only the rarest, most expensive cameras have as many pixels as the eye has rods and cones, and none of these cameras capture images after sunset without artificial light.

The eagle's retina has eight times as many retinal sensors as the human eye. They are arranged on a sphere the size of a marble. The eagle's rounded sensors make simpler optics possible. No commercially available camera that is available today has a pixel count which equals a fourth of the count of sensors in an eagle's eye. The eagle eye uses a simple lens and a curved retina. The best conventional cameras use multiple element lenses with sophisticated coatings, exotic materials and complex formulas. This is all to compensate for their flat sensors. The eagle sees clearly at noon, in daylight or at dusk with simpler, lighter and smaller optics than any camera.

### Rangefinder Cameras

Rangefinder cameras are typified by a broad spectrum from the early LEICA™ thirty-five millimeter cameras, for professionals, to the later “INSTAMATIC™” film types for the masses. (Most of KODAK'S™ INSTAMATIC™ cameras did not focus, so they were not true rangefinders. A few “Instamatic type” models focused, and had a “viewing” lens separated from the “taking” lens, qualifying them as rangefinders.)

Rangefinder cameras have a “taking” lens to put the image on the film (or sensor today) when the shutter opens and closes; mechanically or digitally. These cameras use a second lens for viewing the scene. Focusing takes place through this viewing lens which connects to, and focuses, the taking lens.

Since the taking lens and the viewing lens are different, and have different perspectives on the scene being photographed, the taken image is always slightly different than the viewed image. This problem, called parallax, is minor in most situations but becomes acute at close distances.

Longer telephoto lenses, which magnify more, are impractical for rangefinder formats. This is because two lenses are required, they are expensive and require more side-to-side space than exists within the camera body. That's why no long telephoto lenses exist for rangefinder cameras.

Some rangefinder cameras use a frame in the viewfinder which shifts the border to match that of the taking lens as the focus changes. This aligns the view with the picture actually taken, but only for that portion that's in focus. Backgrounds and foregrounds that are not in focus shift, so those parts of the photographed image still vary slightly from what was seen in the viewfinder.

A few rangefinder cameras do exist that use interchangeable or attachable lenses, but parallax remains an unsolvable problem and so no manufacturer has ever successfully marketed a rangefinder camera with much beyond slightly wide or mildly long telephoto accessories. Any added rangefinder lens must also be accompanied by a similar viewfinder lens. If not, what is viewed won't match the photograph taken at all. This doubles the lens cost.

A derivation of the rangefinder, with the same limitations for accessory lenses, was the twin lens reflex, such as those made by ROLLEI-WERKE™ cameras.

### Compact, or “Point and Shoot” Cameras

Currently, the most popular format for casual photographers is the “Point and Shoot” camera. They emerged first as film cameras but are now nearly all digital. Many have optical zoom lenses permanently attached with no possibility for interchanging optics. The optical zoom, typically, has a four to one range, going from slight wide angle to mild telephoto perspectives. Optical zooms don't often go much beyond this range for acceptable results and speed. Some makers push optical zoom beyond this four to one range, but the resulting images and speeds deteriorate. Others add digital zoom to enhance their optical range; causing results that most trade editors and photographers currently hate, for reasons described in following paragraphs.

There are no “Point and Shoot” cameras with wide angle lenses as wide as the perspective are for an eighteen millimeter SLR lens (when used, for relative comparison, on the old standard thirty-five millimeter film SLR cameras.) There are no “Point and Shoot” cameras with telephoto lenses as long as a two hundred millimeter SLR lens would have been (if on the same old thirty-five millimeter film camera format.)

Today, more photographs are taken daily by mobile phones and PDAs than by conventional cameras. These will be included in the references herein as “Point and Shoot Cameras.”

### Single Lens Reflex (SLR) Cameras

Single lens reflex cameras are most commonly used by serious amateurs and professionals today since they can use wide selections of accessory lenses.

With 35 mm film SLRs, these lenses range from 18 mm “fisheye” lenses to 1,000 mm super-telephoto lenses, plus optical zooms that cover many ranges in between.

With most SLRs there's a mirror behind the taking lens which reflects the image into a viewfinder. When the shutter is pressed, this mirror flips up and out of the way, so the image then goes directly onto the film or sensor. In this way, the viewfinder shows the photographer almost the exact image that will be taken, from extremes in wide vistas to distant telephoto shots. The only exception to an “exact” image capture comes in fast action photography, when the delay caused by the mirror movement can result in the picture taken being slightly different than that image the photographer saw a fraction of a second earlier.

This ability to work with a large variety of lenses made the SLR a popular camera format of the late twentieth century, despite some inherent disadvantages.

Those SLR disadvantages are the complexity of the mechanism, requiring more moving parts than with other formats, plus the noise, vibration and delay caused by the mirror motion. Also, lens designs are constrained, due to the lens needing to be placed farther out in front of the path of the moving mirror, which is more distant from the film or sensor, causing lenses to be heavier, larger and less optimal without lens fogging. There is also the introduction of dust, humidity and other foreign objects into the camera body and on the rear lens elements when lenses are changed.

Dust became a worse problem when digital SLRs arrived, since the sensor is fixed, unlike film. Film could roll away the dust speck so only one frame was affected. With digital cameras, every picture is spotted until the sensor is cleaned. Recent designs use intermittent vibrations to clear the sensor. This doesn't remove the dust from the camera and fails to remove oily particles. Even more recent designs, recognizing the seriousness of this problem, have adhesive strips inside the cameras to capture the dust if it is vibrated off from the sensor. These adhesive strips, however, should be changed regularly to be effective, and, camera users typically would require service technicians to do this.

Since the inherent function of an SLR is to use interchangeable lenses, the problem continues.

Extra weight and bulk are added by the mirror mechanism and viewfinder optics to SLRs. SLRs need precise lens and body mounting mechanisms, which also have mechanical and often electrical connections between the SLR lens and the SLR body. This further adds weight, complexity and cost.

Some of these “vibration” designs assume all photos use a horizontal format, with no adhesive to catch the dust if the sensor vibrates while in a vertical position, or, when pointed skyward or down.

### Optical Zoom Lenses

Optical zoom lenses reduce the need to change lenses with an SLR. The photographer simply zooms in or out for most shots. Still, for some situations, an even wider or longer accessory lens is required with the SLR, and the photographer changes lenses anyway.

Many “Point and Shoot” cameras today have zoom lenses as standard; permanently attached. Nearly all SLRs offer zoom lenses as accessories. While optical technology continues to improve, there are challenges to the zoom range any lens can adequately perform. Other dilemmas with zoom lenses are that they are heavier than their standard counterparts, they are “slower,” meaning less light gets through, limiting usefulness, and zoom lenses never deliver images that are as sharp or deliver the color fidelity as a comparable fixed focal length lens. And again, the optical zoom, by moving more elements in the lens, introduces more moving parts, which can lead to mechanical problems with time and usage, plus added cost. Because optical zooms expand mechanically, they often function like an air pump, sucking in outside air while zooming to telephoto and squeezing out air when retracting for wider angle perspectives. This can easily introduce humidity and sometimes dust to the inner elements.

### II. The Limitations of Conventional Mobile Phone Cameras

The Gartner Group has reported that over one billion mobile phones were sold worldwide in 2009. A large portion of currently available mobile phones include a camera. These cameras are usually low quality photographic devices with simple planar arrays situated behind a conventional lens. The quality of images that may be captured with these cell phone cameras is generally lower than that which may be captured with dedicated point-and-shoot or more advanced cameras. Cell phone cameras usually lack advanced controls for shutter speed, telephoto or other features.

Conventional cell phone and PDA cameras suffer from the same four deficiencies.
1. Because they use flat digital sensors, the optics are deficient, producing poor quality pictures. To get normal resolution would require larger and bulkier lenses, which would cause these compact devices to become unwieldy.
2. Another compromise is that these lenses are slow, gathering less light. Many of the pictures taken with these devices are after sunset or indoors. This often means flash is required to enhance the illumination. With the lens so close to the flash unit, as is required in a compact device, a phenomena known as “red-eye” often occurs. (In darkened situations, the pupil dilates in order to see better. In that situation, the flash often reflects off the subject's retina, creating a disturbing “red eye” image. This is so common that some camera makers wired their devices so a series of flashes go off before the picture is taken with flash, in an attempt to close down the pupils. This sometimes works and always disturbs the candid pose. Pencils to mark out “red eye” are available at retail. There are “red eye” pencils for humans and even “pet eye” pencils for animals. Some camera software developers have written algorithms that detect “red eye” results and artificially remove the “red eye,” sometimes matching the subject's true eye color, but more often not.
3. Flash photography shortens battery life.
4. Flash photography is artificial. Faces in the foreground can be bleached white while backgrounds go dark. Chin lines are pronounced, and it sometimes becomes possible to see into a human subject's nostrils, which is not always pleasing to viewers.

Current sales of high definition television sets demonstrate the growing public demand for sharper images. In the past, INSTAMATIC® cameras encouraged more picture-taking, but those new photographers soon tired of the relatively poor image quality. Thirty-five millimeter cameras, which were previously owned mostly by professionals and serious hobbyists, soon became a mass market product.

With unprecedented numbers of photos now being taken with mobile phones, and the image quality being second-rate, this cycle is likely to repeat.

The development of a system that reduces these problems would constitute a major technological advance, and would satisfy long-felt needs in the imaging business.

### III. Low Light Exposures

Since photography's invention, capturing sufficient light for an exposure has been a challenge. The first Daguerreotypes required hours of sunlight to create an image. By the time of America's Civil War, flash gunpowder was used to illuminate indoor photos. Photographers sometimes provided the subject with a hidden neck brace to reduce movement during long exposures. These exposures could require a few seconds.

Digital cameras today compensate for low light in four ways:
1.) using larger apertures,
2.) using slower shutter speeds,
3.) setting higher sensitivity in the sensors, and sometimes binning pixels to reduce the that noise this adds, and
4.) adding artificial light.

Adjustable apertures are diaphragms within the lens assembly that open or close, wider and narrower, letting more or less light pass through to the sensor. Lenses are defined by their widest aperture opening, which is limited by the lens diameter in relation to the focal length. The industry uses “f/stops” to define that size. The smaller the f/stop number, the wider the diaphragm can open within the lens. An f/2 lens, for example, is called slightly “fast” since the shutter speed can be “faster” when the diaphragm is wide open. An f/4 lens would be “slower” since it cannot open as wide, so the shutter speed must be longer, or, “slower” in a similarly lit situation. An f/4 lens requires a shutter speed four times longer than the f/2 lens to capture the same amount of light from the same scene. Smart phones today don't use adjustable apertures. Most other cameras do. Several decades ago, f/1.4 and f/1.8 lenses were common on 35 mm cameras. With the widespread adoption of zoom lenses, these “speed.” became rare.

The fastest lenses on smart phones, as of May, 2014, are the HTC and SONY cameras. They each have f/2 lenses. CANON and NIKON, with the broadest selections of accessory lenses for SLR cameras, have mostly f/3.5 zoom lenses. Both, however, offer an accessory f/1.2 non-zoom lens. NIKON's is wide angle and cost $900.00 early in 2014. At that same time CANON's was medium telephoto and retailed for $1,600.00.

While optical science has constantly advanced the capabilities of lenses, the ability to capture photons in low light has mainly regressed. The few examples of faster lenses today come with expensive prices.

When taking pictures with a fast lens that is wide open, there is less “depth of field.” This means items that are closer to the camera than the subject, and items farther from the camera than the subject, will not be in sharp focus. This can be pleasing when, for example, a telephone pole or billboard behind a person is out of focus. It can be objectionable, for example, if a mother is in focus, but her baby is not.

Slower shutter speeds do capture images in lower light, but this assumes little movement in the subject. Faster moving subjects blur. Camera movement, often caused by hand tremors, created a need for tripods in the past to stabilize the camera during slow exposures. Some of that need was eliminated by a recent technology called image stabilization. Image stabilization detects hand tremors or other motions in digital cameras, and, moves either the sensor or an optical element to neutralize any camera shaking during the exposure. This makes it possible to take somewhat longer exposures, hand held, without blur. Then any blur will be caused by the subject motion alone. This subject motion during an image stabilized exposure can be detected by pixel changes. This concept adds a fifth capability to the four common methods used to compensate for low light. When little to zero pixel changes are detected during the image stabilized exposure, this invention could extend the time that the shutter remains open in low light, so a better exposure is captured. Or, it could simply take a first exposure at preset aperture, shutter speed and sensor sensitivity settings to measure a larger sample of pixel changes. Then it might immediately and automatically take a second exposure with a more appropriate shutter speed set based on that larger sampling. In the case of consistent motion, whether race cars, dancers, football players or opera singers on stage, this effectively converts the camera from using an exposure meter only into a camera that also has a motion meter.

Adjustable sensitivity in the sensors is measured by a calculation called ISO. The ISO is a number that sets the overall sensitivity to light in the sensor. A higher, ISO is more sensitive to light. By setting a higher ISO, photographs can be taken in lower light. This is done by amplifying signals or increasing voltages across the sensor. Image degradation occurs when doing this, which at some level becomes unacceptable. This varies by sensor design and subjective judgments. Image degradation is caused by the “signal to noise” ratio. “Noise” in this ratio refers to non-image aberrations that appear.

The higher the ISO, the greater the noise. Noise appears like confetti or pepper scattered across the image. Binning of pixels is simply combining adjoining pixels and processing them as a single pixel. This strengthens their signal but reduces definition. Noise drops. At slight noise levels, with high pixel densities, the visual results often appear better with slight binning. When binning is extreme, with many more pixels being combined to form each single virtual pixel, the loss of definition becomes objectionable at some point.

Adding artificial light is common in low light photography. Still cameras use flash. Motion pictures require floodlights or constant illumination of some kind. Unless carefully done, this creates several problems. If the camera provides the illumination, battery life shortens with motion pictures. For still photographs, battery life is less affected, since those cameras' flashes are designed to only be effective within a few feet. Other problems are that subjects in front of a window or mirror will result in glare from the glass, faces in the foreground are bleached while background subjects darken and in some cases show “red eye.” Red eye is caused when a flash reflects off a subject's retina, creating a ghoulish look. This has been fixed by some software corrections which detect red eyes and replaces them. The replacement color selected may or may not match the subject's true eye color, since the camera's sensor cannot know what it was. As cameras became smaller and flashes were built in, this problem became worse. This is because the closer the flash is to the lens, the more likely it is that the subject's retinas will reflect into the lens. Today red eye pencils to touch up the effect on prints are sold in most camera stores, with separate “pet eye” pencils to eliminate the effect from some animals' different retina reflections. An artistic objection to illumination from the camera is the reduced shadowing, which cuts the perceived depth in the photo.

In some cases, this extended shutter speed might enhance a photo in some viewer's opinions. A baseball pitcher's arm and the ball may blur in a night game, while his body and facial expression remain sharp. That example assumes the camera was set to allow a small percentage of pixel changes during the exposure, before extending the duration of the exposure.

Similarly, a ballerina may do her pirouette, and her leg kick might blur while her body holds a steady pose. Telephone wires undulating in a wind might disappear, instead of cluttering the sky and clouds at sunset.

In applications, irrelevant motion is ignored the same way irrelevant exposure highlights and shadows can be ignored with automatic exposure and edifices systems. Some of these systems look at the full viewing screen and calculate the average light intensity or subject distance. An enhanced motion detection system might do the same.

Another option is to center weight the distribution of pixels sampled. In this way, the extreme high changes and low changes are not measured to avoid skewing the average motion level. Another method to measure motion would be to center weight the pixels sampled, as many cameras do for edifices and automatic exposures. And a spot measurement might also be used.

Demand for higher visual resolution always grows. As black and white television screens added color, they got bigger, then became HDTV and now Ultra HDTV is appearing. Smart phone screens are growing already and promising more detail every year. Their pixel counts for the cameras grow annually. No product trend goes in the other directions; lower fidelity or less resolution.

In the sixties and seventies, KODAK introduced the INSTAMATIC camera. It was simple to use. The INSTAMATIC produced reasonable images, if only wallet sized. Millions and millions of new users started taking pictures. But that public taste soon demanded better images so photos could be enlarged and cropped. The Instamatic died in two decades. Suddenly, 35 mm cameras enjoyed several decades of strong growth as these new photographers sought better images.

Today, flash photographs bleach nearby faces while those in the background seem shaded. Candid shots become intrusive. Red eye sometimes destroys the look. Batteries die quicker. Faster lenses make low light photography possible, sometimes with pleasing results from a shallow depth of field. But fast lenses are no longer as common. Boosting the ISO makes lower light photography possible until noise disrupts the image. Binning can reduce the noise but erases detail. Extending the shutter opening time can, in some instances, let the camera capture a picture that would otherwise be lost.

### Noise Reduction

Increasing the ISO, or sensor voltages and amplification, makes lower light photography possible. As previously mentioned, however, this also increases noise. Noise is often described as “salt and pepper” since there are darker specs in light areas and light specs in the darker sections of the image. They are generally randomly scattered and small, but disturb the image.

This effect can be controlled by combining two images of the same subject. The camera first takes the picture with a high ISO number, capturing image detail but also generating noise. The camera immediately takes a second exposure with the ISO dropped but the pixels binned.

This image detail, despite the noise, captures the image edges, where a dark to light tone, or a color shift takes place. These will be lines of irregular, straight, curves where pixels were consistently one way on one side but change to a consistently different tone or color on the other side. The processor isolates these sharp edges into templates.

The camera immediately takes a second exposure with all pixels binned and the ISO lowered. This creates a different image, where the noise is significantly decreased, depending on the amount of ISO drop, but the edges are more ragged due to the increase size of each virtual pixel. This is the LEGO effect.

Now the processor combines the two, using the cleaner, lower ISO but binned image with less noise, put into the templates from the higher ISO and noisy image template to sharpen the image edges. This transforms the noisy image, with ‘salt and pepper’ scattered across it and the fuzzy image, with LEGO image edges into a composite photo that is truer to the original scene than either exposure was separately.

The sequence of the two images captured may be reversed. The high ISO image could be second and the binned and lower ISO could be first. For motion pictures, the process continues constantly.

### SUMMARY OF THE INVENTION

One embodiment of the present invention comprises methods and apparatus for a camera that includes a curved sensor having a number of pixels whose output is sampled to detect unwanted motion. If the motion detected is below a predetermined threshold, a control circuit increases the length of the exposure.

An appreciation of the other aims and objectives of the present invention, and a more complete and comprehensive understanding of this invention, may be obtained by studying the following description of a preferred embodiment, and by referring to the accompanying drawings.

### A BRIEF DESCRIPTION OF THE DRAWINGS

FIG. 1 depicts a generalized conventional camera with flat film or a flat sensor.

FIG. 2 is a simplified depiction of the human eye.

FIG. 3 provides a generalized schematic diagram of a digital camera with a curved sensor manufactured in accordance with one embodiment of the present invention.

FIGS. 4A, 4B, and 4C offer an assortment of views of a generally curved sensor.

FIG. 5 depicts a sensor formed from nine planar segments or facets.

FIG. 6A reveals a cross-sectional view of a generally curved surface comprising a number of flat facets.

FIG. 6 B shows an embodiment of the invention which has sensors formed on the upper side of the sensor.

FIG. 6 C shows an embodiment of the invention which has sensors formed on the upper side of the sensor.

FIG. 7 provides a perspective view of the curved surface shown in FIG. 6A.

FIG. 8 offers a view of one method of making the electrical connections for the sensor shown in FIGS. 6 and 7.

FIGS. 9A and 9B portray additional details of the sensor illustrated in FIG. 7, before and after enlarging the gaps above the substrate, so the flat surface can be bent.

FIGS. 10A and 10B supply views of sensor connections.

FIGS. 11A and 11B depict a series of petal-shaped segments of ultra-thin silicon that are bent or otherwise formed to create a generally dome-shaped surface.

FIG. 12 furnishes a detailed view of an array of sensor segments.

FIG. 13 is a perspective view of a curved shape that is produced when the segments shown in FIG. 12 are joined.

FIGS. 14A, 14B and 14C illustrate an alternative method of the invention that uses a thin layer of semiconductor material that is formed into a generally dome-shaped surface using a mandrel.

FIGS. 14D, 14E and 14F illustrate methods for formed a generally dome-shaped surface using a mandrel.

FIG. 14G shows the dome-shaped surface after sensors have been deployed on its surface.

FIG. 15A shows a camera taking a wider angle photo image.

FIG. 15B shows a camera taking a normal perspective photo image.

FIG. 15C shows a camera taking a telephoto image.

FIGS. 16 and 17 illustrate the feature of variable pixel density by comparing views of a conventional sensor with one of the embodiments of the present invention, where pixels are more concentrated in the center.

FIGS. 18, 19, 20 and 21 provide schematic views of a camera with a retractable and extendable shade. When the camera is used for wider angle shots, the lens shade retracts. For telephoto shots, the lens shade extends. For normal perspectives, the lens shade protrudes partially.

FIGS. 22 and 23 supply two views of a composite sensor. In the first view, the sensor is aligned in its original position, and captures a first image. In the second view, the sensor has been rotated, and captures a second image. The two successive images are combined to produce a comprehensive final image.

FIGS. 24A and 24B offer an alternative embodiment to that shown in FIGS. 22 and 23, in which the sensor position is displaced diagonally between exposures.

FIGS. 25A, 25B, 25C and 25D offer four views of sensors that include gaps between a variety of arrays of sensor facets.

FIGS. 26, 27 and 28 provide illustrations of the back of a moving sensor, revealing a variety of connecting devices which may be used to extract an electrical signal.

FIG. 29 is a block diagram that illustrates a wireless connection between a sensor and a processor.

FIG. 30 is a schematic side sectional view of a camera apparatus in accordance with another embodiment of the present invention.

FIG. 31 is a front view of the sensor of the camera apparatus of FIG. 30.

FIG. 32 is a block diagram of a camera apparatus in accordance with a further embodiment of the present invention.

FIGS. 33, 34, 35, 36 and 37 provide various views of an electronic device which incorporates a curved sensor. FIG. 34 is a front view. FIG. 35 is a rear view. FIG. 36 furnishes a front view of another embodiment. FIG. 37 furnishes a rear view of another embodiment.

FIGS. 38 through 50 illustrate a method to capture more detail from a scene than the sensor is otherwise capable of recording. FIG. 38 shows the image of a tree. FIG. 39 shows a sensor with pixels. In FIG. 40, the image of the tree is superimposed over the sensor. FIG. 41 shows the original image translated over the pixels. FIG. 42 is a second image of the tree, which has been shifted one half pixel to the right. FIG. 43 is the second image, translated over the pixels. FIG. 44 is a third image, shifted one half pixel up over the sensor. FIG. 44 is the third shot, translated over the pixels. FIG. 46 is a fourth image, shifted one half pixel to the left. FIG. 47 is the fourth image, translated over the pixels. FIG. 48 shows the resulting data image recorded by taking four images, each ½ pixel apart from the adjoining exposures taken. FIG. 49 shows the original tree image, as it would be digitally recorded in four varying exposures on the sensor, each positioned ½ pixel apart. FIG. 49 shows the tree itself, and the four typical digital images that would be recorded by four individual exposures of that tree. FIG. 50 shows how the original tree breaks down into the multiple images, and, how the composite, created by the software from those four images, starts to resemble a tree.

FIG. 51 presents a schematic illustration of an optical element which moves in a tight circular path over a stationary flat sensor.

FIG. 52 is an overhead view of the optical element and sensor shown in FIG. 51.

FIG. 53 presents a schematic illustration of an optical element which moves over a stationary curved sensor.

FIG. 54 is an overhead view of the optical element and sensor shown in FIG. 53.

FIG. 55 presents a schematic illustration of a method for imparting motion to a flat sensor, which moves beneath a stationary optical element.

FIG. 56 is an overhead view of the optical element and sensor shown in FIG. 55.

FIG. 57 presents a schematic illustration of a method for imparting circular motion to a sensor, such as the ones shown in FIGS. 55 and 56.

FIG. 58 is a perspective illustration of the components shown in FIG. 58.

FIG. 59 presents a schematic illustration of a method for imparting motion to a curved sensor, which moves beneath a stationary optical element.

FIG. 60 is an overhead view of the optical element and sensor shown in FIG. 59.

FIG. 61 is a schematic illustration of a method for imparting circular motion to an optical element.

FIG. 62 presents nine sequential views of a flat sensor as it moves in a single circular path.

FIG. 63 is a schematic representation of a flat sensor arrayed with pixels. In FIG. 63, the sensor resides in its original position. In FIGS. 64 and 65, the sensor continues to rotate through the circular path.

FIG. 66 shows a combination of a flat sensor and a lens.

FIG. 67 shows a combination of a curved sensor with gaps and a lens.

FIGS. 68 and 69 provide two successive views of a first exposure taken by a camera without image stabilization.

FIGS. 70 and 71 provide two successive views of a first exposure taken by a camera with image stabilization.

FIG. 72 presents an unaided eye's view of a cat.

FIGS. 73 and 74 offer two successive views of a first and a second exposure of the cat, which are superimposed over the mini-sensors and gaps within the camera.

FIG. 75 reveals the final composite image of the cat.

FIG. 76 is a schematic diagram of one embodiment of the invention which depicts optical image stabilization.

FIG. 77 is a schematic diagram of another embodiment of the invention which depicts electronic image stabilization.

FIG. 78 is a schematic diagram of another embodiment of the invention which illustrates a lens shade motor control.

FIG. 79 is a schematic diagram of another embodiment of the invention which portrays a manual zoom and lens shade control.

FIGS. 80 through 83 are schematic diagrams which illustrate lens shade control mechanisms. FIG. 80 depicts a first embodiment of lens shade control. FIG. 81 depicts a second embodiment 490 of lens shade control. FIG. 82 depicts a third embodiment 494 of lens shade control. FIG. 83 depicts a fourth embodiment of lens shade control.

FIG. 84 is a schematic diagram which depicts a manual zoom and lens shade control.

FIGS. 85, 86 and 87 illustrate binning and compression methods.

FIG. 88 depicts an arcuate array of mini-sensors, together with a corrective optical element.

FIGS. 89A, 89B and 89C depict three views of an aperture in a camera, showing three different shutter configurations: a large aperture, a medium aperture and a small aperture.

FIG. 90 is a schematic illustration of a first array of pixels on a sensor. This first array is ten pixels square, and contains one hundred pixels.

FIG. 91 is a schematic illustration of a second array of pixels on a sensor. This second array includes the same one hundred pixels shown in FIG. 90, but now have been binned into twenty-five pixels.

FIG. 92 offers a schematic diagram of a group of pixels on a curved sensor. Each pixel has an output which is connected to a signal processor for detecting unwanted motion during an exposure.

FIG. 93A is a flow chart which illustrates one embodiment of the invention.

FIG. 93B shows a camera display that presents a low light warning.

FIG. 93C show a camera display that presents suggested exposure settings for low light conditions.

FIG. 94 presents a series of four images of a ballerina that have were captured under varying light conditions.

FIGS. 95A, 95B, 95C, 95D and 95E reveal a series of images of a small section of the images presented in FIG. 94.

FIG. 96 illustrates the process of taking a photograph on a cloudy day.

FIG. 97 illustrates the same process as is shown in FIG. 94, but under extremely low light conditions.

FIGS. 98, 99, 100, 101 and 102 present a series of five images taken of a bird under low light conditions.

FIG. 103 is an enlarged image of the Moon.

FIG. 104 depicts the Moon's image in an exposure when the ISO is high to compensate for low light. This combination of settings generates noise.

FIG. 105 shows how the Moon looks in a second exposure with a lower ISO, but the pixels are binned. Noise is reduced, but edge detail is lost.

FIG. 106 portrays a template which is formed when the processor isolates the image edges within the high ISO exposure within this tiny portion of the photo.

FIG. 107 shows how the template transforms the high ISO image and the binned image into a more accurate photograph than either was by itself, but enlarged, so that the pixel effect is still exaggerated.

FIGS. 108, 109, 110 and 111 illustrate the reduced, but still enlarged, pixilated Moon, and the process results.

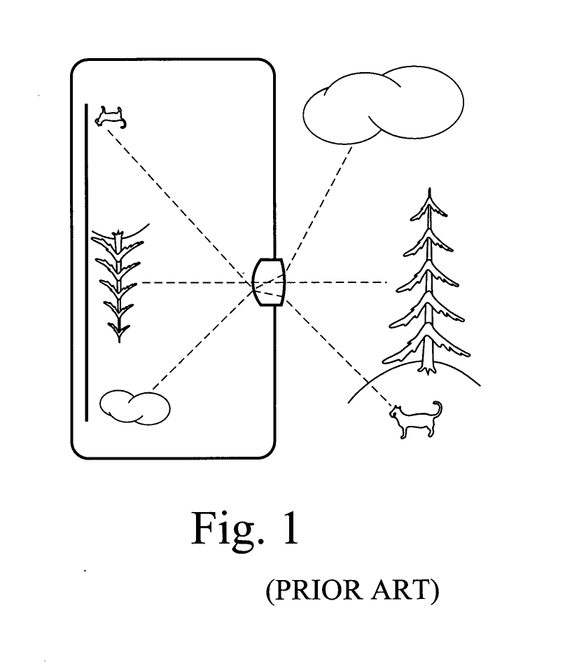

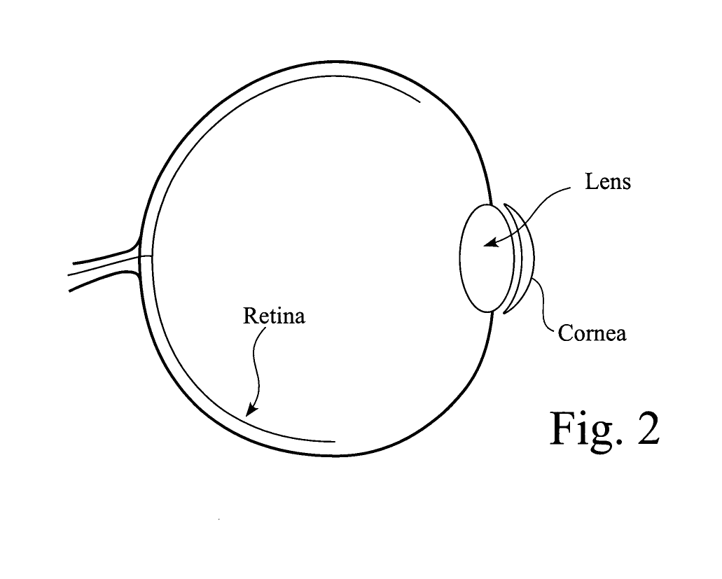

### A DETAILED DESCRIPTION OF PREFERRED & ALTERNATIVE EMBODIMENTS

### Section 1. Overview of the Invention

The present invention provides methods and apparatus related to a camera having a non-planar, curved or curvilinear sensor. The present invention may be incorporated in a mobile communication device. In this Specification, and in the Claims that follow, the terms “mobile communication device” and “mobile communication means” are intended to include any apparatus or combination of hardware and/or software which may be used to communicate, which includes transmitting and/or receiving information, data or content or any other form of signals or intelligence.

Specific examples of mobile communication devices include conventional cameras, cellular or wireless telephones, smart phones, personal digital assistants, laptop or netbook computers, iPads™ or other readers/computers, or any other generally portable device which may be used for telecommunications or viewing or recording visual content.

Unlike conventional cellular telephones which include a camera that utilizes a conventional flat sensor, the present invention includes a curved, concave or otherwise non-planar sensor. In one embodiment, the non-planar surfaces of the sensor used in the present invention comprise a plurality of small flat segments which altogether approximate a curved surface. In general, the sensor used by the present invention occupies three dimensions of space, as opposed to conventional sensors, which are planes that are substantially and generally contained in two physical dimensions.

The present invention may utilize sensors which are configured in a variety of three-dimensional shapes, including, but not limited to, spherical, paraboloidal and ellipsoidal surfaces.

In the present Specification, the terms “curvilinear,” “curved,” and “concave” encompass any line, edge, boundary, segment, surface or feature that is not completely colinear with a straight line. The term “sensor” encompasses any detector, imaging device, measurement device, transducer, focal plane array, charge-coupled device (CCD), complementary metal-oxide semiconductor (CMOS) or photocell that responds to an incident photon of any wavelength.

While some embodiments of the present invention are configured to record images in the optical spectrum, other embodiments of the present invention may be used for a variety of tasks which pertain to gathering, sensing and/or recording other forms of radiation. Embodiments of the present invention include systems that gather and/or record color, black and white, infra-red, ultraviolet, x-rays or any other stream of radiation, emanation, wave or particle. Embodiments of the present invention also include systems that record still images or motion pictures.

### Section 2. Specific Embodiments of the Invention

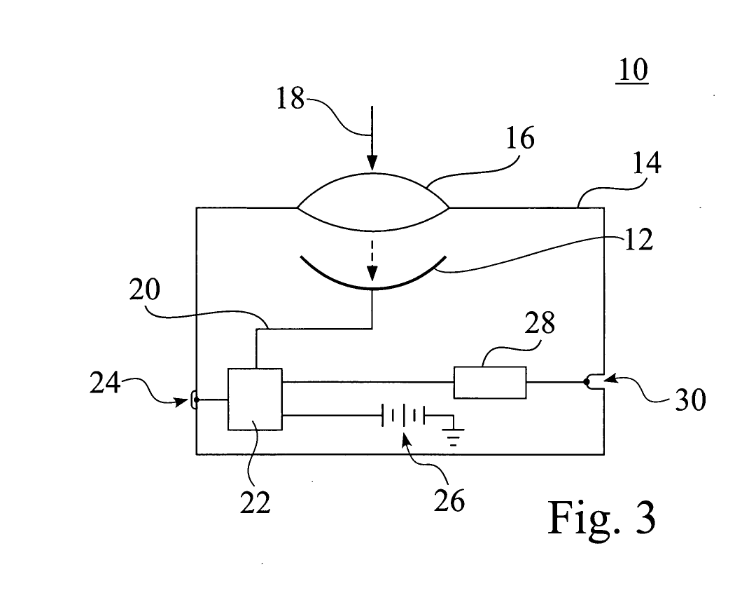

FIG. 3 provides a generalized schematic diagram of a digital camera 10 with a curved sensor 12 sub-assembly which may be incorporated into a mobile communication device. A housing 14 has an optical element 16 mounted on one of its walls. The objective lens 16 receives incoming light 18. In this embodiment, the optical element is an objective lens. In general, the sensor 12 converts the energy of the incoming photons 18 to an electrical output 20, which is then fed to a signal or photon processor 22. The signal processor 22 is connected to user controls 24, a battery or power supply 26 and to a solid state memory 28. Images created by the signal processor 22 are stored in the memory 28. Images may be extracted or downloaded from the camera through an output terminal 30, such as a USB port.

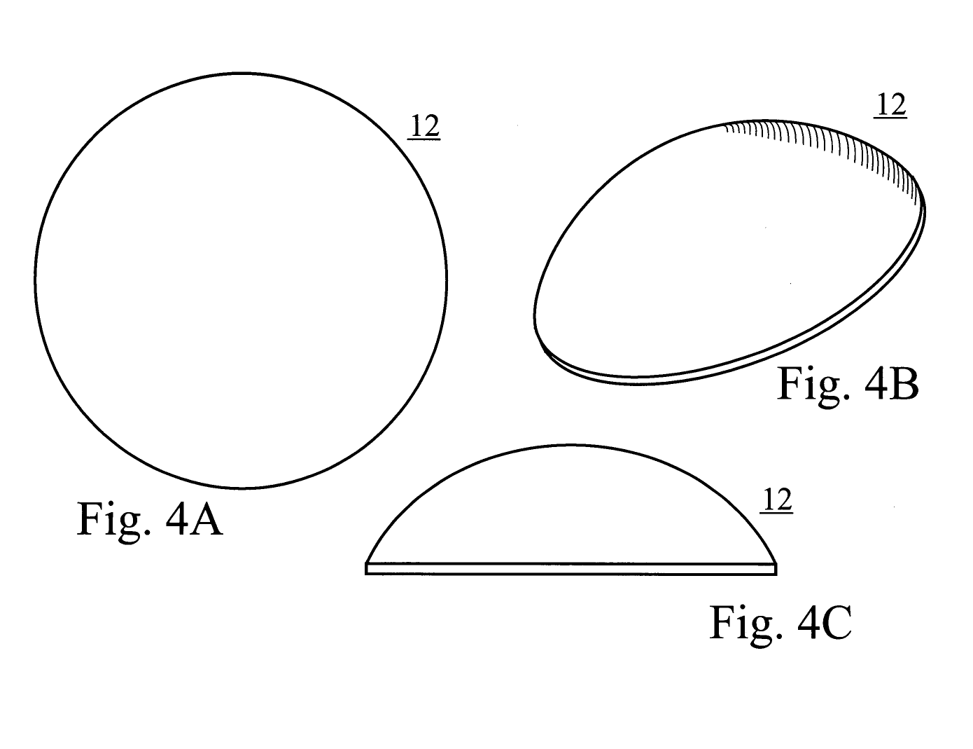

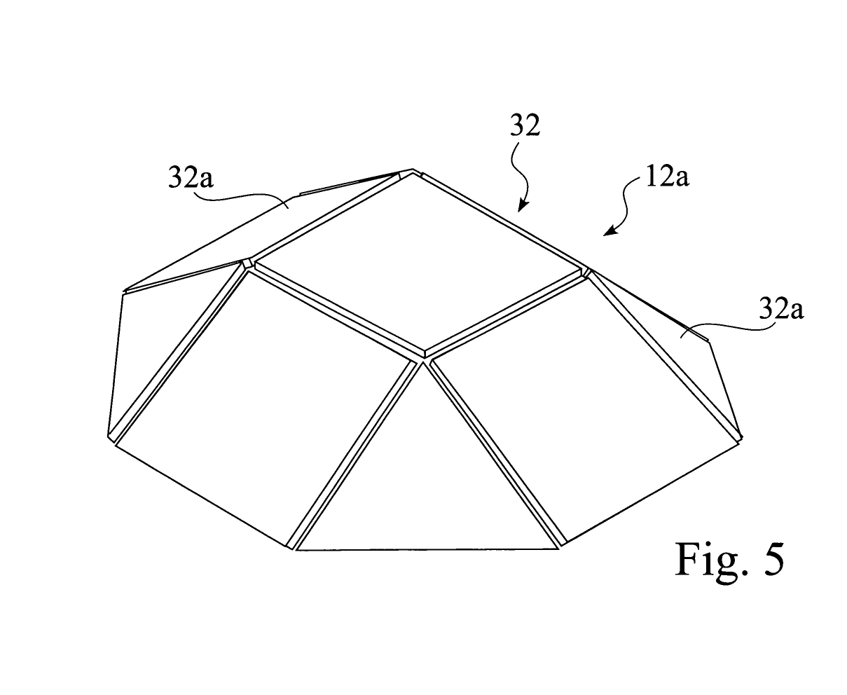

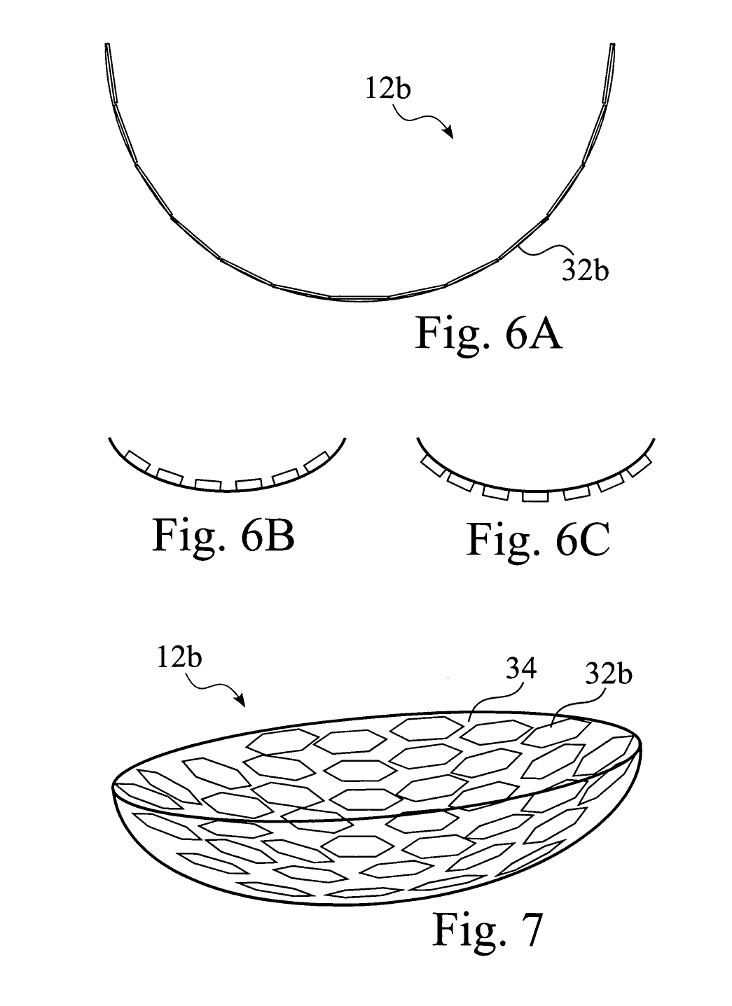

Embodiments of the present invention include, but are not limited to, mobile communication devices with a camera that incorporate the following sensors:
1. Curved sensors: Generally continuous portions of spheres, or revolutions of conic sections such as parabolas or ellipses or other non-planar shapes. Examples of a generally curved sensor 12 appear in FIGS. 4A, 4B and 4C. In this specification, various embodiments of curved sensors are identified with reference character 12, 12a, 12b, 12c, and so on.
2. Faceted sensors: Aggregations of polygonal facets or segments. Any suitable polygon may be used, including squares, rectangles, triangles, trapezoids, pentagons, hexagons, heptagons, octagons or others. FIG. 5 exhibits a sensor 12a comprising nine flat polygonal segments or facets 32a. For some applications, a simplified assembly of a few flat sensors might lose most of the benefit of a smoother curve, while achieving a much lower cost. FIGS. 6A and 7 provide side and perspective views of a generally spherical sensor surface 12b comprising a number of flat facets 32b. FIG. 7 shows exaggerated gaps 34 between the facets. The facets could each have hundreds, thousands or many millions of pixels. In this specification, the facets of the sensor 12 are identified with reference characters 32, 32a, 32b, 32c and so on.

FIG. 6A shows that sensors may be formed on the upper side of the sensor, which faces the objective lens and the incoming light. FIG. 6B shows that sensors may be formed on the opposite side of the sensor, which faces away from the objective lens and incoming light. In either embodiment, the side of the sensor which receives the incident light and then produces a signal faces the incident light.

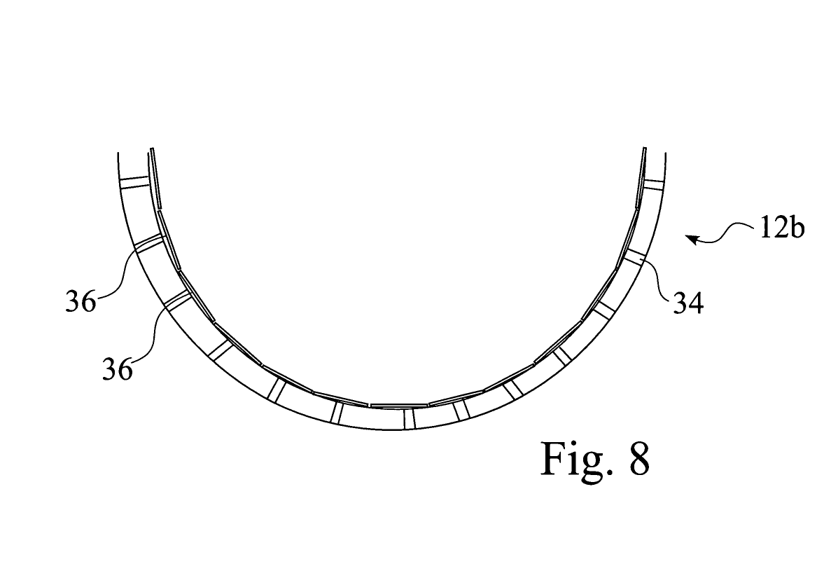

FIG. 8 offers a view of the electrical connections 36 for the curved sensor 12b shown in FIG. 7. The semiconductor facet array is disposed on the interior surface. The exterior surface may be a MYLAR™, CAPTAIN™ or similar backplane formed in a curved shape.

For one embodiment of the invention, several methods are currently available to produce “bendable” silicon:
“Japanese chemical company Teijin, in cooperation with California-based NanoGram, has developed a technology that makes it possible to produce bendable silicon semiconductor chips. The key factor was the usage of tiny silicon particles which are tens of nanometers in diameter (and a nanometer is one billionth of a meter).” See website for Techcrunch, 19 Aug. 2009.
In their article entitled Bendable GaAs metal-semiconductor field-effect transistors formed with printed GaAs wire arrays on plastic substrates, published on 15 Aug. 2005, Sun et al. disclose that “Micro/nanowires of GaAs with integrated ohmic contacts have been prepared from bulk wafers by metal deposition and patterning, high-temperature annealing, and anisotropic chemical etching. These wires provide a unique type of material for high-performance devices that can be built directly on a wide range of unusual device substrates, such as plastic or paper. In particular, transfer printing organized arrays of these wires at low temperatures onto plastic substrates yield high-quality bendable metal-semiconductor field-effect transistors.”
According to the website End gadget, “researchers from IEC have developed bendable microprocessor by layering a plastic substrate, gold circuits, organic dielectric, and a pentacene organic semiconductor to create an 8-bit logic circuit with 4000 transistors.”

In another embodiment of the invention, the sensor may be formed from stressed or strained Silicon.

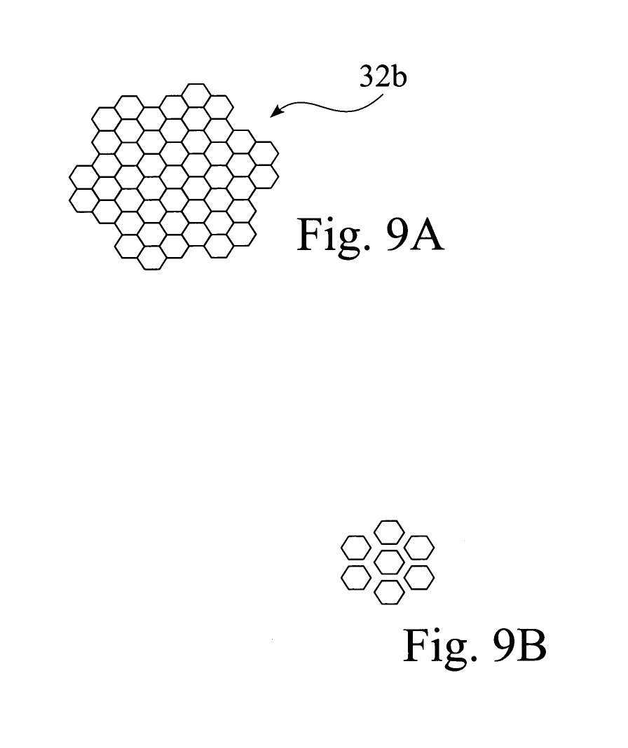

FIG. 9 provides a detailed view of facets on the curved sensor 12b. In general, the more polygons that are employed to mimic a generally spherical surface, the more the sensor will resemble a smooth curve. In one embodiment of the invention, a wafer is manufactured so that each camera sensor has tessellated facets. Either the front side or the rear side of the wafer of sensor chips is attached to a flexible membrane that may bend slightly (such as MYLAR™ or KAPTON™), but which is sufficiently rigid to maintain the individual facets in their respective locations. A thin line is etched into the silicon chip between each facet, but not through the flexible membrane. The wafer is then shaped into a generally spherical surface.

FIGS. 9A and 9B furnish a view of the facets 32b which reside on the interior of the curved sensor.

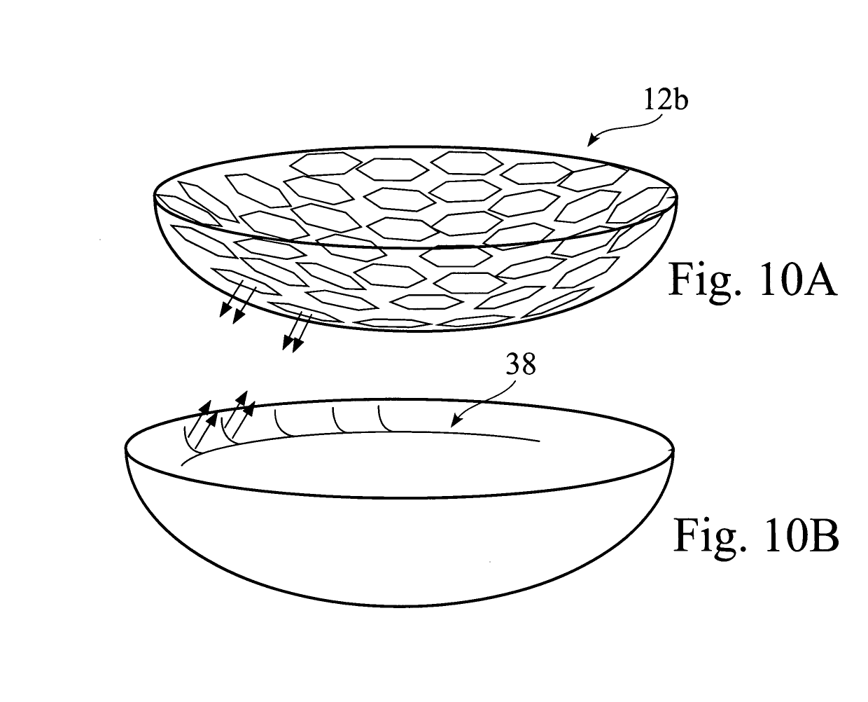

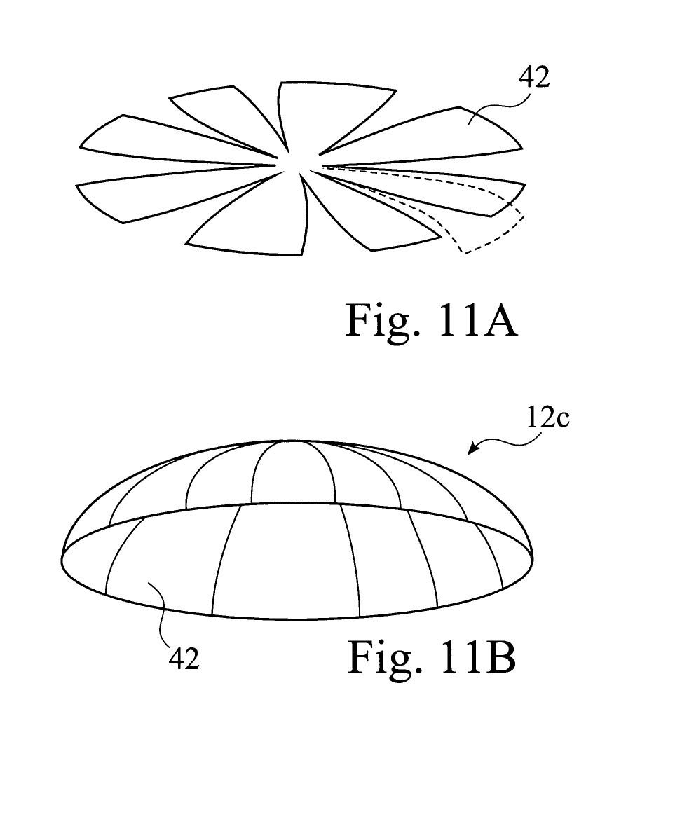

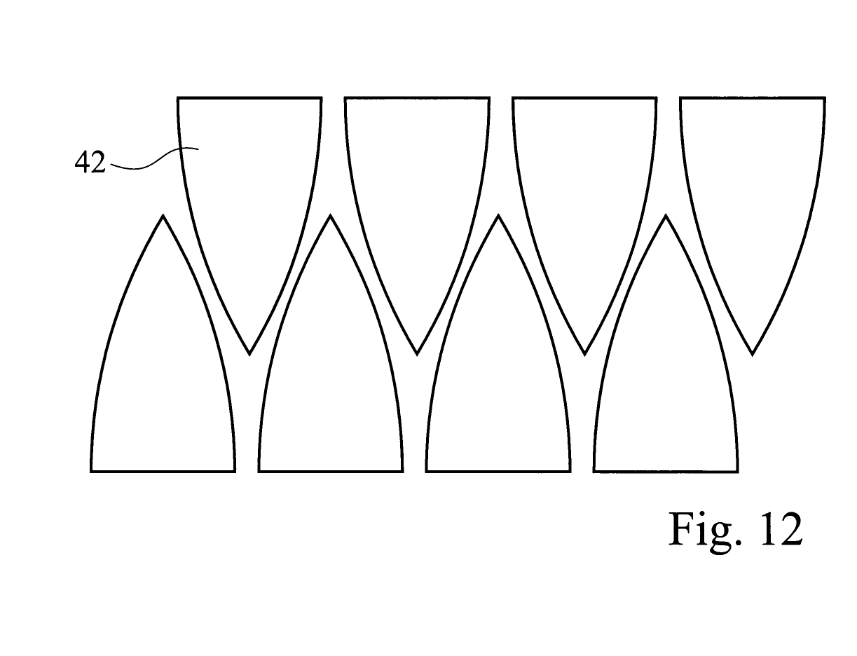

FIGS. 10A and 10B illustrate a backplane 38 which may be used to draw output signals from the facets on the sensor.

FIGS. 11A and 11B show a generally hemispherical shape 40 that has been formed by bending and then joining a number of ultra-thin silicon petal-shaped segments 42. These segments are bent slightly, and then joined to form the curved sensor.

FIG. 12 provides a view of one embodiment of the petal-shaped segments 42. Conventional manufacturing methods may be employed to produce these segments. In one embodiment, these segments are formed from ultra-thin silicon, which are able to bend somewhat without breaking. In this Specification, and in the Claims that follow, the term “ultra-thin” denotes a range extending generally from 10 to 250 microns. In another embodiment, pixel density is increased at the points of the segments, and are gradually decreased toward the base of each segment. This embodiment may be implemented by programming changes to the software that creates the pixels.

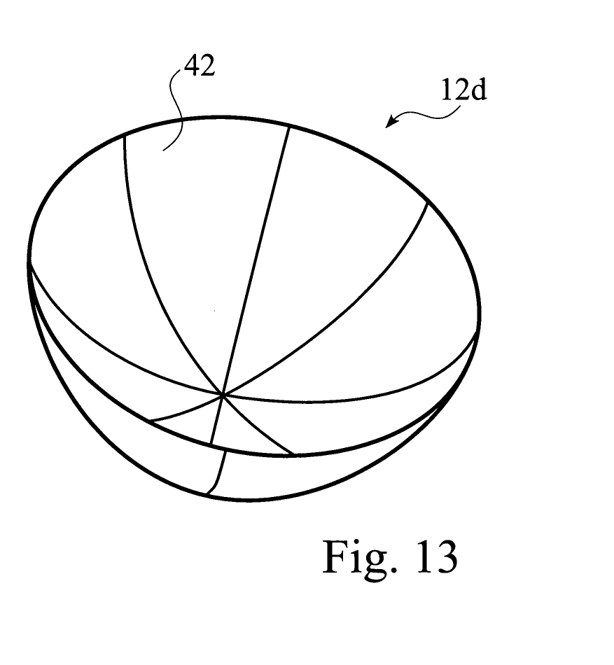

FIG. 13 offers a perspective view of one embodiment of a curved shape that is formed when the segments shown in FIG. 12 are joined. The sensors are placed on the concave side, while the electrical connections are made on the convex side. The number of petals used to form this non-planar surface may comprise any suitable number. Heat or radiation may be employed to form the silicon into a desired shape. The curvature of the petals may be varied to suit any particular sensor design.

In one alternative embodiment, a flat center sensor might be surrounded by these “petals” with squared-off points.

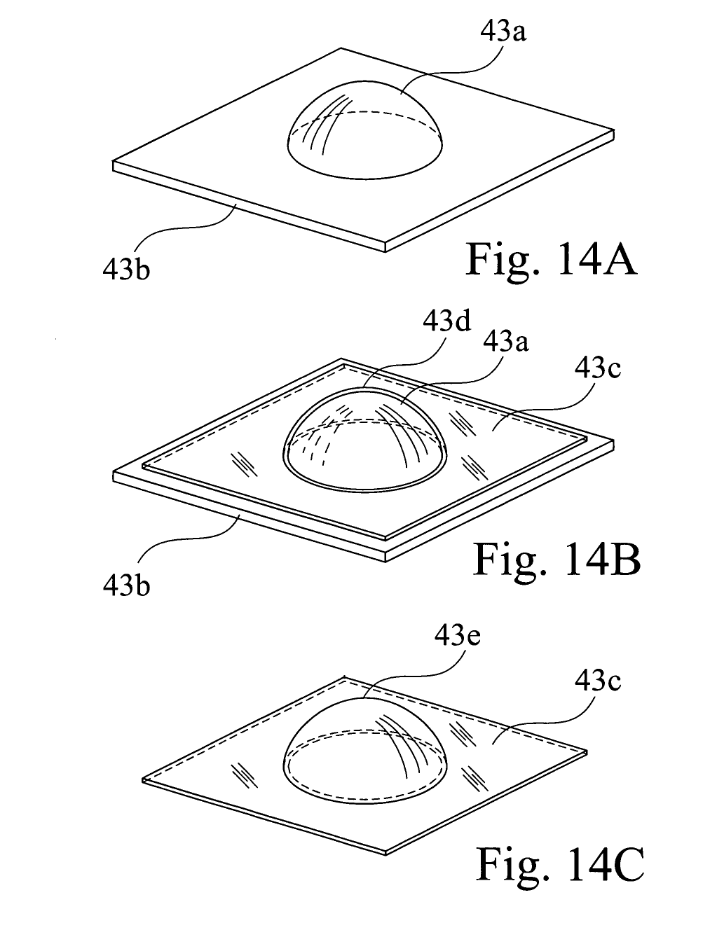

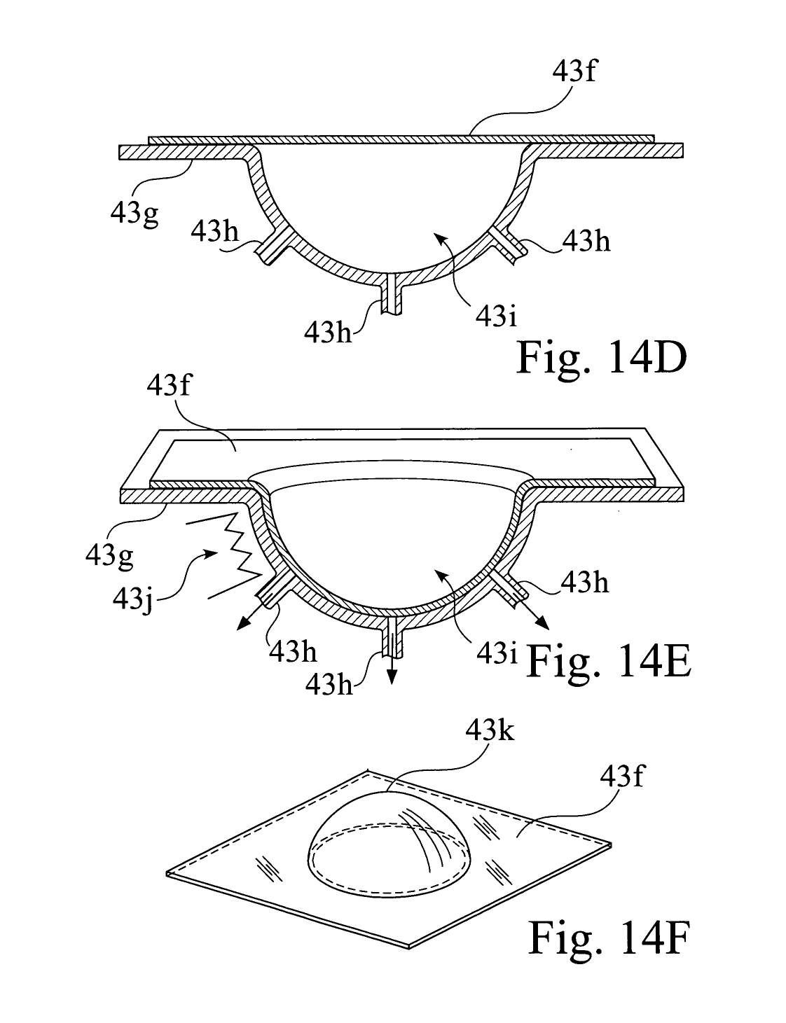

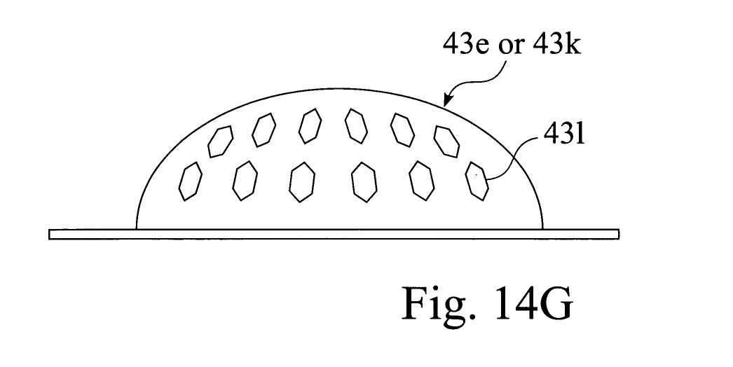

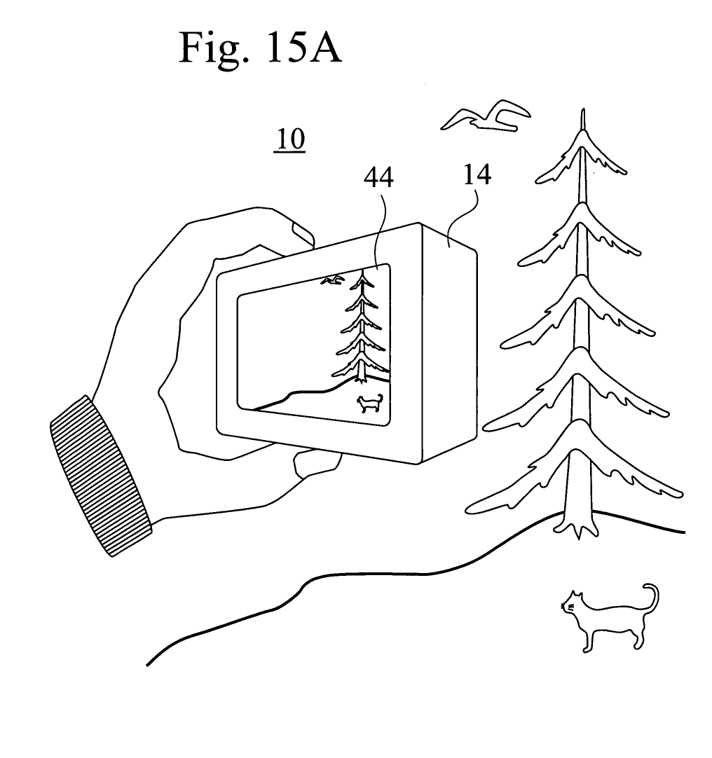

FIGS. 14A, 14B and 14C depict an alternative method for forming a curved sensor. FIG. 14A depicts a dome-shaped first mandrel 43a on a substrate 43b. In FIG. 14B, a thin sheet of heated deformable material 43c is impressed over the first mandrel 43a. The central area of the deformable material 43c takes the shape of the first mandrel 43a, forming a generally hemispherical base 43e for a curved sensor, as shown in FIG. 14C.

FIGS. 14D, 14E and 14F depict an alternative method for forming the base of a curved sensor. In FIG. 14D, a second sheet of heated, deformable material 43f is placed over a second mandrel 43g. A vacuum pressure is applied to ports 43h, which draws the second sheet of heated, deformable material 43f downward into the empty region 43i enclosed by the second mandrel 43g. FIG. 14E illustrates the next step in the process. A heater 43j increases the temperature of the second mandrel 43g, while the vacuum pressure imposed on ports 43h pulls the second sheet of heated, deformable material 43f down against the inside of the second mandrel 43g. FIG. 14F shows the resulting generally hemispherical dome 43k, which is then used as the base of a curved sensor.

FIG. 14G shows a generally hemispherical base 43e or 43k for a curved sensor after sensor pixels 431 have been formed on the base 43e or 43k.

### Digital Zoom

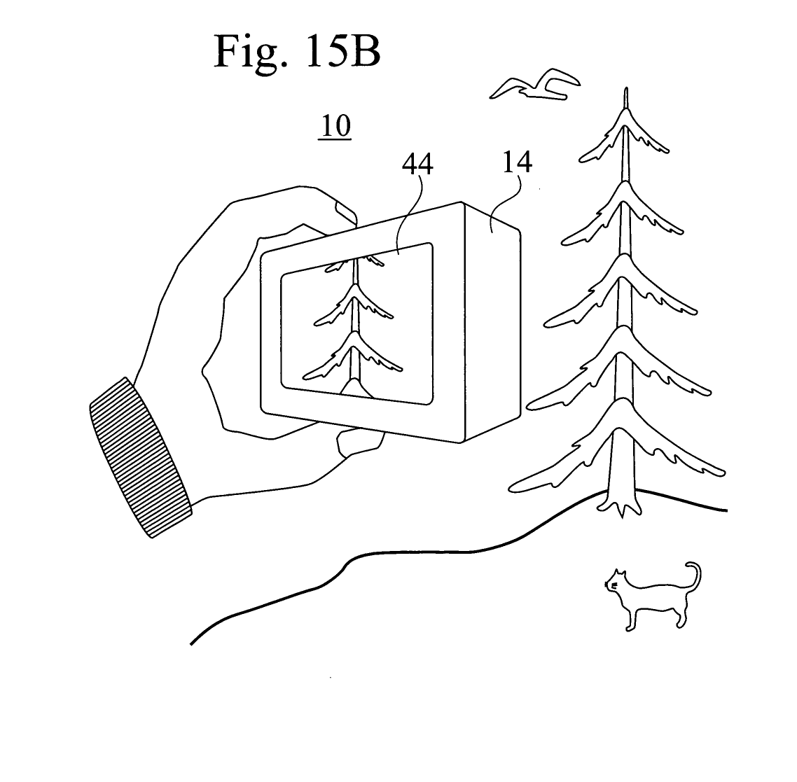

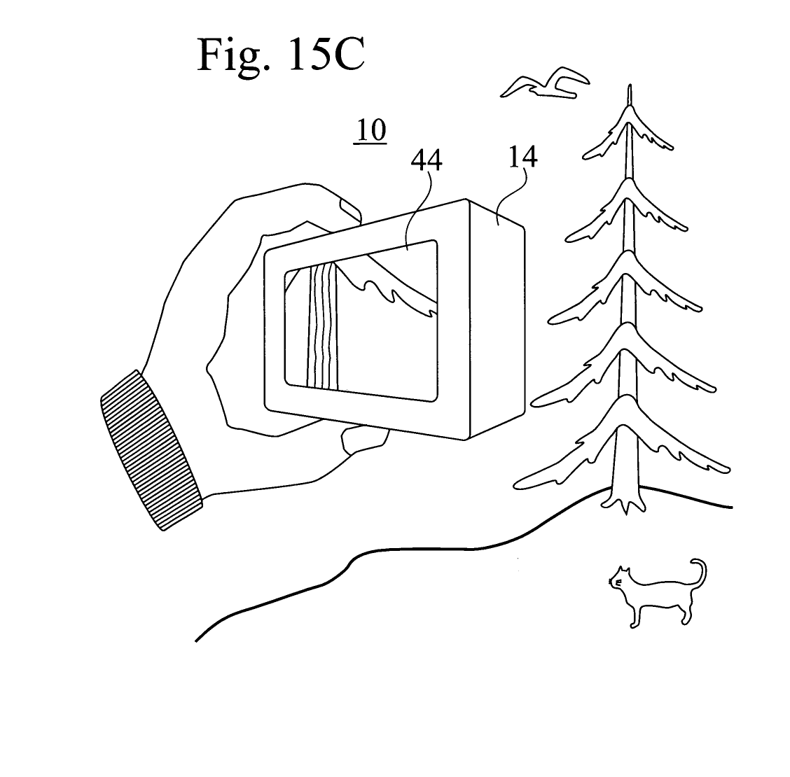

FIG. 15A shows a camera taking a wide angle photo. FIG. 15A shows the same camera taking a normal perspective photo, while FIG. 15B shows a telephoto view. In each view, the scene stays the same. The view screen on the camera shows a panorama in FIG. 15A, a normal view in FIG. 15B, and detail from the distance in FIG. 15C. Just as with optical zoom, digital zoom shows the operator exactly the scene that is being processed from the camera sensor.

Digital zoom is software-driven. The camera either captures only a small portion of the central image, the entire scene or any perspective in between. The monitor shows the operator what portion of the overall image is being recorded. When digitally zooming out to telephoto in one embodiment of the present invention, which uses denser pixels in its center, the software can use all the data. Since the center has more pixels per area, the telephoto image, even though it is cropped down to a small section of the sensor, produces a crisp image. This is because the pixels are more dense at the center.

When the camera has “zoomed back” into a wide angle perspective, the software can compress the data in the center to approximate the density of the pixels in the edges of the image. Because so many more pixels are involved in the center of this wide angle scene, this does not effect wide angle image quality. Yet, if uncompressed, the center pixels represent unnecessary and invisible detail captured, and require more storage capacity and processing time. Current photographic language might call the center section as being processed “RAW” or uncompressed when shooting telephoto but being processed as “JPEG” or other compression algorithm in the center when the image is wide angle.

Digital zoom is currently disdained by industry experts. When traditional sensors capture an image, digital zooming creates images that break up into jagged lines, forms visible pixels and yields poor resolution.

Optical zoom has never created images as sharp as fixed focus length lenses are capable of producing. Optical zooms are also slower, letting less light through the optical train.

Embodiments of the present invention provide lighter, faster, cheaper and more dependable cameras. In one embodiment, the present invention provides digital zoom. Since this does not require optical zoom, it uses inherently lighter lens designs with fewer elements.

In various embodiments of the invention, more pixels are concentrated in the center of the sensor, and fewer are placed at the edges of the sensor. Various densities may be arranged in between the center and the edges. This feature allows the user to zoom into a telephoto shot using the center section only, and still have high resolution.

In one embodiment, when viewing the photograph in the wide field of view, the center pixels are “binned” or summed together to normalize the resolution to the value of the outer pixel density.

When viewing the photograph in telephoto mode, the center pixels are utilized in their highest resolution, showing maximum detail without requiring any adjustment of lens or camera settings.

The digital zoom feature offers extra wide angle to extreme telephoto zoom. This feature is enabled due to the extra resolving power, contrast, speed and color resolution lenses are able to deliver when the digital sensor is not flat, but curved, somewhat like the retina of a human eye. The average human eye, with a cornea and single lens element, uses, on average, 25 million rods and 6 million cones to capture images. This is more image data than is captured by all but a rare and expensive model or two of the cameras that are commercially available today, and those cameras typically must use seven to twenty element lenses, since they are constrained by flat sensors. These cameras cannot capture twilight images without artificial lighting, or, by boosting the ISO which loses image detail. These high-end cameras currently use sensors with up to 48 millimeter diagonal areas, while the average human eyeball has a diameter of 25 millimeters. Eagle eyes, which are far smaller, have eight times as many sensors as a human eye, again showing the optical potential that a curved sensor or retina provides. Embodiments of the present invention are more dependable, cheaper and provide higher performance. Interchangeable lenses are no longer necessary, which eliminates the need for moving mirrors and connecting mechanisms. Further savings are realized due to simpler lens designs, with fewer elements, because flat film and sensors, unlike curved surfaces, are at varying distances and angles from the light coming from the lens. This causes chromatic aberrations and varying intensity across the sensor. To compensate for that, current lenses, over the last two centuries, have mitigated the problem almost entirely, but, with huge compromises. Those compromises include limits on speed, resolving power, contrast, and color resolution. Also, the conventional lens designs require multiple elements, some aspheric lenses, exotic materials and special coatings for each surface. Moreover, there are more air to glass surfaces and more glass to air surfaces, each causing loss of light and reflections.

### Variable Density of Pixels

In some embodiments of the present invention, the center of the sensor, where the digitally zoomed telephoto images are captured, is configured with dense pixilation, which enables higher quality digitally zoomed images.

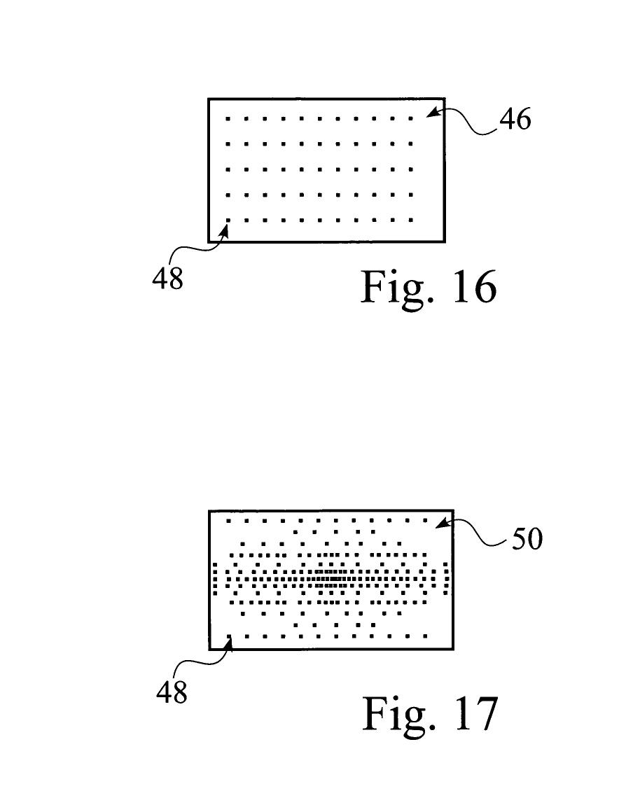

FIGS. 16 and 17 illustrate this feature, which utilizes a high density concentration of pixels 48 at the center of a sensor. By concentrating pixels near the central region of the sensor, digital zoom becomes possible without loss of image detail. This unique approach provides benefits for either flat or curved sensors. In FIG. 16, a conventional sensor 46 is shown, which has pixels 48 that are generally uniformly disposed over the surface of the sensor 46. FIG. 17 shows a sensor 50 produced in accordance with the present invention, which has pixels 48 that are more densely arranged toward the center of the sensor 50.

In another embodiment of the invention, suitable software compresses the dense data coming from the center of the image when the camera senses that a wide angle picture is being taken. This feature greatly reduces the processing and storage requirements for the system.

### Lens Shade

Other embodiments of the invention include a lens shade, which senses the image being captured, whether wide angle or telephoto. When the camera senses a wide angle image, it retracts the shade, so that the shade does not get into the image area. When it senses the image is telephoto, it extends, blocking extraneous light from the non-image areas, which can cause flare and fogged images.

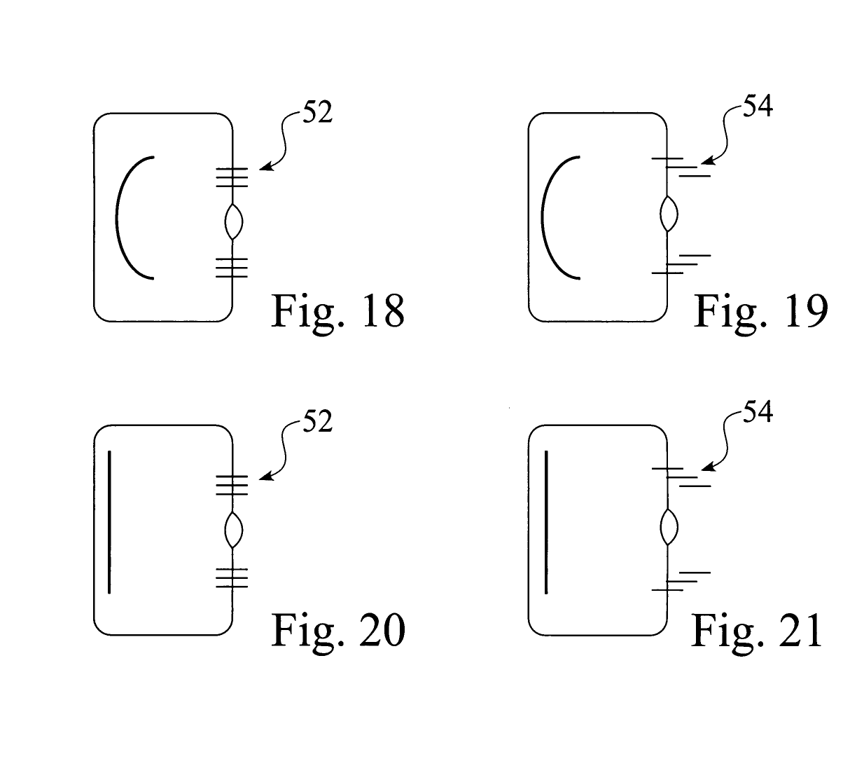

FIGS. 18 and 19 provide views of a camera equipped with an optional retractable lens shade. For wide angle shots, the lens shade is retracted, as indicated by reference character 52. For telephoto shots, the lens shade is extended, as indicated by reference character 54.

FIGS. 20 and 21 provide similar views to FIGS. 18 and 19, but of a camera with a planar sensor, indicating that the lens shade feature is applicable independently.

### Dust Reduction

Embodiments of the present invention reduce the dust problem that plagues conventional cameras since no optical zoom or lens changes are needed. Accordingly, the camera incorporated into the mobile communication device is sealed. No dust enters to interfere with image quality. An inert desicate gas, such as Argon, Xenon or Krypton may be sealed in the lens and sensor chambers within the enclosure 14, reducing oxidation and condensation. If these gases are used, the camera gains some benefits from their thermal insulating capability and temperature changes will be moderated, and the camera can operate over a wider range of temperatures.

### Improved Optical Performance

The present invention may be used in conjunction with a radically high speed lens, useable for both surveillance without flash (or without floods for motion) or fast action photography. This becomes possible again due to the non-planar sensor, and makes faster ranges like a f/0.7 or f/0.35 lens designs, and others, within practical reach, since the restraints posed by a flat sensor (or film) are now gone.

All these enhancements become practical since new lens formulas become possible. Current lens design for flat film and sensors must compensate for the “rainbow effect” or chromatic aberrations at the sensor edges, where light travels farther and refracts more. Current lens and sensor designs, in combination with processing algorithms, have to compensate for the reduced light intensity at the edges. These compensations limit the performance possibilities.

Since the camera lens and body are sealed, an inert gas like Argon, Xenon or Krypton may be inserted, e.g., injected during final assembly, reducing corrosion and rust. The camera can then operate in a wider range of temperatures. This is both a terrestrial benefit, and, is a huge advantage for cameras installed on satellites.

### Rotating & Shifted Sensors

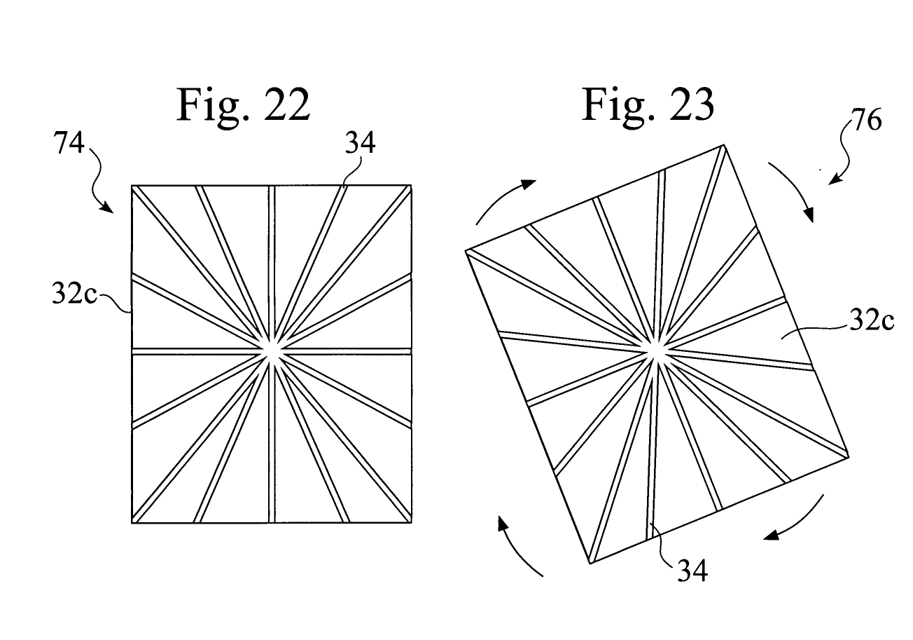

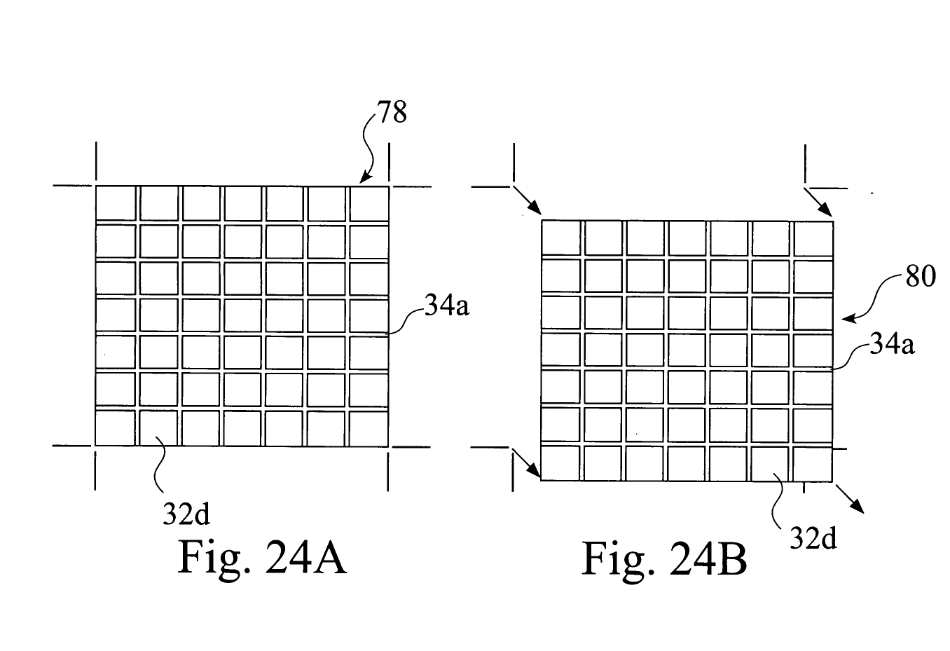

FIGS. 22 and 23 illustrate a series of alternative sensor arrays with sensor segments 32c separated by gaps 34, which are necessary when tilting each outer row inward, row by row, further and further, to form the overall concave shade of the overall sensor, which facilitates easier sensor assembly. In this embodiment, a still camera which utilizes this sensor array takes two pictures in rapid succession. A first sensor array is shown in its original position 74, and is also shown in a rotated position 76. The position of the sensor arrays changes between the times the first and second pictures are taken. Software is used to recognize the images missing from the first exposure, and stitches that data in from the second exposure. The change in the sensor motion or direction shift may vary, depending on the pattern of the sensor facets.

A motion camera can do the same, or, in a different embodiment, can simply move the sensor and capture only the new image using the data from the prior position to fill in the gaps in a continuous process.

This method captures an image using a moveable sensor with gaps between the smaller sensors that make up its concave shape. This method makes fabricating much easier, because the spaces between segments become less critical. So, in one example, a square sensor in the center is surrounded by a row of eight more square sensors, which, in turn, is surrounded by another row of sixteen square sensors. The sensors are sized to fit the circular optical image, and each row curves in slightly more, creating the non-planar total sensor.

In use, the camera first takes one picture. The sensor immediately rotates or shifts slightly and a second image is immediately captured. Software can tell where the gaps were and stitches the new data from the second shot into the first. Or, depending on the sensor's array pattern, it may shift linearly in two dimensions, and possibly move in an arc in the third dimension to match the curve.

This concept makes the production of complex sensors easier. The complex sensor, in this case, is a large sensor comprising multiple smaller sensors. When such a complex sensor is used to capture a focused image, the gaps between each sensor lose data that is essential to make the complete image. Small gaps reduce the severity of this problem, but smaller gaps make the assembly of the sensor more difficult. Larger gaps make assembly easier and more economical, but, create an even less complete image. The present method, however, solves that problem by moving the sensor after the first image, and taking a second image quickly. This gives the complete image and software can isolate the data that is collected by the second image that came from the gaps and splice it into the first image.

The same result may be achieved by a moving or tilting lens element or a reflector that shifts the image slightly during the two rapid sequence exposures. In this embodiment, the camera uses, but changes in a radical way, an industry technique known as “image stabilization.” The camera may use image stabilization in both the first and second images. This method neutralizes the effect of camera motion during an exposure. Such motion may come from hand tremors or engine vibrations. However, in this embodiment, after the first exposure, the camera will reverse image stabilization and introduce “image de-stabilization” or “intentional jitter” to move the image slightly over the sensor for the second exposure. This, with a sensor fixed in its position, also gives a shift to the second exposure so the gaps between the facets from the first exposure can be detected, and, the missing imagery recorded and spliced into the final image.

In one example shown in FIG. 23, the sensor rotates back and forth. In an alternative embodiment, the sensor may shift sideways or diagonally. The sensor may also be rotated through some portion of arc of a full circle. In yet another embodiment, the sensor might rotate continuously, while the software combines the data into a complete image.

FIGS. 24A and 24B also shows a second set of sensors. The sensor is first shown in its original position 78, and is then shown in a displaced position 80.

### Sensor Grid Patterns

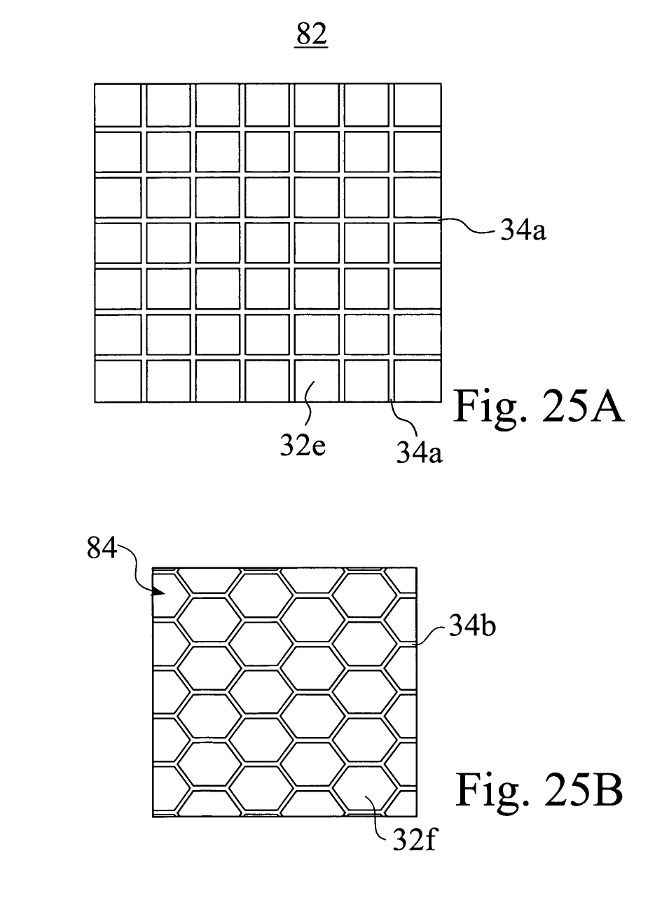

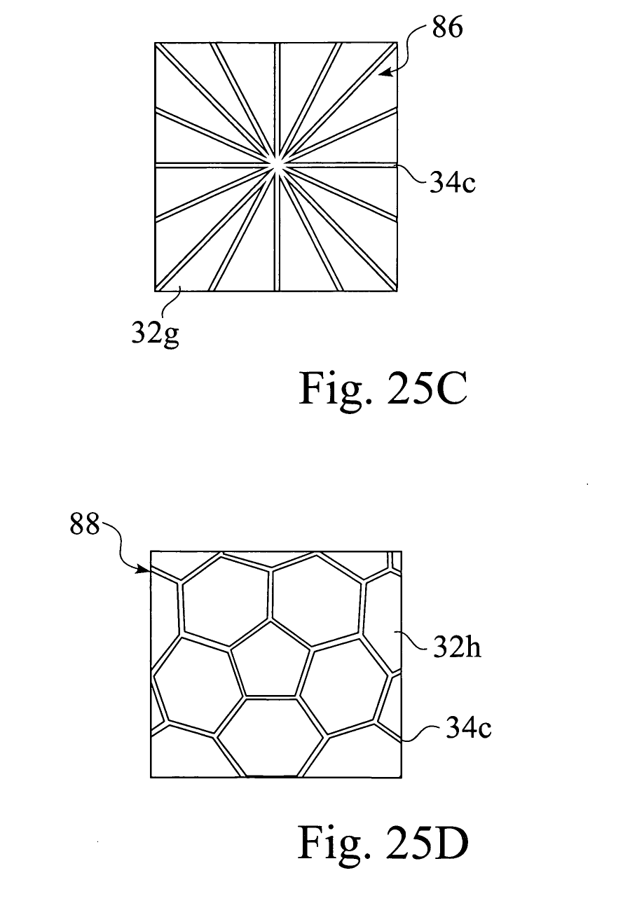

FIGS. 25A, 25B, 25C and 25D reveal four alternative grid patterns for four alternative embodiments of sensors 82, 84, 86 and 88. The gaps 34 between the facets 32e, 32f, 32g and 32h enable the manufacturing step of forming a curved sensor.

### Electrical Connections to Sensors

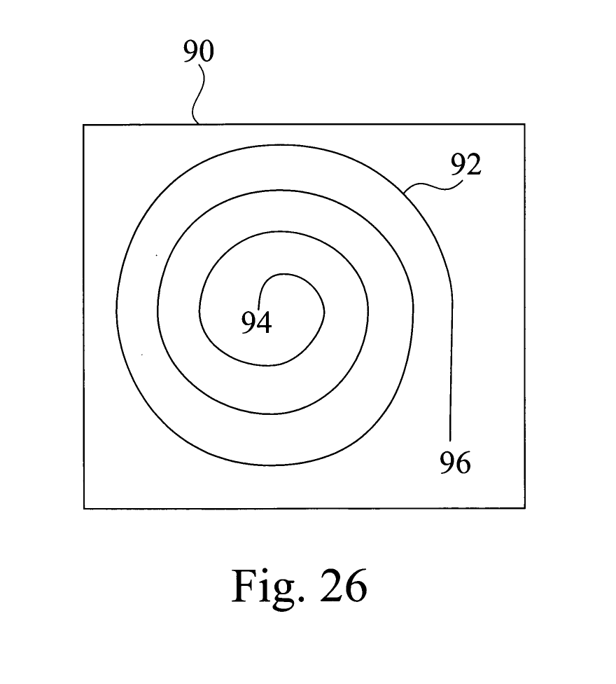

FIGS. 26, 27 and 28 provide views of alternative embodiments of electrical connections to moving sensors.

FIG. 26 shows a sensor 90 has a generally spiral-shaped electrical connector 92. The conductor is connected to the sensor at the point identified by reference character 94, and is connected to a signal processor at the point identified by reference character 96. This embodiment of an electrical connection may be used when the sensor is rotated slightly between a first and second exposure, as illustrated in FIG. 23. This arrangement reduces the flexing of the conductor 92, extending its life. The processor may built into the sensor assembly.

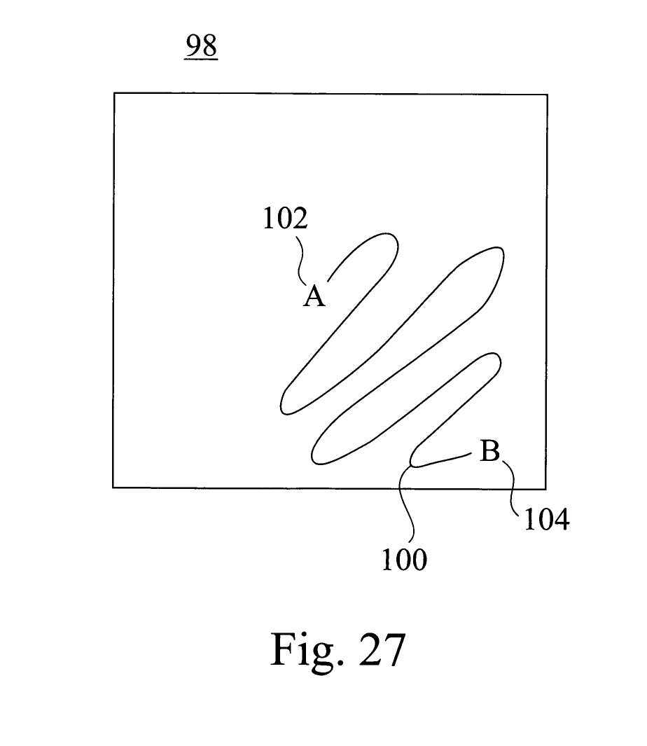

FIG. 27 shows the back of a sensor 102 with an “accordion” shape conductor 100, which is joined to the sensor at point A and to a processor at point B. This embodiment may be used when the sensor is shifted but not rotated between a first and second exposure, as illustrated in FIG. 24.

This type of connection, like the coiled wire connection, makes a 20 back and forth sensor connection durable.

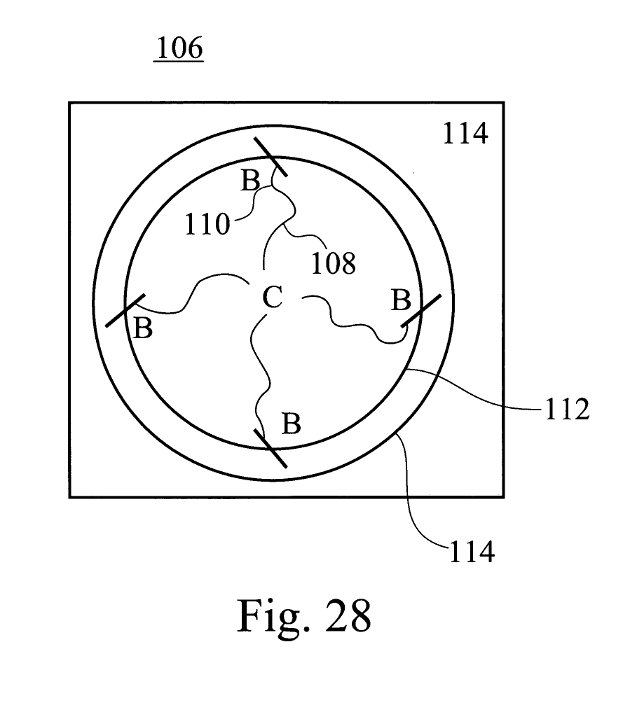

FIG. 28 shows the back of a sensor 114 having generally radially extending conductors. The conductors each terminate in brush B which are able to contact a ring. The brushes move over and touch the ring, collecting an output from the rotating sensor, and then transmit the output to the processor at the center C. This embodiment may be used when the sensor is rotated between exposures. In addition, this connection makes another embodiment possible; a continuously rotating sensor. In that embodiment, the sensor rotates in one direction constantly. The software detects the gaps, and fills in the missing data from the prior exposure.

### Wireless Connection

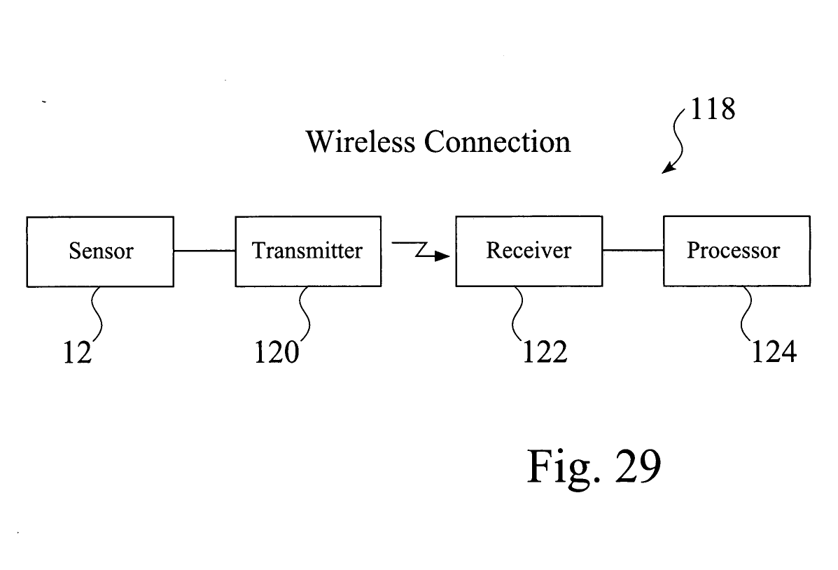

FIG. 29 offers a block diagram of a wireless connection 118. A sensor 12 is connected to a transmitter 120, which wirelessly sends signals to a receiver 122. The receiver is connected to a signal processor 124.

In summary, the advantages offered by the present invention include, but are not limited to:

High resolution digital zoom

### Faster

### Lighter

### Cheaper

Longer focusing ranges
More reliable
Lower chromatic aberration
More accurate pixel resolution
Eliminate need for flash or floodlights
Zooming from wide angle to telephoto

### Section 3. Additional Embodiments

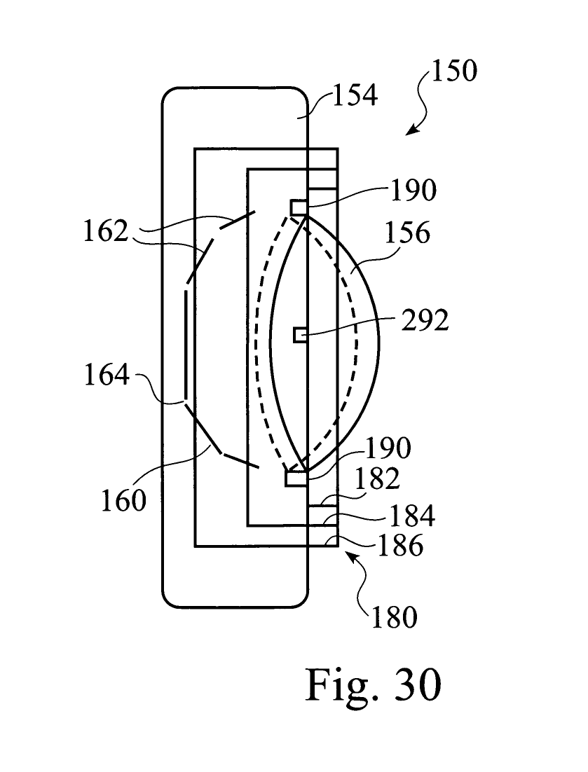

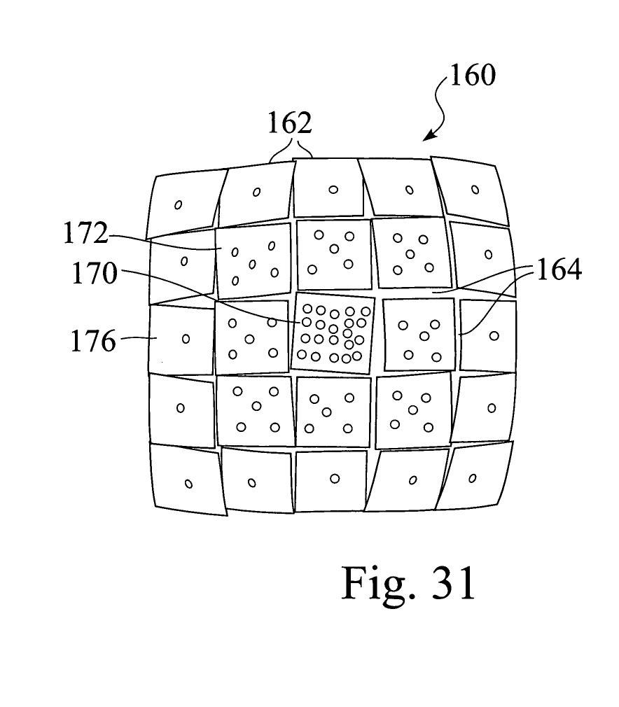

A mobile communication device including a camera 150 having many of the preferred features of the present invention will now be described with reference to FIGS. 30 and 31.

It will be understood that numerous conventional features such as a battery, shutter release, aperture monitor and monitor screen have been omitted for the purposes of clarity.

The camera comprises an hermetically-sealed enclosure 154 accommodating a generally curved sensor 160 and a lens 156. Enclosure 154 is filled with Argon, Xenon or Krypton. A front view of the sensor 160 is illustrated schematically in FIG. 3.1 and comprises a plurality of flat square pixel elements or facets 162 arranged to be relatively inclined so as to form an overall curved configuration. To minimize the area of the substantially triangular gaps 164 which result between the elements 162, the center square 170 is the largest, and the adjacent ring of eight squares 172 is made of slightly smaller squares so that they touch or nearly touch at their outermost corners. The next ring of sixteen squares 176 has slightly smaller squares than the inner ring 172.

The center square 170 has the highest density of pixels; note that this square alone is used in the capture of telephoto images. The squares of inner ring 172 have medium density pixilation, which for normal photography gives reasonable definition. The outer ring 176 of sixteen squares has the least dense pixel count.

In this embodiment, the gaps 164 between the elements 162 are used as pathways for electrical connectors.

The camera 150 further comprises a lens shade extender arrangement 180 comprising a fixed, inner shade member 182, first movable shade member 184 and a second, radially outermost, movable shade member 186. When the operator is taking a wide angle photograph, the shade members are in a retracted disposition as shown in FIG. 30; only stray light from extremely wide angles is blocked. In this mode, to reduce data processing time and storage requirements, the denser pixel data from the central portions 170, 172 of the curved sensor can be normalized across the entire image field to match the less dense pixel counts of the edge facets 176 of the sensor.

For a normal perspective photograph, the shade member 184 is extended so that stray light from outside of the viewing area is blocked. In this mode, a portion of the data facets 172 of the curved sensor are compressed. To reduce processing time and storage requirements, the data from the most center area 170, with higher density of pixels, can be normalized across the entire image field.

When the user zooms out digitally to a telephoto perspective, shade member 186 is extended. In this mode, only the center portion 170 of the curved sensor 160 is used. Since only that sensor center is densely covered with pixels, the image definition will be crisp.

Photographers generally zoom to fill the frame and to block out distractions. The lens shade works on a wide range of settings, and has an infinite number of positions between the widest angle and the narrowest telephoto positions. An alternative embodiment utilizes a single shade element. Other alternative embodiments may include two or more elements. The embodiments that use multiple shade elements have a telephoto element inside the other elements.

In operation, camera 150 uses two exposures to fill in any gaps within the sensors range, i.e., to obtain the pixel data missing from a single exposure due to the presence of gaps 164. For this purpose, the camera deploys one of two methods. In the first, as previously described, the sensor moves and a second exposure is taken in rapid succession. The processing software detects the image data that was missed in the first exposure, due to the sensor's gaps, and “stitches” that missing data into the first exposure. This creates a complete image. The process is run continuously for motion pictures, with the third exposure selecting missing data from either the preceding or the following exposure, again to create a complete image.

In the second method, a radical change to the now-standard process known in the industry as “image stabilization” is used. For the first exposure, the image is stabilized. Once recorded, this “image stabilization” is turned off, the image is shifted by the stabilization system, and the second image is taken while it is re-stabilized. In this method, a complete image is again created, but without any motion required of the sensor.

The dashed lines shown in FIG. 30 indicate the two-dimensional motion of the lens for one embodiment of the focusing process.

In another embodiment of the invention that includes intentional jittering, the lens does not move back and forth, but, rather, tilts to alter the position of the image on the sensor.

The above-described camera 150 has numerous advantages. The sealing of the enclosure 154 with a gas like argon prevents oxidation of the parts and provides thermal insulation for operation throughout a broader range of temperature.

Although the center square 170 with a high pixel density is relatively expensive, it is relatively small and it is only necessary to provide a single such square, this keeping down the overall cost. A huge cost advantage is that it provides an acceptable digital zoom without the need for accessory lenses. Accessory lenses cost far, far more than this sensor, and are big, heavy and slow. The outer ring 176 has the smallest squares and the lowest pixel count and so they are relatively inexpensive. Thus, taking into account the entire assembly of squares, the total cost of the sensor is low, bearing in mind it is capable of providing an acceptable performance over a wide range of perspectives.

Numerous modifications may be made to the camera 150. For example, instead of being monolithic, lens 156 may comprise a plurality of elements.

The enclosure 154 is sealed with another inert gas, or a non-reactive gas such as Nitrogen, Krypton, Xenon or Argon; or it may not be sealed at all.

The pixels or facets 170, 172, 176 may be rectangular, hexagonal or of any other suitable shape. Squares and rectangles are easiest to manufacture. Although a central pixel and two surrounding “square rings” of pixels are described, the sensor may comprise any desired number of rings.

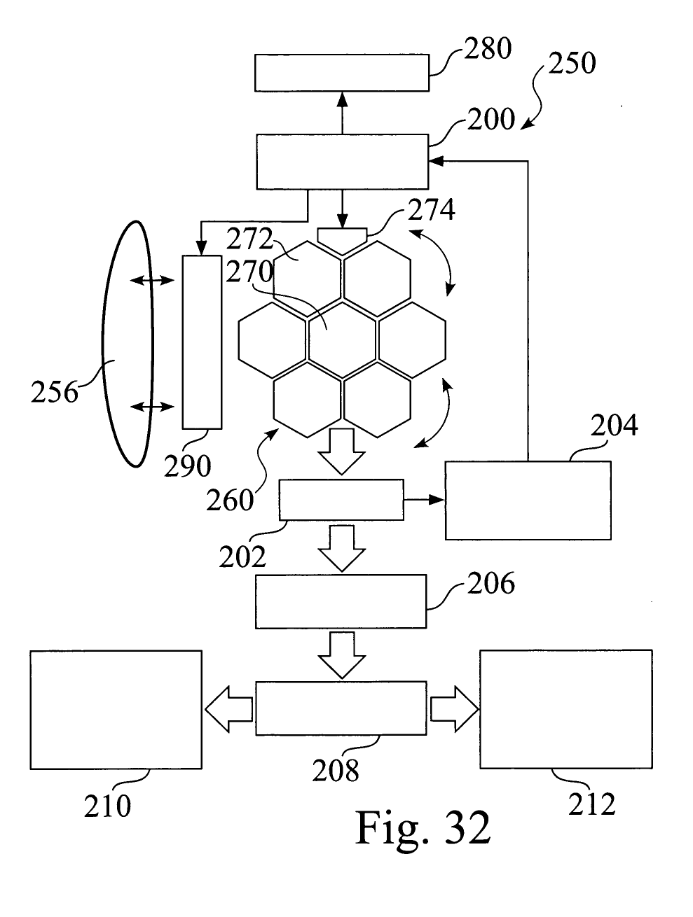

In FIG. 32, there is shown a block diagram of a camera 250 having many of the features of the camera 150 of FIGS. 30 and 31. A non-planar sensor 260 has a central region 270 with high pixel density and a surrounding region comprising facets 272 with low pixel density. A shutter control 274 is also illustrated. The shutter control 274 together with a focus/stabilization actuating mechanism 290 for lens 256 and a lens shade actuator 280 are controlled by an image sequence processor 200. The signals from pixels in facets 270, 272 are supplied to a raw sensor capture device 202. Another output of device 202 is supplied to a device 206 for effecting pixel density normalization, the output of which is supplied to an image processing engine 208. A first output of engine 208 is supplied to a display/LCD controller 210. A second output of engine 208 is supplied to a compression and storage controller 212.

The features and modifications of the various embodiments described may be combined or interchanged as desired.

### Section 4. Mobile Communicator with a Curved Sensor Camera

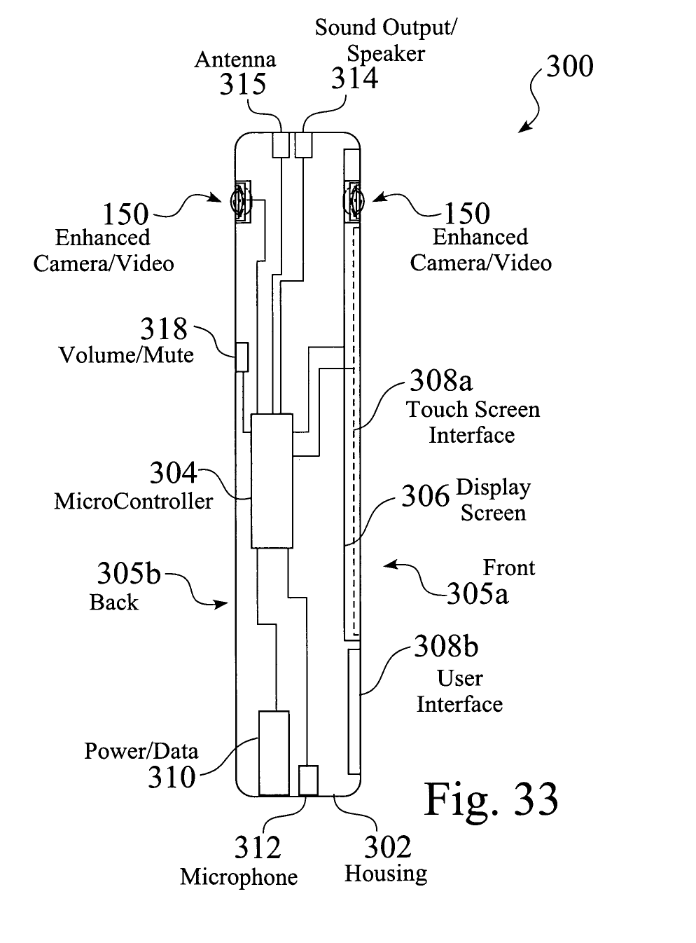

FIGS. 33, 34, 35 and 36 present views of one embodiment of the invention, which combines a curved sensor camera with a mobile communication device. The device may be a cellular telephone; laptop, notebook or netbook computer; or any other appropriate device or means for communication, recordation or computation.

FIG. 33 shows a side view 300 of one particular embodiment of the device, which includes an enhanced camera 150 for still photographs and video on both the front 305a and the back 305b sides. A housing 302 encloses a micro-controller 304, a display screen 306, a touch screen interface 308a and a user interface 308b. A terminal for power and/or data 310, as well as a microphone, are located near the bottom of the housing 302. A volume and/or mute control switch 318 is mounted on one of the slender sides of the housing 302. A speaker 314 and an antenna 315 reside inside the upper portion of the housing 302.

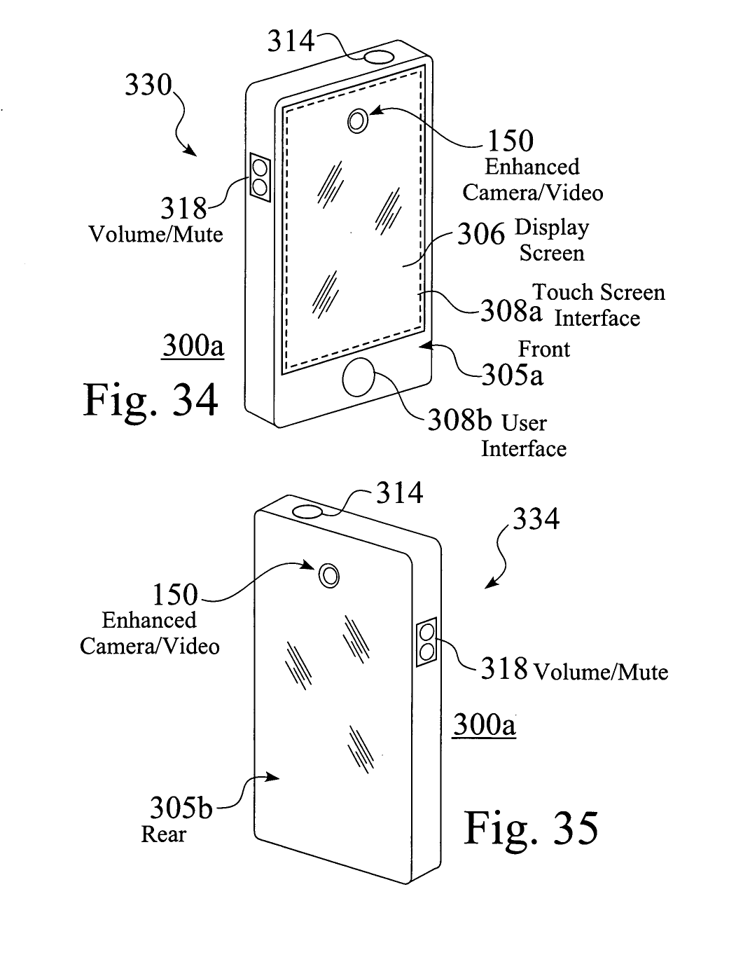

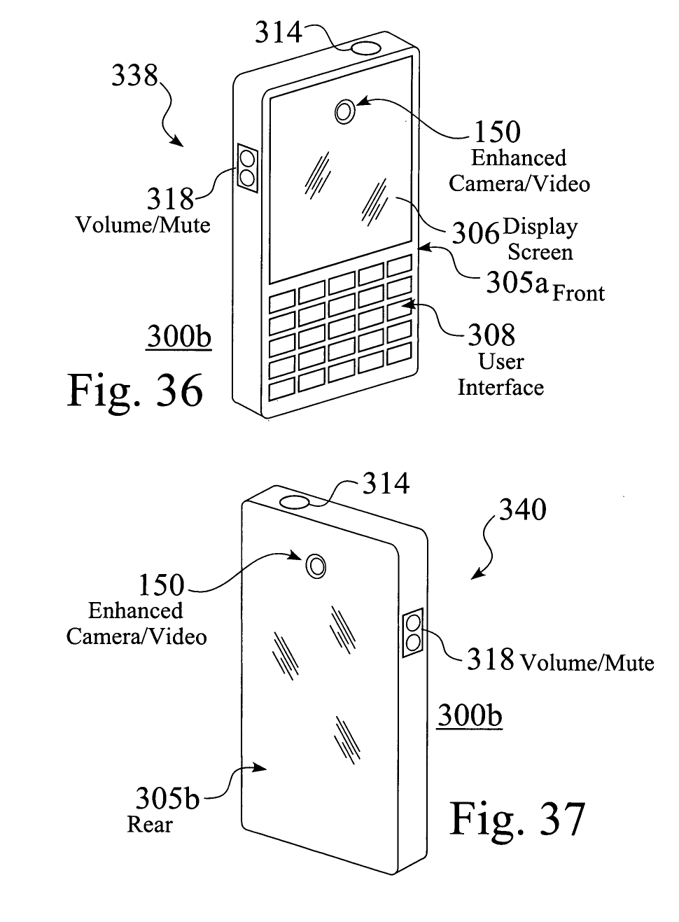

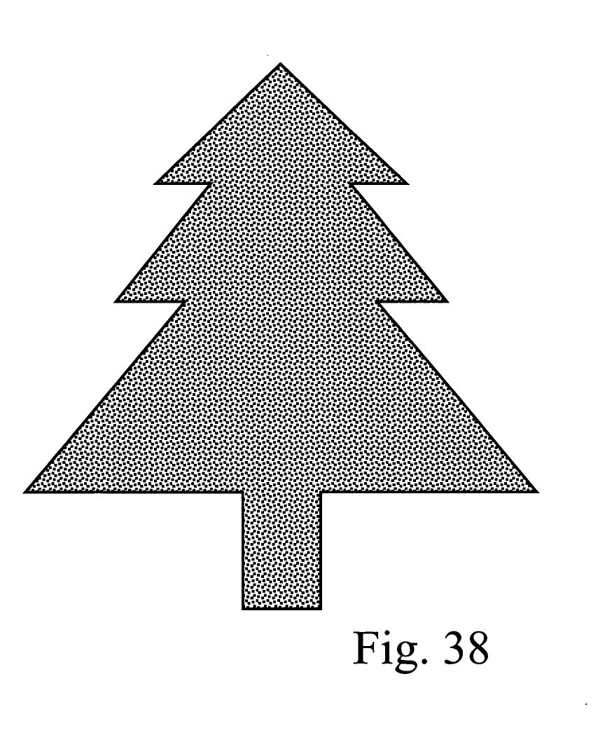

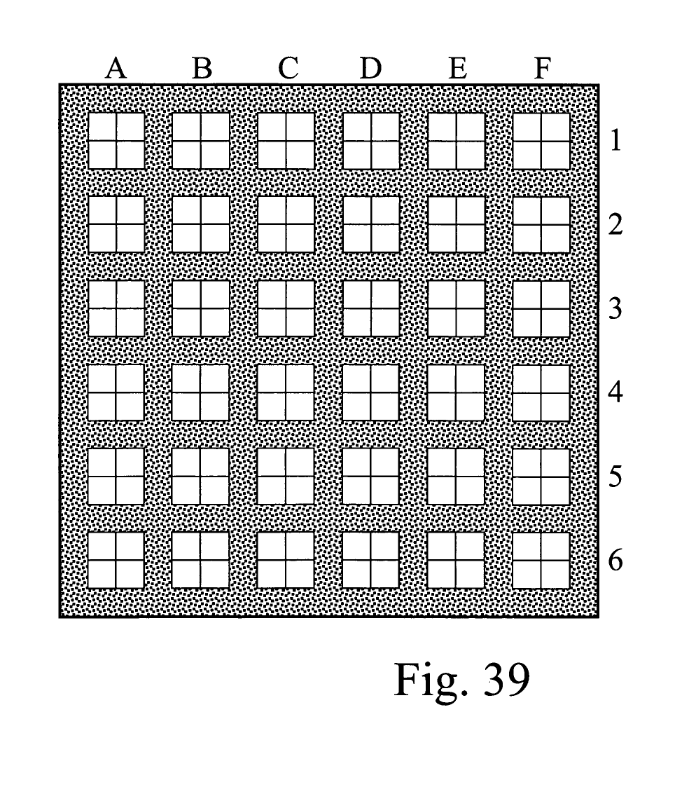

FIGS. 34 and 35 offer perspective views 330 and 334 of an alternative embodiment 300a. FIGS. 36 and 37 offer perspective views 338 and 340 of yet another alternative embodiment 300b.

### Section 5. Method to Capture More Detail from a Scene than the Sensor is Otherwise Capable of Recording

This alternative method uses multiple rapid exposures with the image moved slightly and precisely for each exposure.

In the illustrated example, four exposures are taken of the same scene, with the image shifted by ½ pixel in each of four directions for each exposure. (In practice, three, four, five or more exposures might be used with variations on the amount of image shifting used.)

For this example, FIG. 38 shows a tree. In this example, it is far from the camera, and takes up only four pixels horizontally and the spaces between them, plus five pixels vertically with spaces.

(Cameras are currently available at retail with 25 Megapixel resolution, so this tree image represents less than one millionth of the image area and would be undetectable by the human eye without extreme enlargement.)

FIG. 39 represents a small section of the camera sensor, which might be either flat or curved. For the following explanation, vertical rows are labeled with letters and horizontal rows are labeled with numbers. The dark areas represent spaces between the pixels.

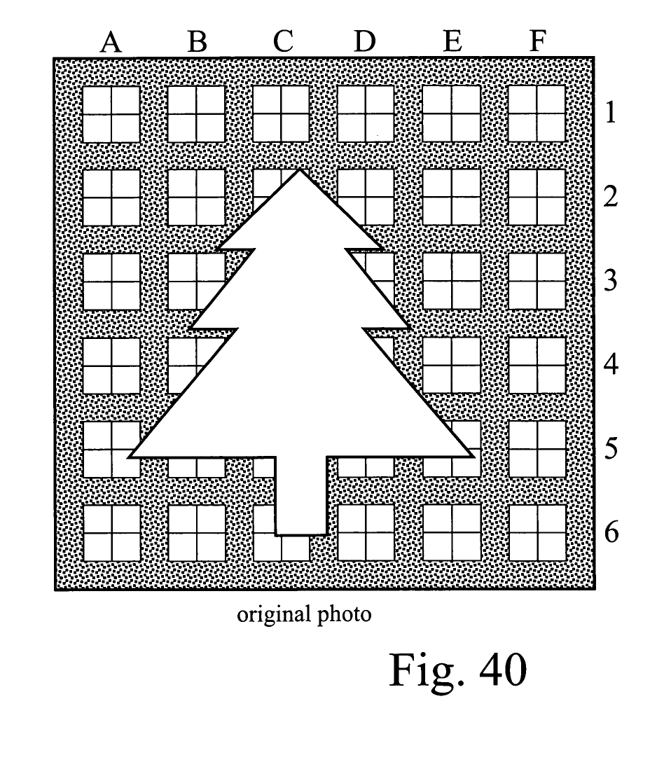

FIG. 40 shows how the tree's image might be first positioned on the pixels. Note that only pixels C2, C3, D3, C4, D4, B5, C5 and D5 are “more covered than not” by the tree image. Those, then, are the pixels that will record its image.

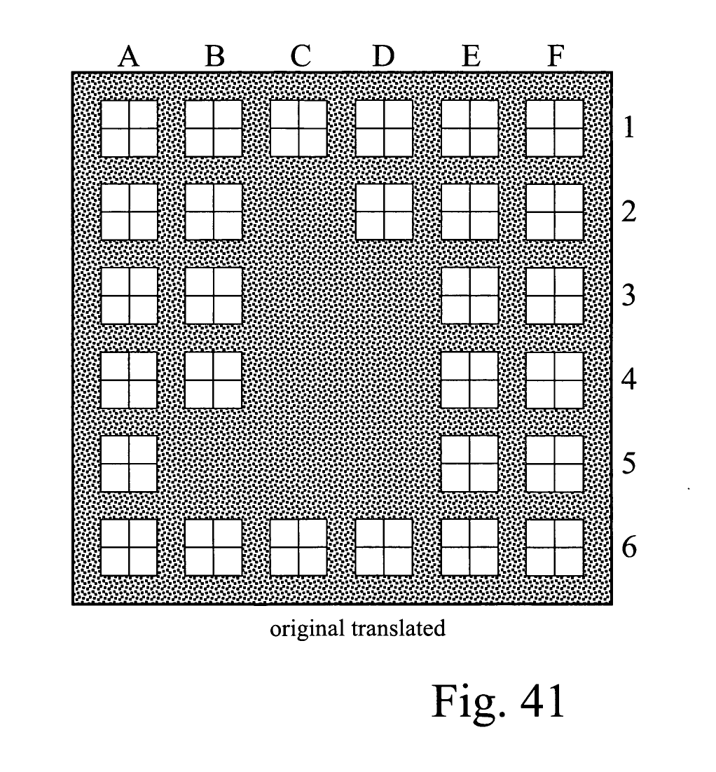

FIG. 41 then shows the resulting image that will represent the tree from this single exposure. The blackened pixels will be that first image.

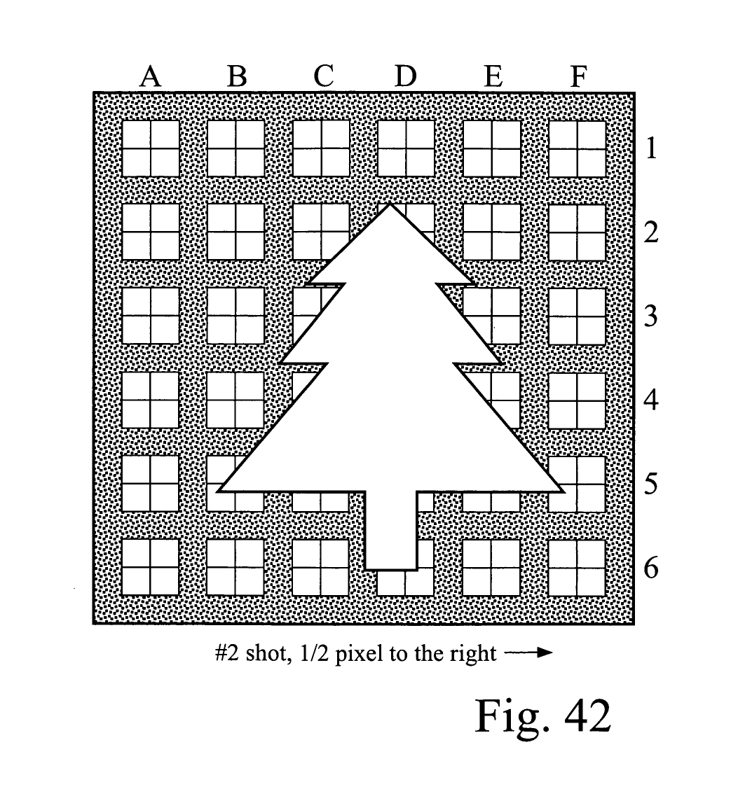

FIG. 42, however, represents a second exposure. Note that the image for this exposure has been shifted by ½ pixel to the right. This shift might be done by moving the sensor physically, or, by reversing the process known in the industry as “image stabilization.” Image stabilization is a method to eliminate blur caused by camera movement during exposures. Reversing that process to move the image focused on the sensor, for the additional exposures, and reversing only between those exposures, is a unique concept and is claimed for this invention.

With FIG. 42, the resulting pixels that are “more covered than not” by the image are D2, C3, D3, C4, D4, (E4 might go either way) C5, D5 and E5.

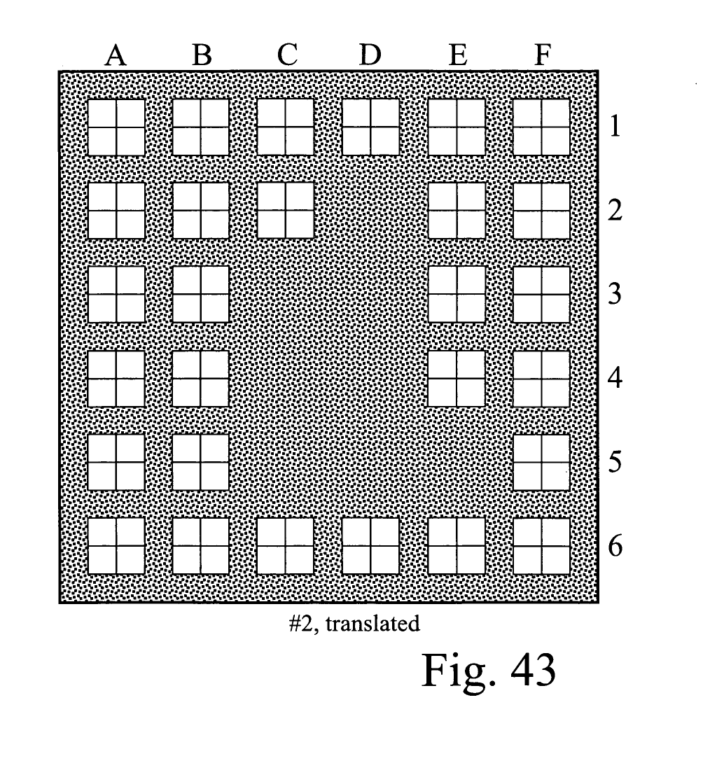

This results in a data collection for this image as shown by FIG. 43.

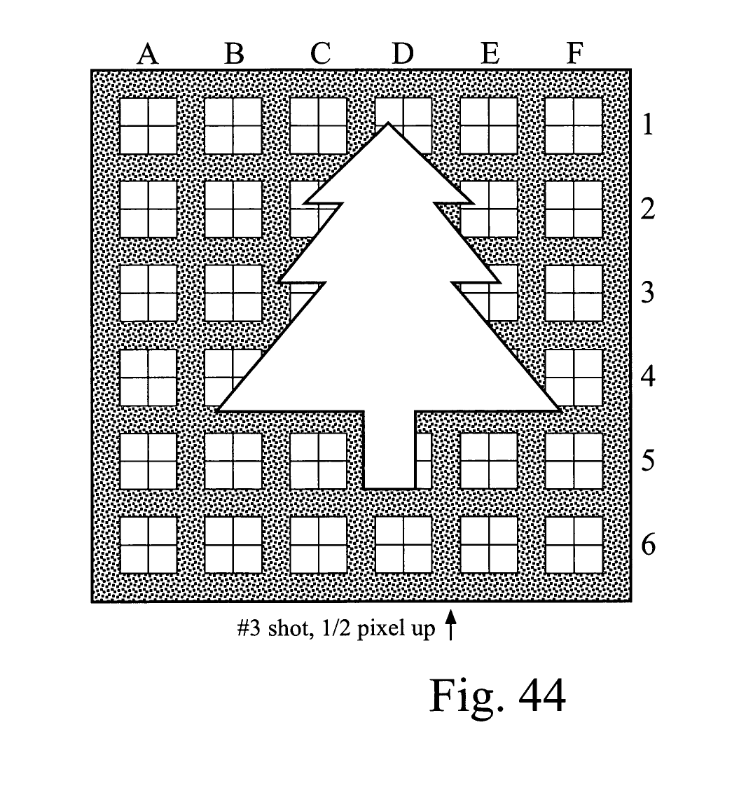

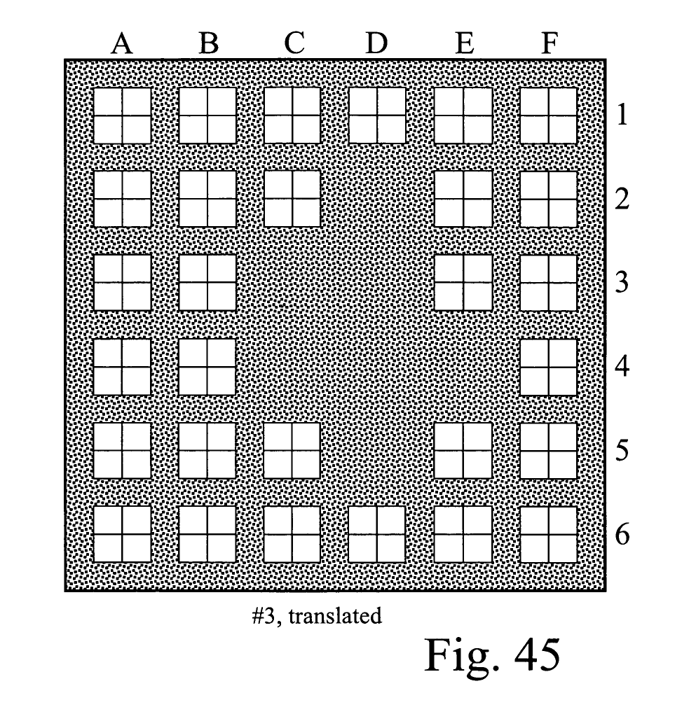

FIG. 44 represents a third exposure. This time the image is moved up from exposure 2 by ½ pixel. The results are that the tree is picked up on pixels D2, C3, D3, C4, D4, E4 and D5.

This third exposure, then, is represented by data collected as shown in FIG. 45.

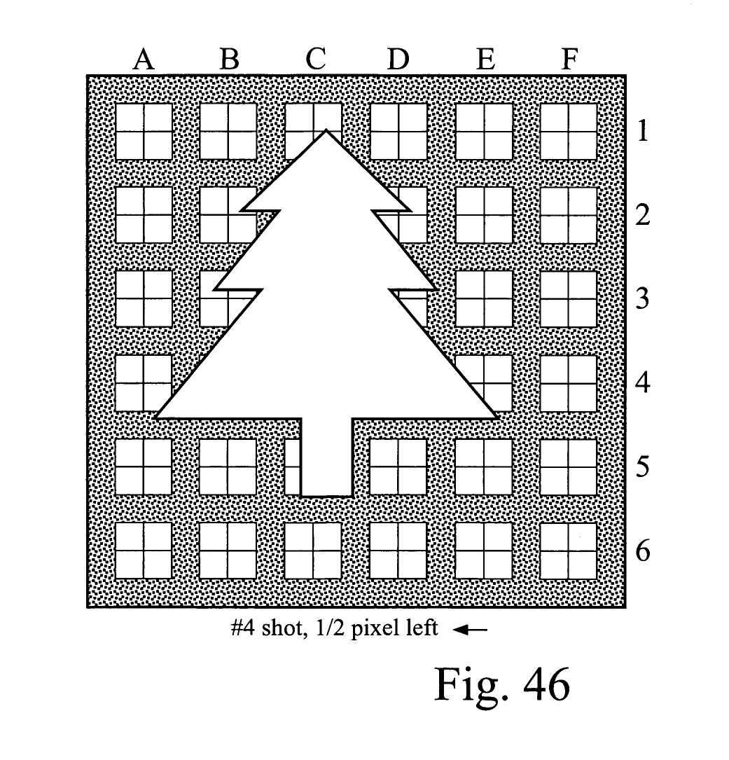

FIG. 46 continues the example. In this case, the image is now shifted to the left by ½ pixel from the third exposure. The result is that imagery is caught by pixels C2, C3, D3, B4, C4, D4 and C5.

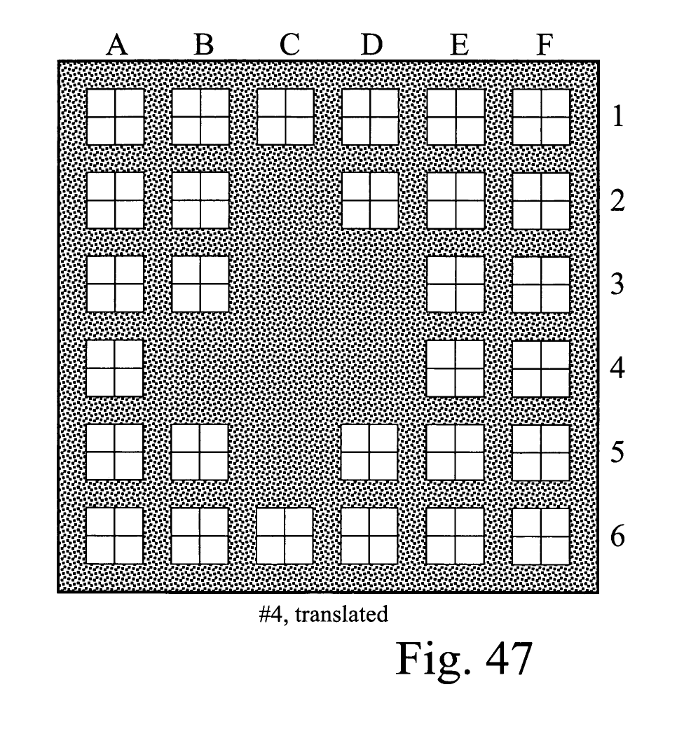

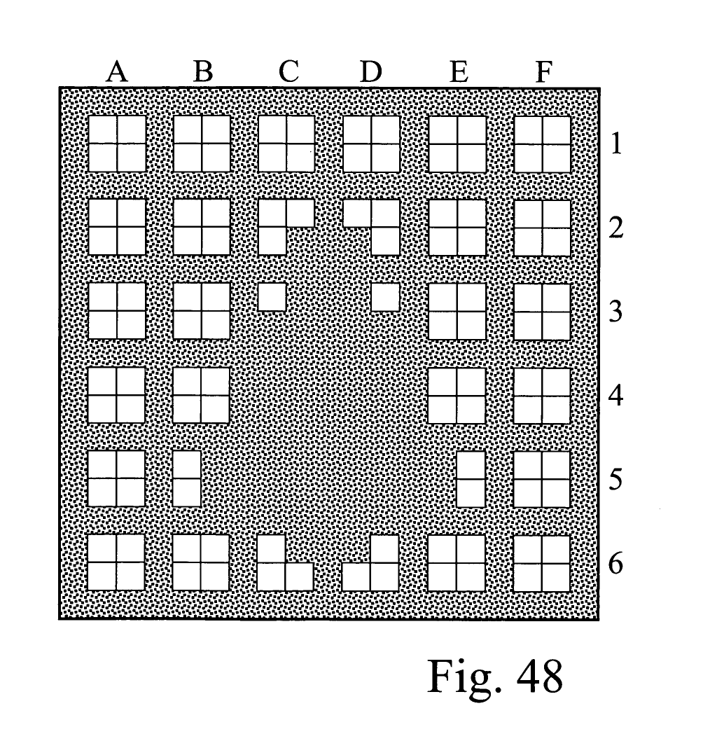

FIG. 47 represents that fourth recorded image.

Now the camera has four views of the same tree image.

Current image stabilization neutralizes tiny hand tremors and even some motor or other vibrations during a single exposure, eliminating blur. That capability suggests moving the image to second, third and fourth or more positions can occur quickly.

Pixel response times are also improving regularly, to the point that digital cameras that were formerly only still cameras, have, for the most part, also become motion picture cameras in subsequent model enhancements. This also suggests that rapid multiple exposures can be done; particularly since this is the essence of motion photography.

What has not been done or suggested is changing the mode of the image stabilization mechanism so that it moves the image slightly, and by a controlled amount, for each of the multiple exposures, while stabilizing the image during each exposure.

Alternatively, moving the sensor slightly for the same effect is also a novel method.

Software interprets the four captured images and are part of this invention's claims. The software “looks” at FIGS. 45 and 47, and conclude that whatever this image is, it has a stub centered at the bottom. Because this stub is missing from FIGS. 41 and 43, the software concludes that it is one pixel wide and is a half pixel long.

The software looks at all four figures and determine that whatever this is, it has a base that's above that stub, and that base is wider than the rest of the image, going three pixels horizontally. This comes from line five in FIGS. 41 and 43 plus line four in FIGS. 45 and 47.

The software looks at lines three and four in FIG. 41 and FIG. 43 and conclude that there is a second tier above the broad base in this image, whatever it is, that is two pixels wide and two pixels tall.

But, the software also looks at lines three in FIG. 45 and FIG. 47, confirming that this second tier is two pixels wide, but, that it may only be one pixel tall.

The software averages these different conclusions and make the second tier 1½ pixels tall.

The software looks at line two in all four images and realize that there is a narrower yet image atop the second tier. This image is consistently one pixel wide and one pixel high, sits atop the second tier but is always centered over the widest bottom tier, and the stub when the stub appears.

FIG. 48 shows the resulting data image recorded by taking four images, each ½ pixel apart from the adjoining exposures taken. Note that since the data has four times as much information, the composite image, whether on screen or printed out, will produce ¼ fractions of pixels. This shows detail that the sensor screen was incapable of capturing with a single exposure.

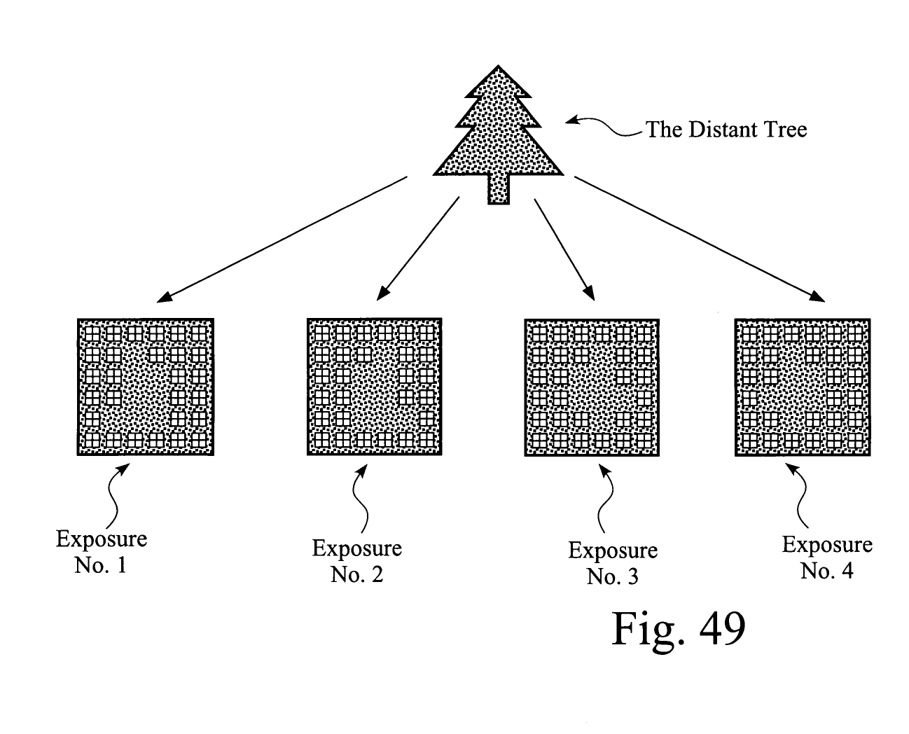

FIG. 49 shows the original tree image, as it would be digitally recorded in four varying exposures on the sensor, each positioned ½ pixel apart. FIG. 49 shows the tree itself, and the four typical digital images that would be recorded by four individual exposures of that tree. None look anything like a tree.

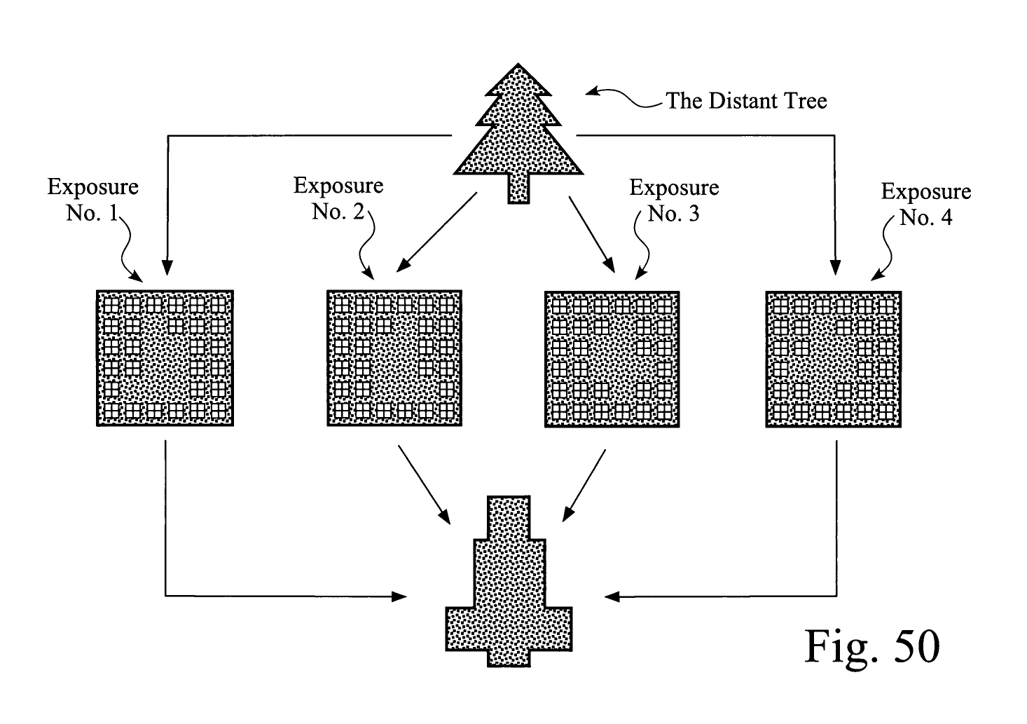

The tree is captured digitally four times. FIG. 50 shows how the original tree breaks down into the multiple images, and, how the composite, created by the software from those four images, starts to resemble a tree. The resemblance is not perfect, but is closer. Considering that this represents about 0.000001% of the image area, this resemblance could help some surveillance situations.

### Section 6. Alternative Method for Forming a Curved Sensor

One embodiment of this new method proposes to create a concave mold to shape the silicon after heating the wafer to a nearly molten state. Gravity then settles the silicon into the mold. In all of these methods, the mold or molds could be chilled to maintain the original thickness uniformly by reducing the temperature quickly. Centrifuging is a second possible method. The third is air pressure relieved by porosity in the mold. A fourth is steam, raised in temperature by pressure and/or a liquid used with a very high boiling point. The fourth is simply pressing a convex mold onto the wafer, forcing it into the concave mold, but again, doing so after raising the silicon's temperature.

Heating can occur in several ways. Conventional “baking” is one. Selecting a radiation frequency that affects the silicon significantly more than any of the other materials is a second method. To enhance that second method, a lampblack like material that absorbs most of the radiation might be placed on the side of the silicon that's to become convex, and is removed later. It absorbs the radiation, possibly burns off in the process but heats the thickness of the wafer unevenly, warming the convex side the most, which is where the most stretching occurs. A third method might be to put this radiation absorbing material on both surfaces, so the concave side, which absorbs compression tension and the convex side, which is pulled by tensile stresses, are each heated to manage these changes without fracturing.

A final method is simply machining, polishing or laser etching away the excess material to create the curved sensor. In the first embodiment, the curved surface is machined out of the silicon or other ingot material. The ingot would be thicker than ordinary wafers. Machining could be mechanical, by laser, ions or other methods.

In the second embodiment, the wafer material is placed over a pattern of concave discs. Flash heating lets the material drop into the concave shape. This may be simply gravity induced, or, in another embodiment, may be centrifuged. Another enhancement may be to “paint” the backside with a specific material that absorbs a certain frequency of radiation to heat the backside of the silicon or other material while transmitting less heat to the middle of the sensor. This gives the silicon or other material the most flexibility across the side being stretched to fit the mold while the middle, is less heated, holding the sensor together and not being compressed or stretched, but only bent. In another embodiment, the front side is “painted” and irradiated, to allow that portion to compress without fracturing. In another embodiment, both sides are heated at the same time, just before reforming. Radiation frequency and the absorbent “paint” would be selected to minimize or eliminate any effect on the dopants.

### Section 7. Improving Image Details

In another embodiment of the invention, a generally constant motion is deliberately imparted to a sensor and/or an optical element while multiple exposures are taken. In another embodiment, this motion may be intermittent. Software then processes the multiple exposures to provide an enhanced image that offers greater definition and edge detail. The software takes as many exposures as the user may predetermine.

In this embodiment, the sensor is arrayed with pixels having a variable density, with the highest density in the center of the pixels. When the sensor rotates, the motion on the outer edges is far greater than at the center, so with a consistent pixel density across the sensor, either too little would change in the center, or too much would change at the outer edges at any given speed. Varying pixel density solves that. By taking pictures with less than a pixel diameter of motion, enhanced detail is captured in the composite image.

Fixed Sensor with Moving Image

In one alternative embodiment of the invention, a stationary flat or curved sensor may be used to collect data or to produce an image using an image which moves in a circular motion. In one implementation of this embodiment, the circular path of the image has a diameter which is generally less than the width of a pixel on the sensor. In one embodiment, the circular path has a diameter which is half the width of a pixel. In this embodiment, pixel density is constant across the sensor. If the image was a picture of a clock, it would move constantly in a small circle, with the number 12 always on top and the number 6 always on the bottom. The present invention includes both embodiments—one in which the sensor moves under the objective lens, and another in which the image moves over the sensor.

Moving Sensor with Stationary Image

In yet another alternative embodiment of the invention, a flat or curved sensor which generally constantly moves in a tight circle may be used to collect data or to produce an image. In one implementation of this embodiment, the circular path of the moving sensor has a diameter which is generally less than the width of a pixel on the sensor. In one embodiment, the circular path has a diameter which is half the width of a pixel.

The advantages of these embodiments include:

Elimination of any reciprocal movement

No vibration

No energy loss from stop and go motions

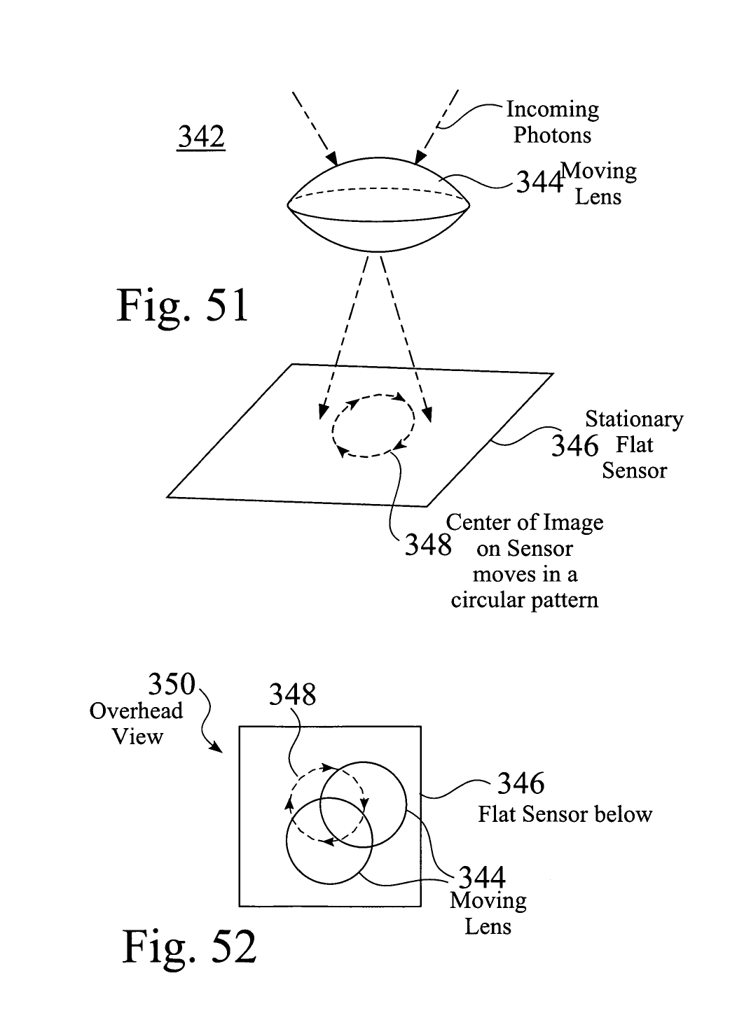

FIG. 51 presents a schematic illustration 342 of an optical element 344 which moves over a flat sensor 346. The optical element 344 moves in a tight circular path over the flat sensor to move the incoming light over the surface of the flat sensor along a tight circular path 348. In this embodiment, the optical element is shown as an objective lens. In other embodiments, any other suitable lens or optical component may be employed. In an alternative embodiment, the optical element 344 may tilt or nutate back and forth in a generally continuous or intermittent motion that moves the image in a tight circle over the surface of the stationary flat sensor 346.

FIG. 52 is an overhead view 350 of the same optical element 344 which moves over a the same stationary flat sensor 346 as shown in FIG. 51. The optical element 344 moves in a tight circular path over the sensor 346 to move the incoming light over the surface of the flat sensor 346.

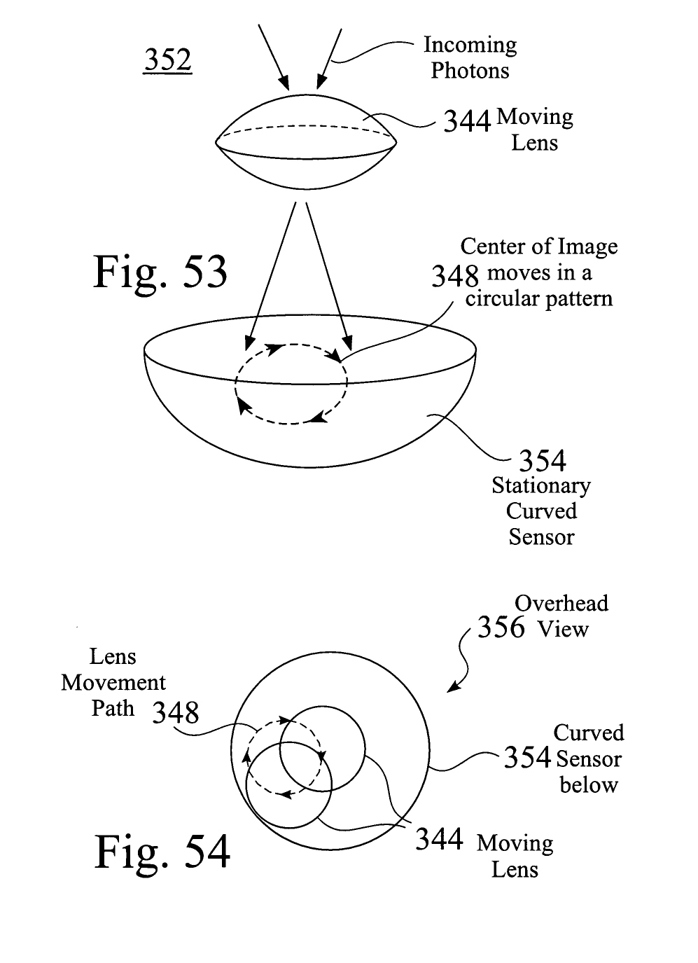

FIG. 53 furnishes a schematic illustration 352 of an optical element 344 which moves over a stationary curved sensor 354.

FIG. 54 is an overhead view 356 of the same optical element 344 and sensor 354 shown in FIG. 53.

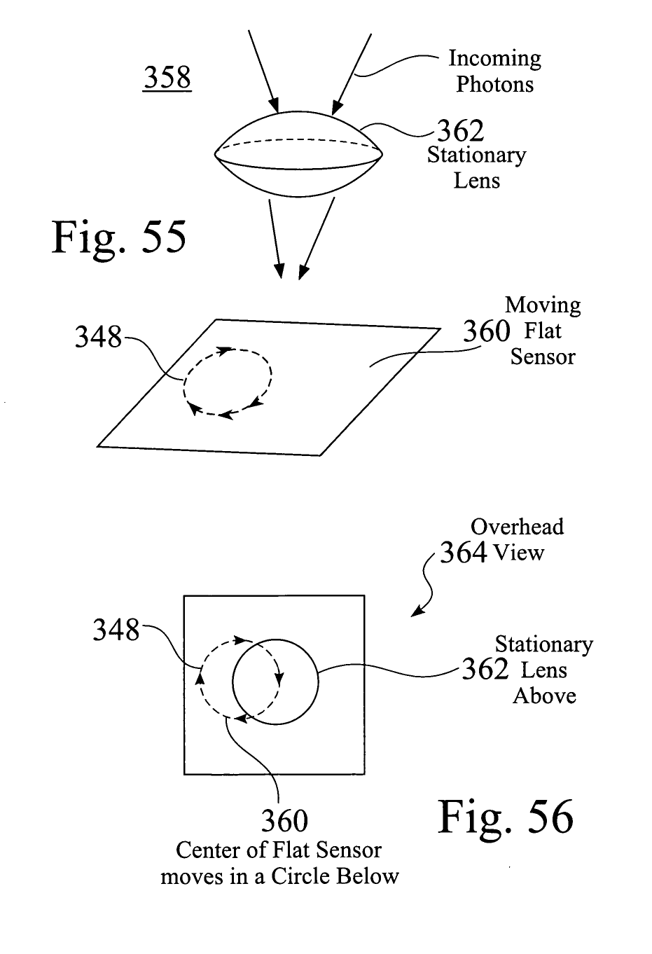

FIG. 55 supplies a schematic illustration 358 of one method for imparting motion to a flat sensor 360 as it moves beneath a stationary optical element 362.

FIG. 56 is an overhead view 372 of the same stationary optical element 362 and sensor 360 as shown in FIG. 55.

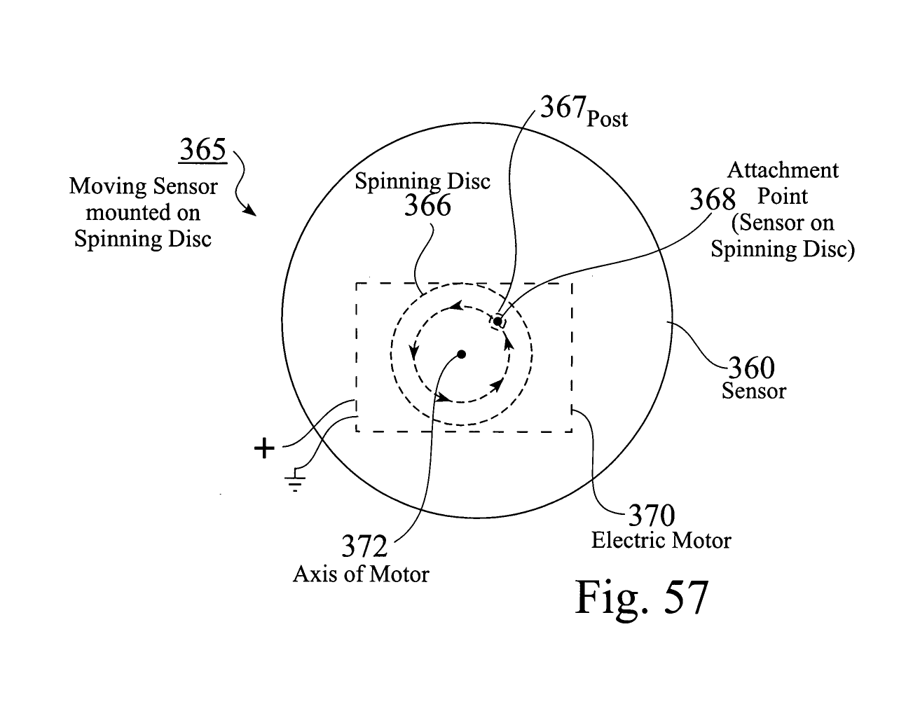

FIG. 57 is an illustration 364 that reveals the details of the components which impart the spinning motion to the sensor 360 shown in FIGS. 55 and 56. The flat sensor 360 is attached to a post or connector 364 which is mounted on a spinning disc 366 which is positioned below the sensor 360. The attachment is made at an off-center location 368 on the disc which is not the center of the disc. The disc is rotated by an electric motor 370, which is positioned below the disc. The axis 372 of the motor is not aligned with the attachment point 368 of the connecting post 364.

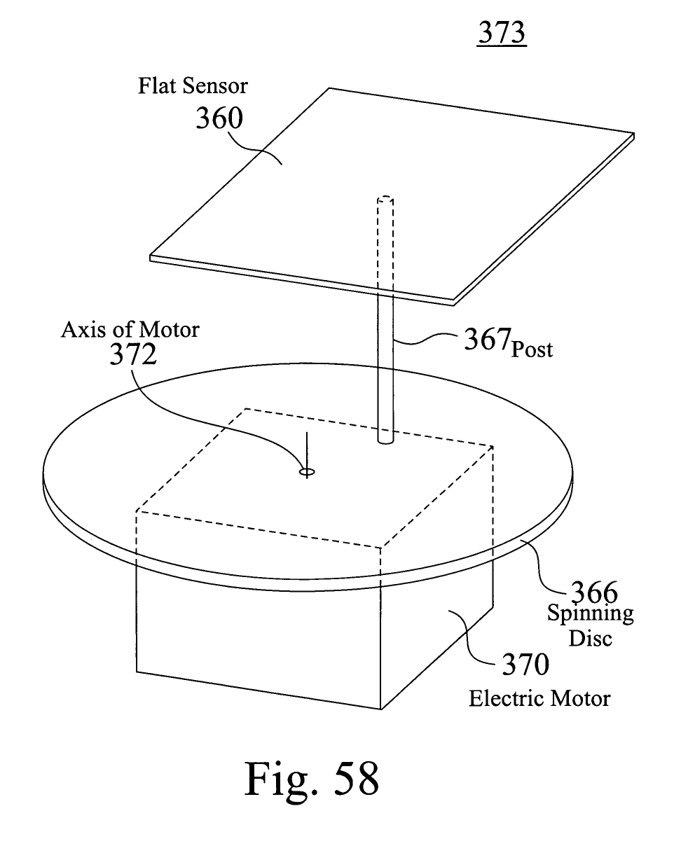

FIG. 58 offers a perspective view of the components shown in FIG. 57.

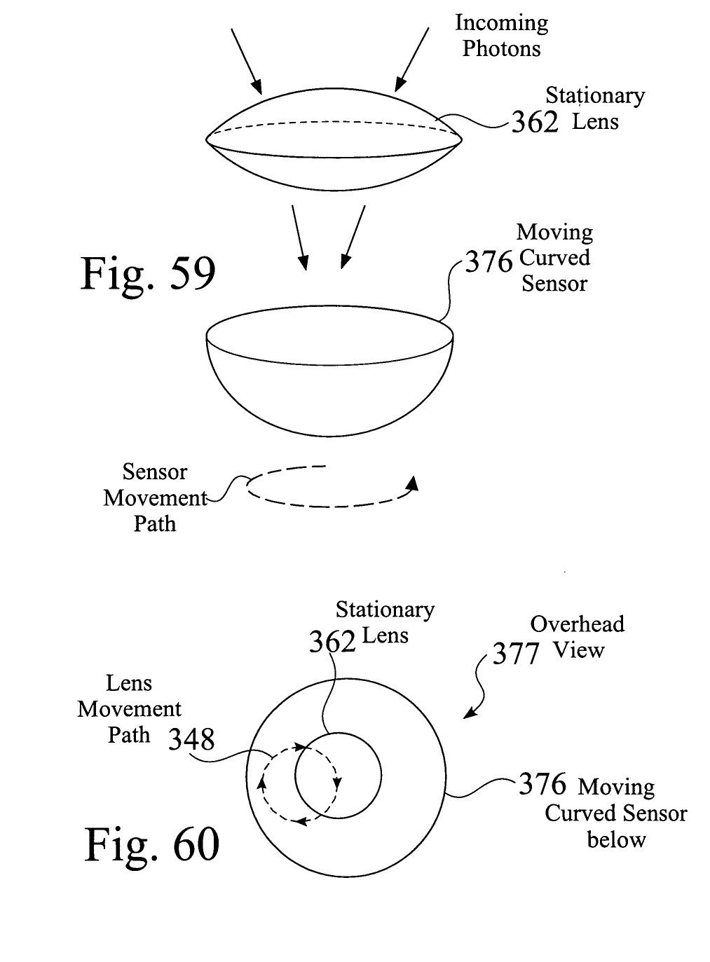

FIG. 59 offers a schematic depiction 374 of a stationary optical element 362 which resides over a curved sensor 376 which moves below the fixed optical element 362.

FIG. 60 is an overhead view of the optical element 362 and sensor 376 shown in FIG. 59.

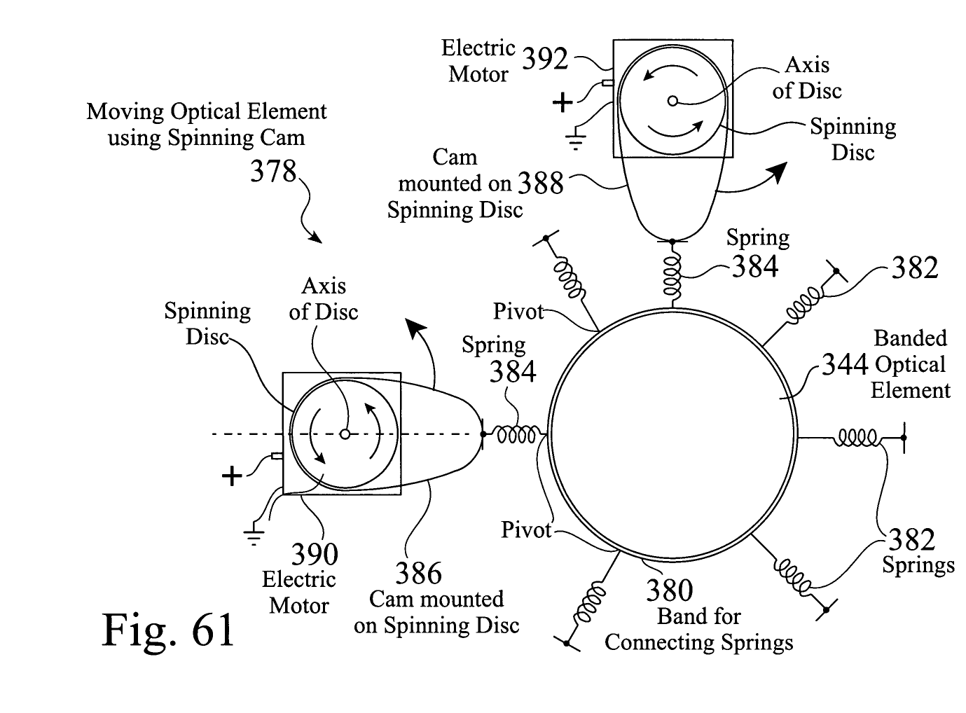

FIG. 61 furnishes an illustration 378 of a method for imparting a circular motion to an optical element 344 like the one shown in FIGS. 51 and 52. The optical element 344 is surrounded by a band 380, which provides pivoting attachment points 382 for a number of springs 384. Two of the springs are attached to cams 386 and 388, and each cam is mounted on an electric motor 390 and 392. When the cams rotate, the springs connected to the bands which surround the optical elements move the optical element. The two cams are out of phase by ninety degrees to provide circular motion.

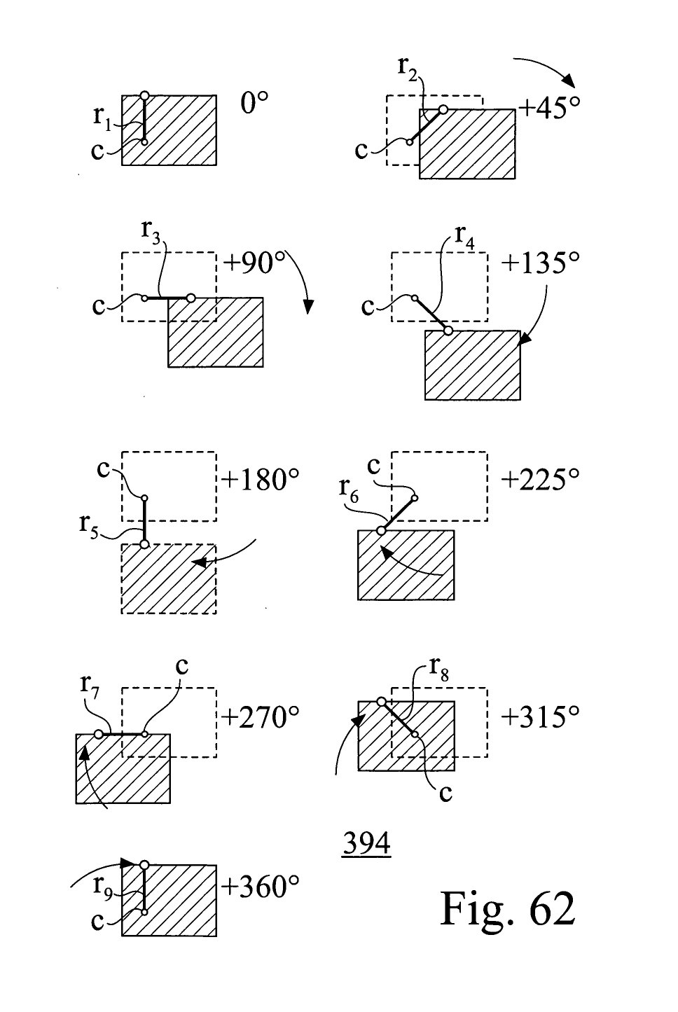

FIG. 62 presents a series 394 of nine simplified views of a flat sensor as it moves through a single orbit in its circular path. In one embodiment, the circular path is less than one pixel in diameter. In each view, an axis of rotation C is shown, which lies near the lower left corner of the square sensor. A radius segment is shown in each successive view, which connects the axis of rotation to a point on the top side of each square. In each view, the square sensor has moved forty-five degrees in a clockwise direction about the axis of rotation, C. In each view, a dotted-line version of the original square is shown in its original position. The radius segments are numbered r₁ through r₉, as they move through each of the eight steps in the circle.

In alternative embodiments, the sensor depicted in FIG. 62 may be configured in a rectangular or other suitable planar shape. In another alternative embodiment, the sensor may be curved or hemispherical. The motion may be clockwise, counter-clockwise or any other suitable displacement of position that accomplishes the object of the invention.

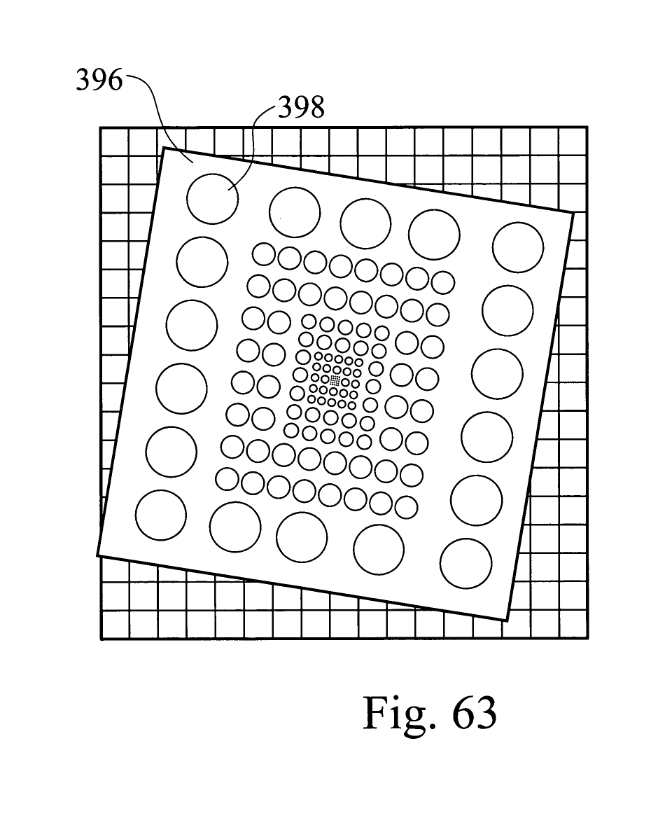

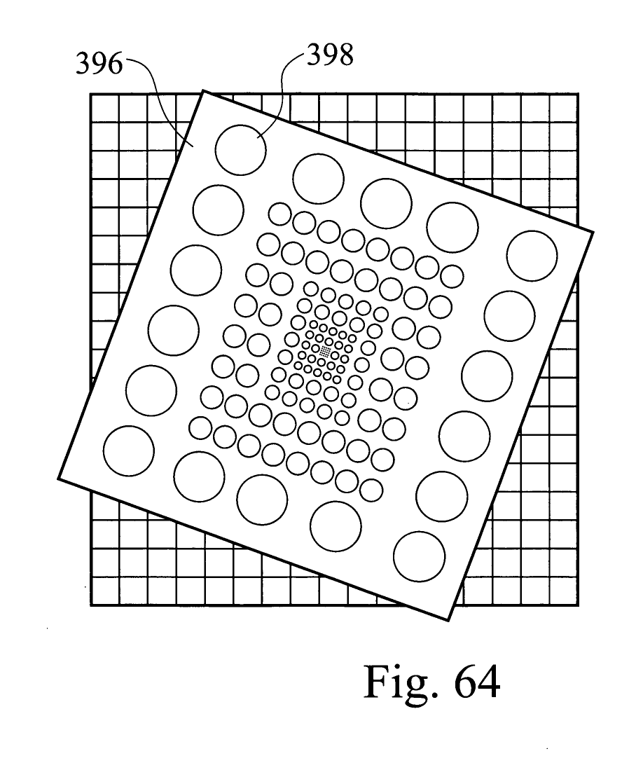

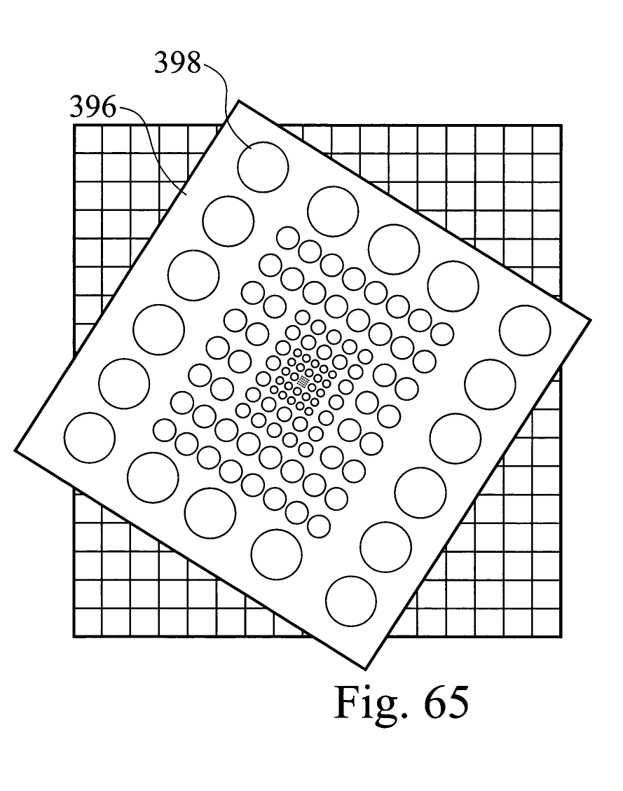

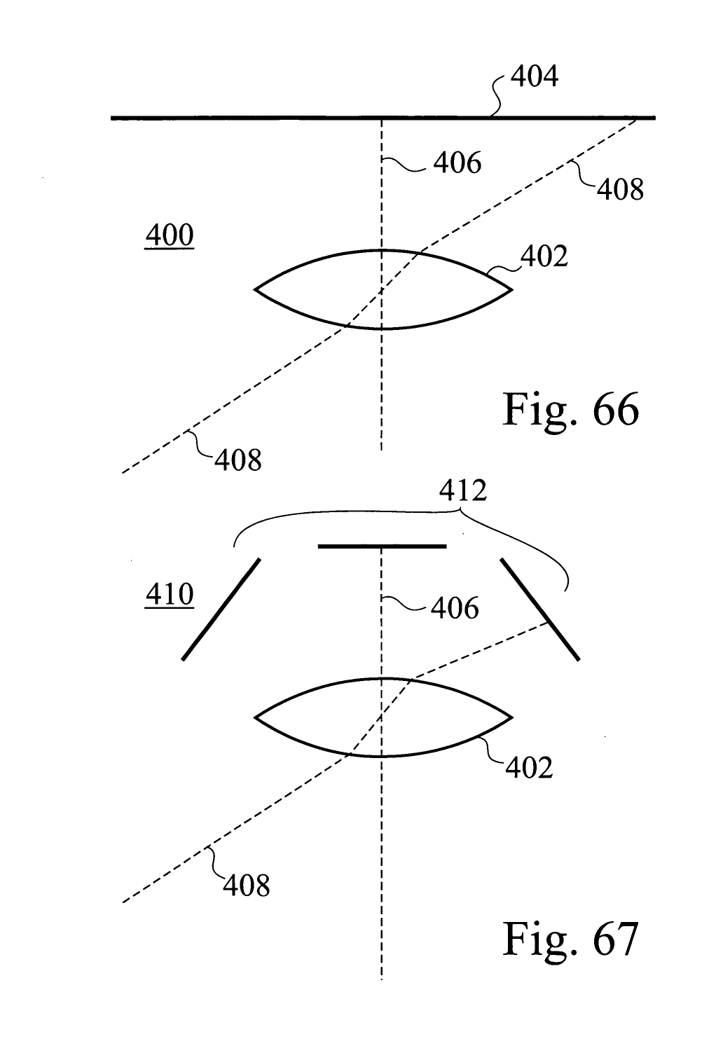

FIG. 63 is a schematic representation of a flat sensor arrayed with pixels 396. In FIG. 63, the sensor resides in its original position. In FIGS. 64 and 65, the sensor continues to rotate through the circular path. As the sensor rotates multiple exposures are taken, as determined by software. In this embodiment, the outer and inner rows of pixels each move by the same number of pixel spaces.

This embodiment enhances detail in an image beyond a sensor's pixel count, and may be used in combination with the method described in Section 5, above, “Method to Capture More Detail from a Scene than the Sensor is Otherwise Capable of Recording.”

While pixel density is increasing on sensors rapidly, when pixels are reduced in size such that each pixel can sense only a single photon, the limit of pixel density has been reached. Sensitivity is reduced as pixels become smaller.

This embodiment may be utilized in combination with methods and apparatus for sensor connections described in U.S. Pat. No. 8,248,499.

In yet another embodiment, miniature radios may be used to connect the output of the sensor to a micro-processor.

### Section 8. Method to Create Complete Image from Digital Sensors Containing Gaps

In another embodiment of the invention, a complete image is produced from digital sensors that contain gaps. In yet another embodiment, a complete image is produced from an array of sensors that are physically spaced apart or separated. In either of these two embodiments, the sensors operate behind a single optical path.

In the first embodiment, a camera includes a generally concave sensor which is formed so that it includes gaps 34 between facets 32, as shown in FIG. 7. A first exposure is taken while the image stabilization feature is activated. Image stabilization is described above in Sections II, III and V. The image stabilization feature is then de-activated, and then re-activated. A second exposure is then taken while the image stabilization feature is active. The signal processor 22, which runs a software program, then picks up the image data missing from the first exposure, and stitches it into the first exposure, creating a complete image. This process may be used generally continuously to create motion pictures or videos.

FIGS. 59 and 60 illustrate the difference between sensors that have gaps, and those that do not. FIG. 59 shows a lens and sensor combination 400. The lens 402 is positioned near flat sensor 404. The lens 402 has a central axis 406. A light ray 408 enters the lens 402, and is refracted. The light ray which emerges from the other side of the lens 402 impinges on the flat sensor 404. In FIG. 60, a different combination of elements 410 includes the same lens 402 and a sensor with gaps 412. The incident light 408 enters the lens 402, and, after emerging from the other side of the lens 402, strikes one portion of the sensor 412.

As shown in FIGS. 59 and 60, using a flat sensor 404 causes the incident light 408 to impinge on the outside portion of the flat sensor due to the refraction through the lens 402. By using a more “curved” sensor as shown in FIG. 60, the incident ray impinges upon the portion of the sensor at an angle which is closer to the normal, and also strikes the portion of the sensor more near its center. This feature provides an enhanced image.

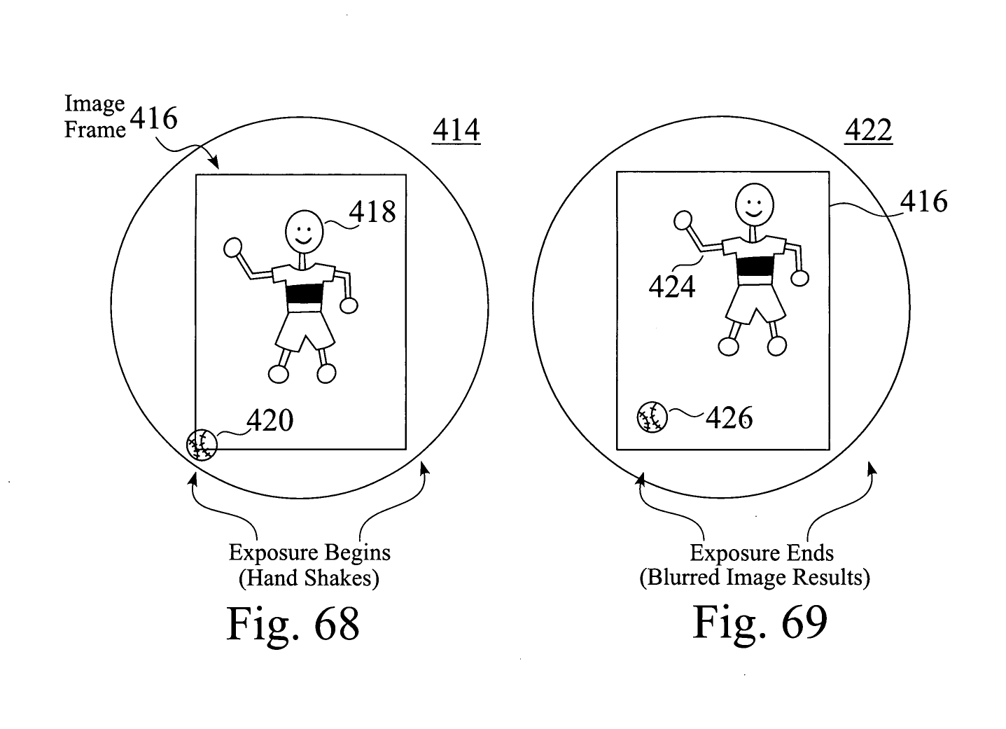

FIGS. 68 and 69 offer views of a scene that is photographed with a handheld camera that does not include an image stabilization system. In FIG. 68, an image frame 416 shows a boy 418 and a baseball 420 in two successive views separated by a short period of time. During that period of time, the user's hand shakes slightly. In FIG. 68, an exposure begins. A short time later, as shown in FIG. 69, the exposure ends. The resulting photographic image is blurry, due to the slight jitter of the handheld camera.

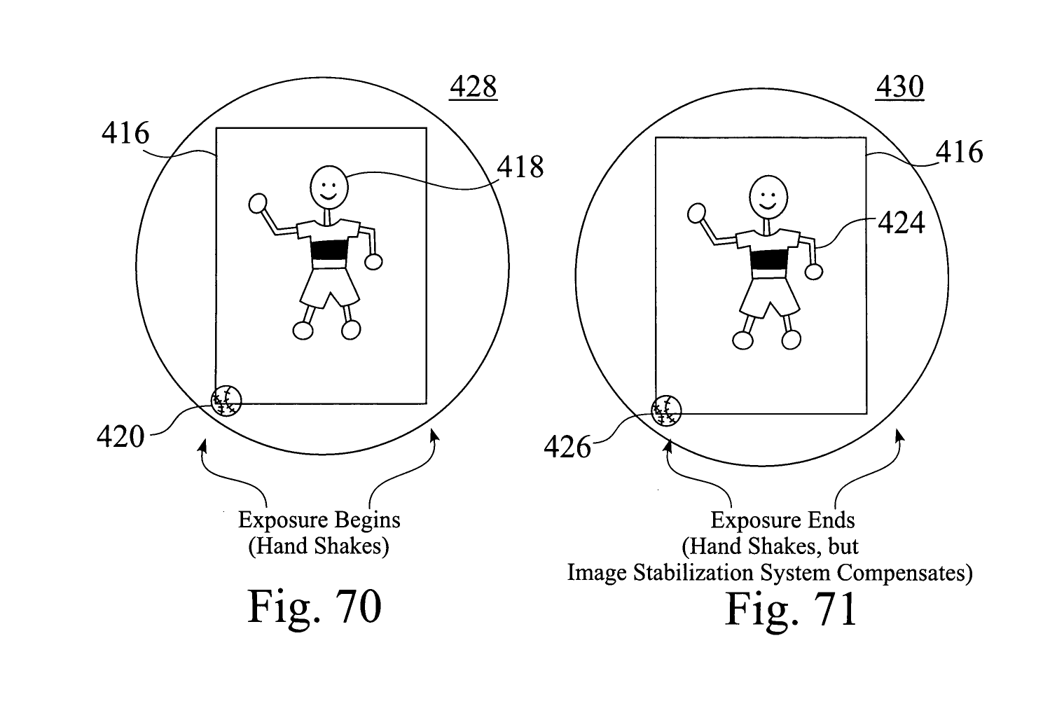

FIGS. 70 and 71 offers vies of the same scene as shown in FIGS. 68 and 69, but which is photographed with a handheld camera that includes image stabilization. In FIG. 70, the image frame 416 shows the boy 418 and the baseball 420 in two successive views separated by a short period of time. During that period of time, the user's hand shakes slightly. In FIG. 70, an exposure begins. A short time later, as shown in FIG. 71, the exposure ends. The resulting photographic image is sharp, since the slight jitter of the handheld camera is counteracted by the image stabilization system.

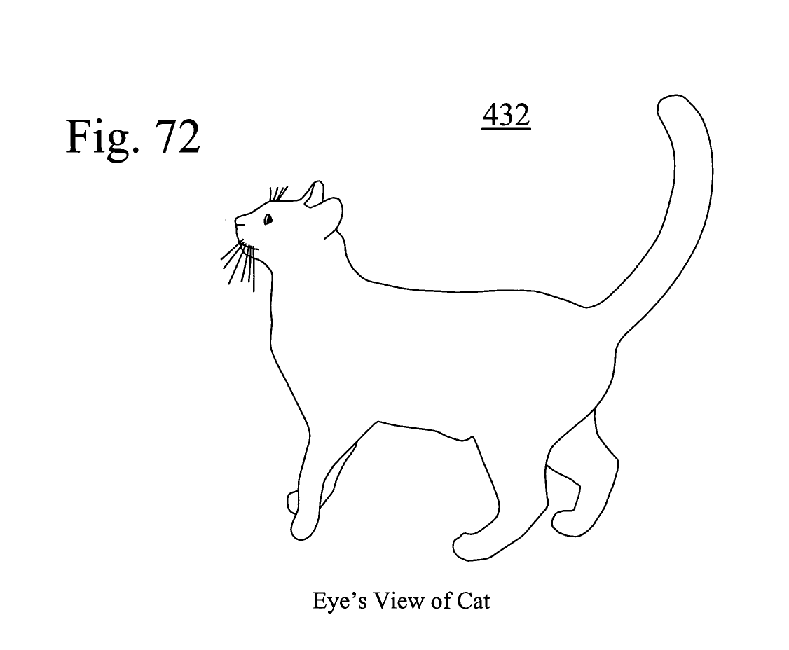

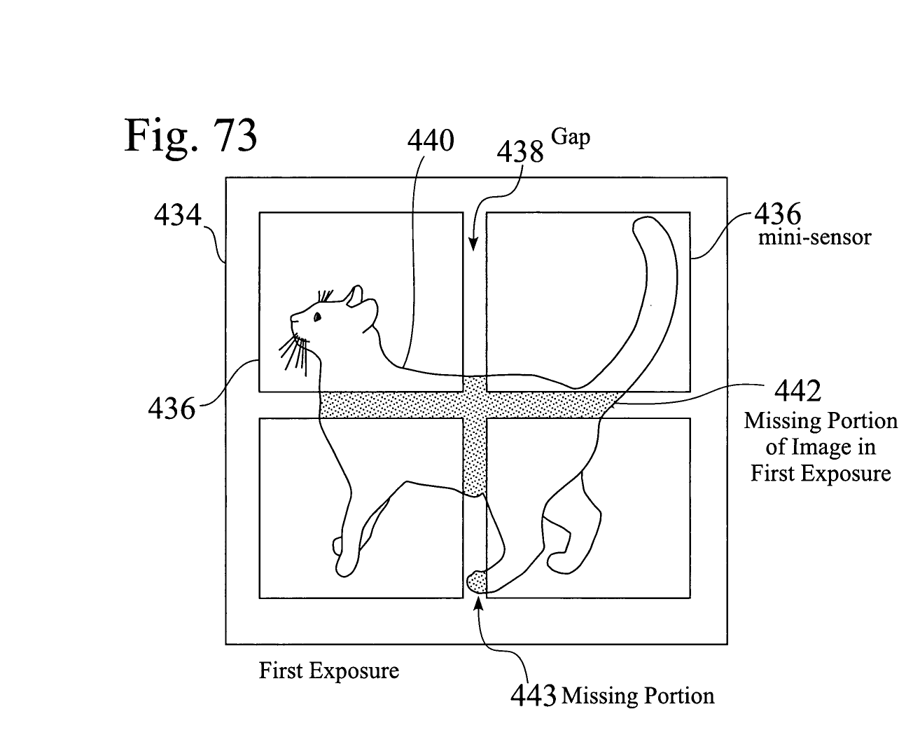

FIGS. 72 through 75 further illustrate this embodiment of the invention, which includes optical image stabilization. FIG. 72 shows the unaided eye's view 432 of a cat. In FIG. 73, an image of the cat is superimposed over a portion of a camera's sensor 434. The sensor 434 includes four generally square mini-sensors 436 which are separated by gaps 438.

In FIG. 73, the camera takes a first exposure while optical image stabilization is active. The first exposure records only those portions of the cat's image 440 which register with the mini-sensors 436. The other portions of the entire cat's image which are not recorded in this first exposure are those which are superimposed over the gaps 438, and are shown as cross-hatched “missing portions” 442 of the image.

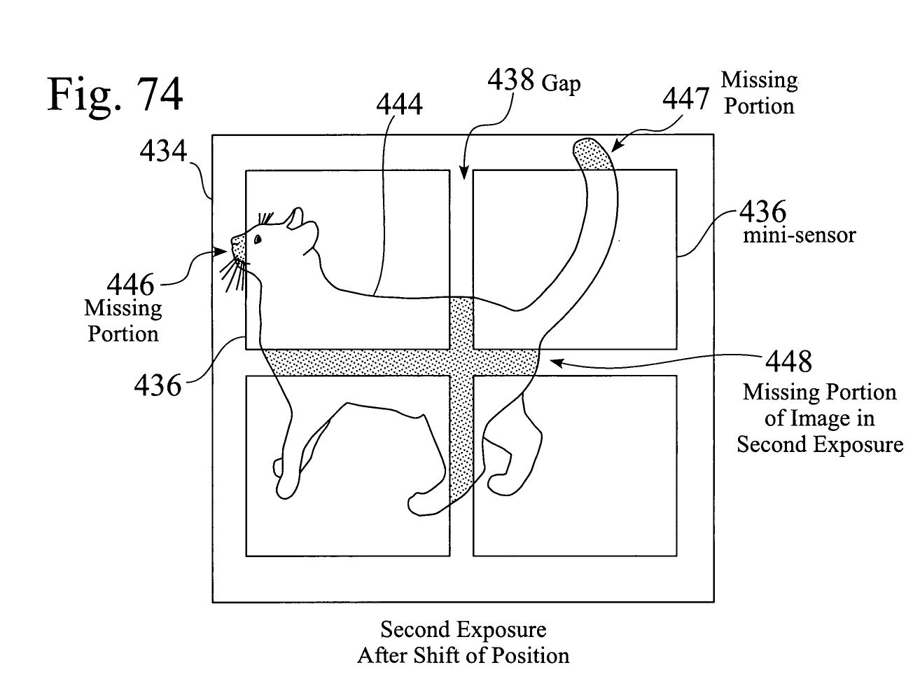

In FIG. 74, the camera takes a second exposure while optical image stabilization is active. The cat has moved or has changed position in the time between the beginning of the first and second exposures. This movement may simply be the jitter created by a user's hand. The second exposure records only those portions of the cat's image 444 which register with the mini-sensors 436. The other portions of the entire cat's image that are not recorded in this second exposure are those which are superimposed over the gaps 438, and are shown as cross-hatched “missing-portions” 446 of the image.

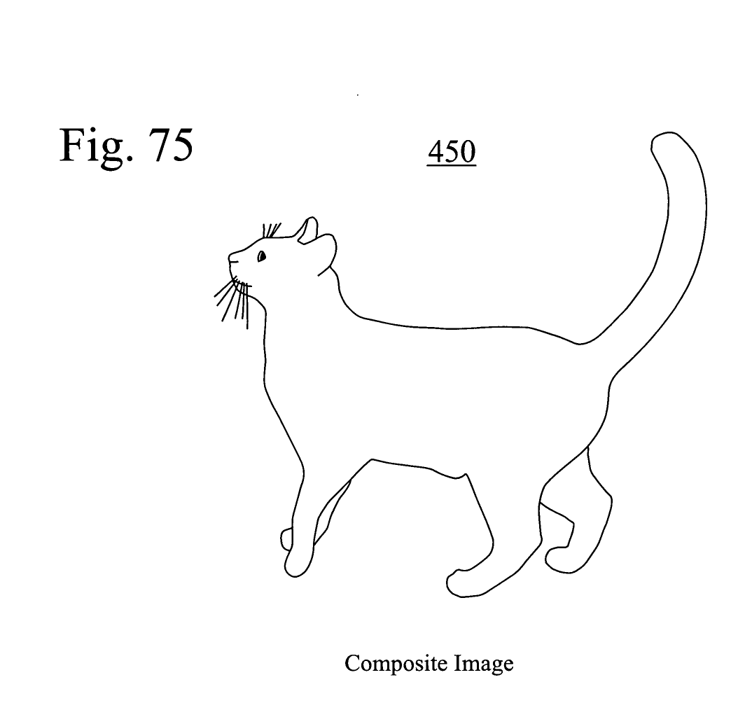

After the camera records the first and second exposures, electronic stabilization software, which is stored in the camera's memory, is executed on the camera's processor. This software compares the two exposures, pixel by pixel, and detects the missing portions in each exposure. The software then creates a composite image 450, as shown in FIG. 75, which “stitches together” the originally recorded and missing portions to produce a complete image.

Electronic image stabilization is well known in the art. According to Wilikpedia, electronic image stabilization “reduces blurring associated with the motion of a camera during exposure.” In some cameras, a gyroscope is used to sense camera rotation, which causes angular error. The gyroscopes measure the rotation, and send information to an actuator which moves the sensor in the camera to counteract the rotation. In another embodiment, an angular rate sensor may be used to measure and to compensate for unwanted camera motion while an exposure is taken. An Image Stabilizer Primer is available at the website for Videomaker, and is also described at the websites operated by Nikon and Canon. Yu et al. disclose a Summarization of Electronic Image Stabilization in their paper published at the 7^{th} International Conference on Computer-Aided Industrial Design and Conceptual Design in 2006.

This embodiment of the invention provides the following benefits:

simpler, smaller optics;

optics that capture more light; and

missing data from the gaps are captured.

### Section 9. Image Stabilization Methods

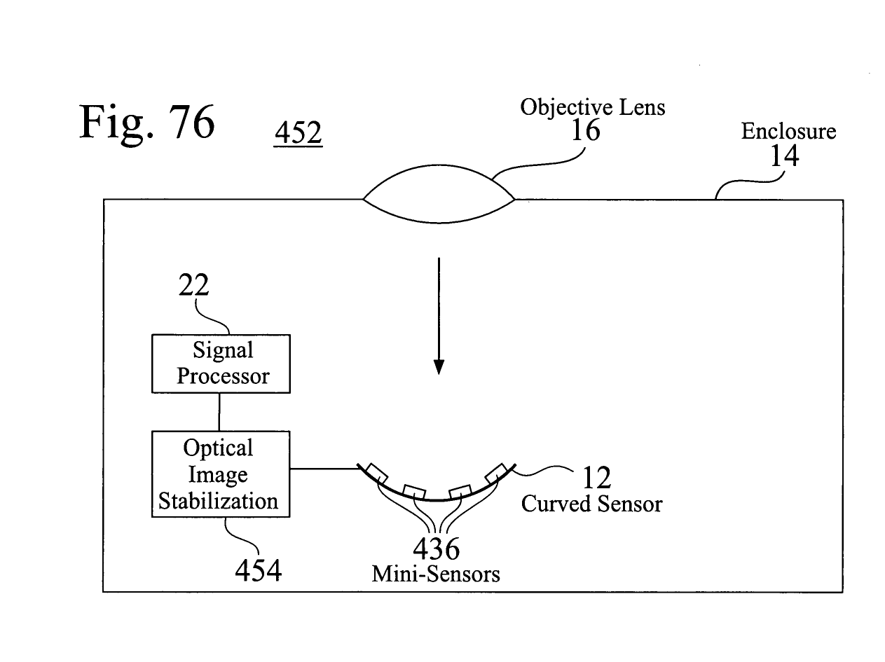

FIG. 76 supplies a schematic view of a camera 452 that incorporates both a curved sensor and optical image stabilization. An objective lens 16 resides on an enclosure 14. Inside the camera, a curved sensor 12 is positioned to receive light beams from the objective lens 16 above it. The curved sensor 12 includes a number of mini-sensors 436. The output of the mini-sensors 436 is connected to an optical image stabilization circuit 454, which is also connected to a signal processor 22.

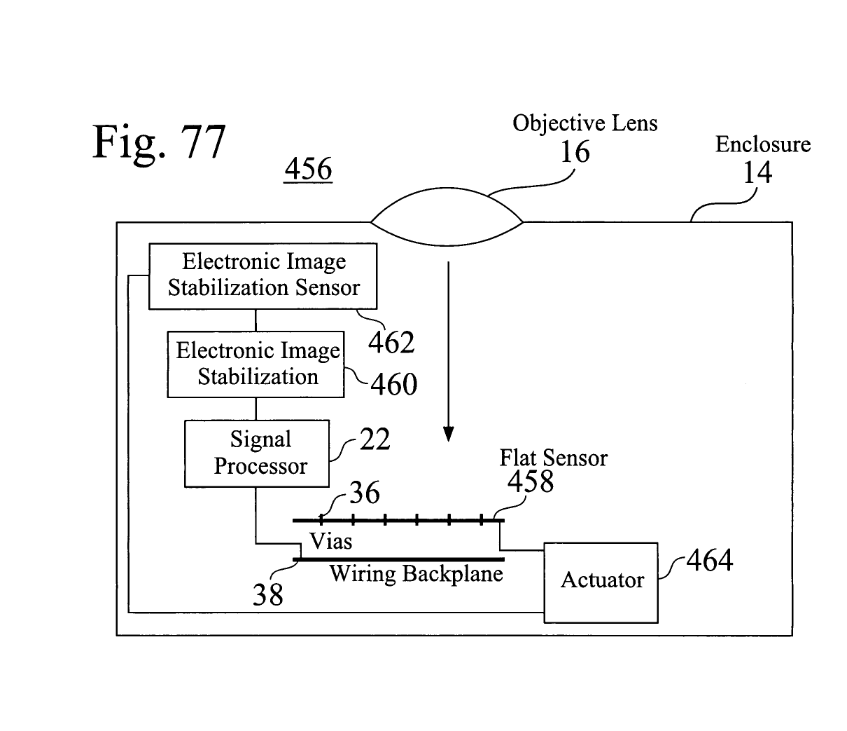

FIG. 77 shows a camera 456 that incorporates electronic image stabilization. An objective lens 16 is situated on an enclosure 14. Inside the camera, a conventional flat sensor 458 is positioned to receive light gathered by the objective lens 16. An electronic image stabilization circuit 460 is connected to an electronic image stabilization sensor 462, which detects any unwanted rotation of the camera. The electronic image stabilization circuit 460 is also connected to a actuator 464, which physically adjusts the position of the sensor 458 to counteract any unwanted rotation.

### Section 10. Lens Shade Motion Control Mechanisms

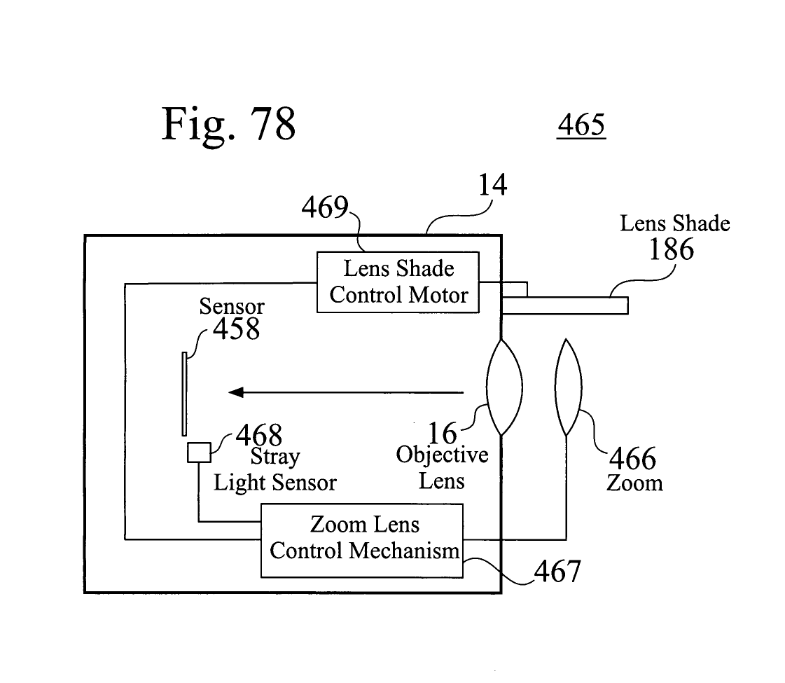

FIG. 78 is a schematic diagram of a camera 465 with automatic lens shade control. A zoom lens 466 is mounted over the objective lens 16 which is affixed to the enclosure 14. A lens shade 186 extends over both the objective and zoom lenses 16 & 466. A zoom lens control mechanism 467 is connected to a scattered light sensor 468, and operates the zoom lens 466. The scattered light sensor 468 is disposed beyond the outermost edge of the flat sensor 458. When the scattered light sensor 468 detects too much scattered light, it sends a signal to a lens shade control motor 469, and the lens shade 186 is extended.

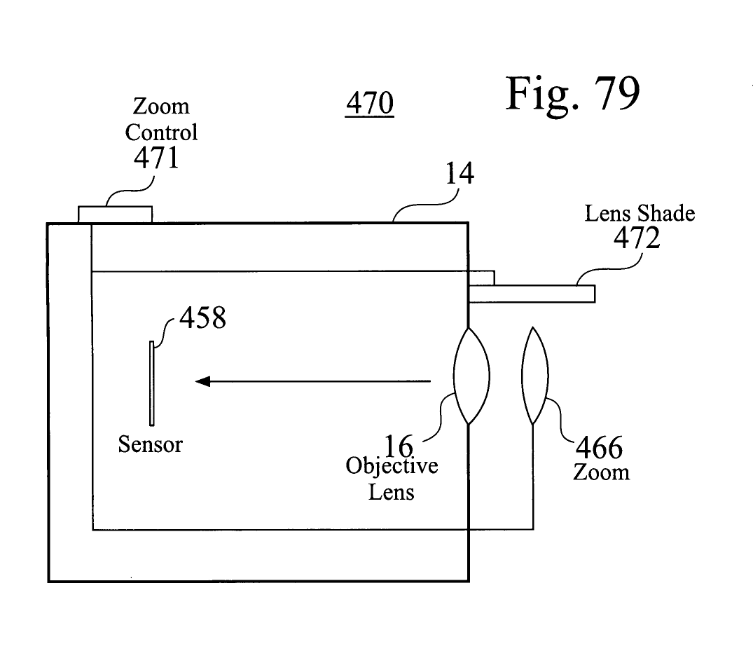

FIG. 79 reveals a diagram of a camera 470 with a manual zoom and lens shade control. As shown in FIG. 78, the objective lens 16 is located on the enclosure 14. A zoom lens 466 is mounted over the objective lens 16. A flat sensor 458 receives light from the objective lens 16. A manual zoom control knob 471 is mounted on the enclosure, and is connected to a manually controlled lens shade 472, which is also mounted on the enclosure 14, and which extends over both the objective and the zoom lenses 16 & 466. In an alternative embodiment, the lens shade control is mechanically linked to the zoom lens barrel.

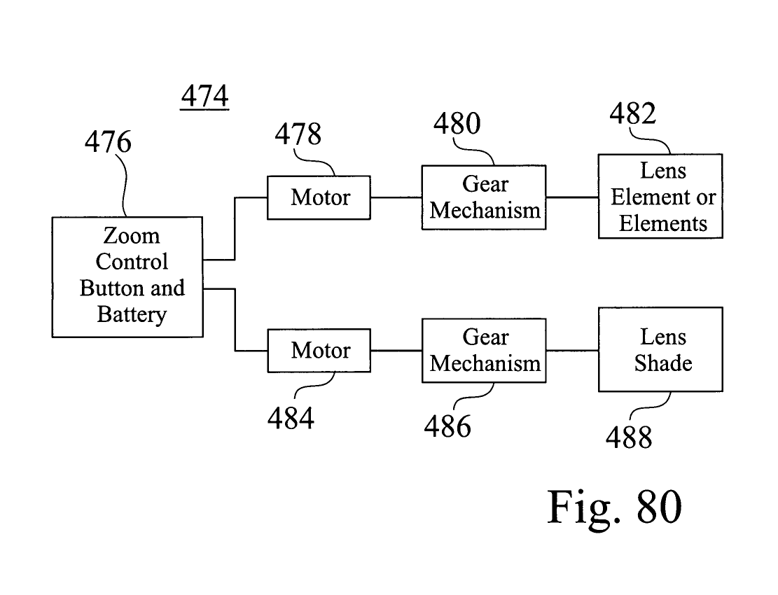

FIG. 80 depicts a first embodiment 474 of lens shade control. A zoom control button 476 is connected, in series, to a first motor 478, a first gear mechanism 480 and one or more lenses 482. The zoom control button 476 is also connected, in series, to a second motor 484, a second gear mechanism 486 and a lens shade 488 which is controlled in concert with a zoom lens.

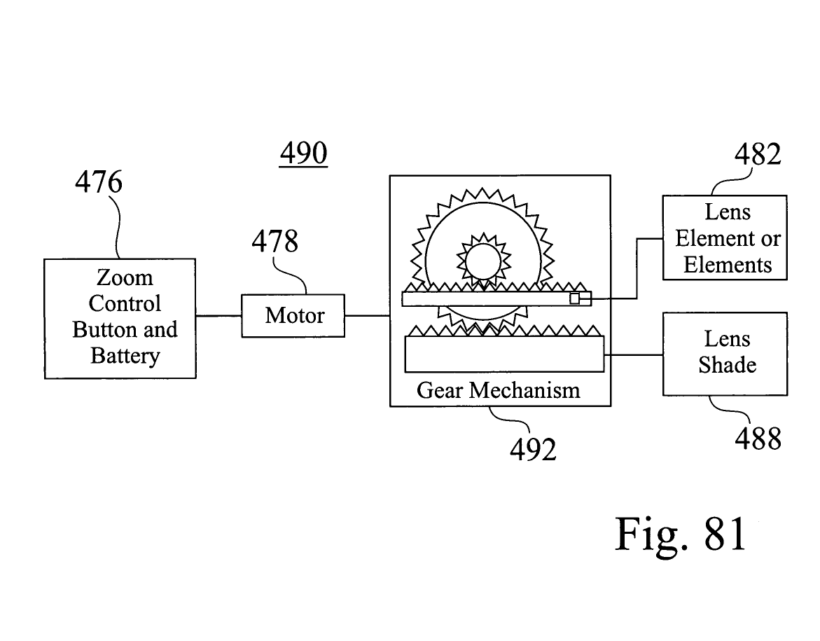

FIG. 81 depicts a second embodiment 490 of lens shade control. A zoom control button 476 is connected, in series, to a first motor 478, and a twin track gear mechanism 492, one or more lenses 482 and a lens shade 488.

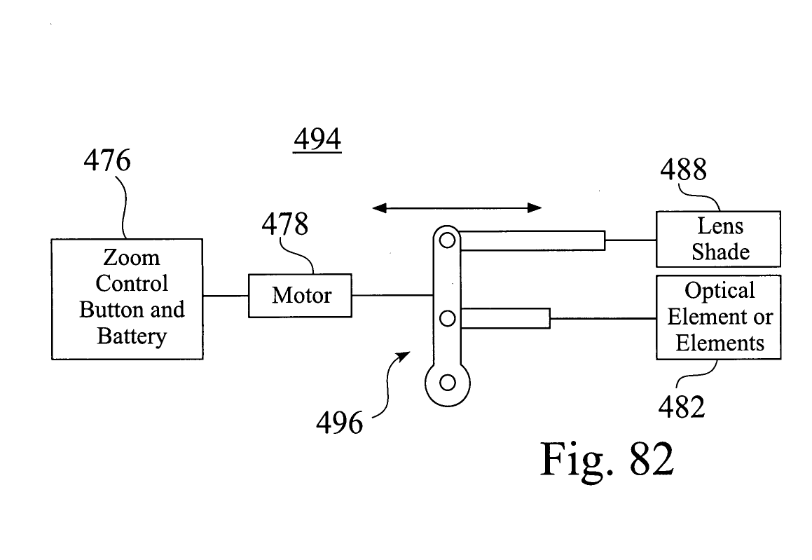

FIG. 82 depicts a third embodiment 494 of lens shade control. A zoom control button 476 is connected, in series, to a first motor 478, and a double lever arm 496, one or more lenses 482 and a lens shade 488.

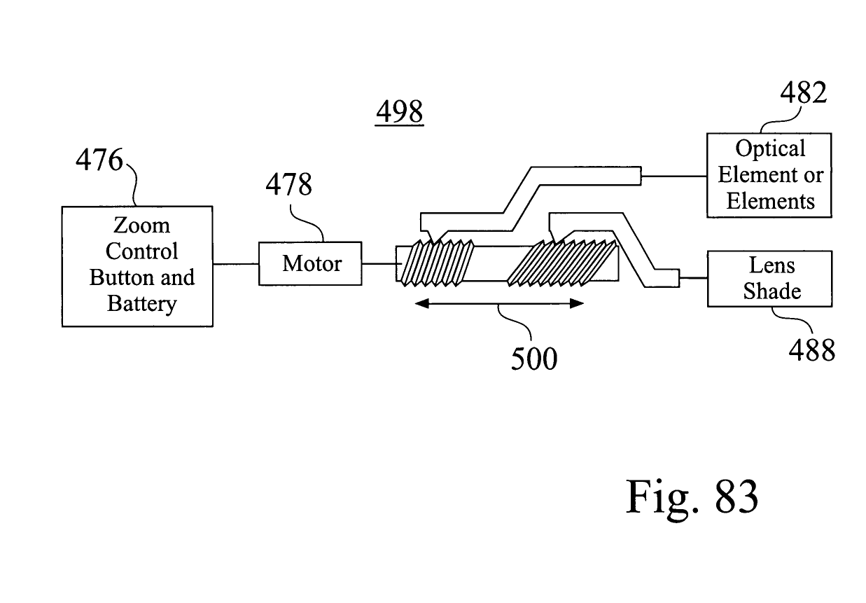

FIG. 83 depicts a fourth embodiment 498 of lens shade control. A zoom 10 control button 476 is connected, in series, to a first motor 478, and a single arm 500, one or more lenses 482 and a lens shade 488.

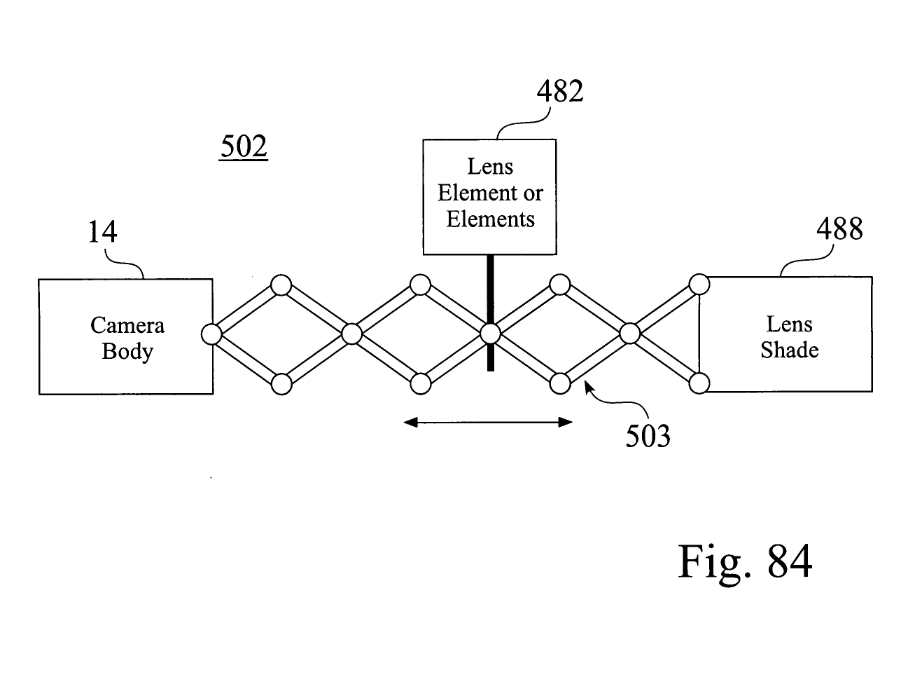

FIG. 84 presents a view of a manual zoom and lens shade controller 502. A pantograph 503 is connected, in series, to the enclosure 14, the zoom lens 466 and to a lens shade 488.

### Section 11. Binning & Compression

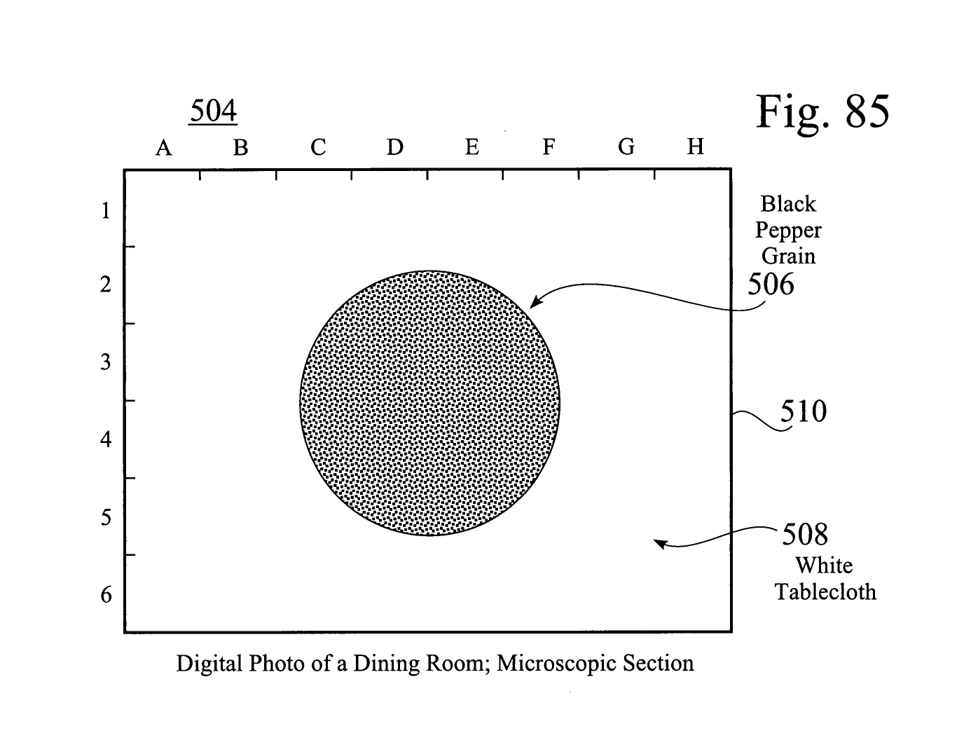

FIGS. 85, 86 and 87 depict methods for binning and compression. FIG. 85 is a view 504 of a tiny fraction of a digital photo, which covers only forty-eight pixels. The black spot 506 on the white background 508 may be thought of as a peppercorn on a white tablecloth. The pixels are indicated by the horizontal and vertical axes, labeled A through H, and 1 through 6, respectively.

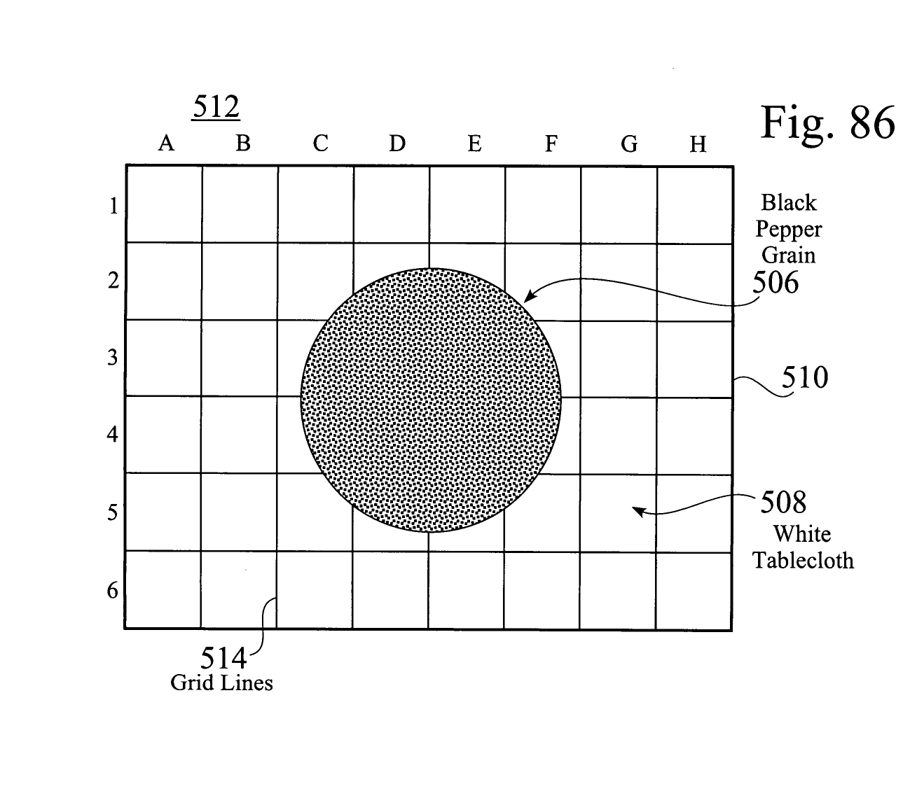

FIG. 86 provides another view 512 of the scene 504 shown in FIG. 85, but with grid lines 514 that show the boundaries of the forty-eight pixels. In one embodiment of the invention, a compression algorithm is used, and the signal processor stores and prints this tiny section of the image, going left to right and top to bottom as (A1-C2 white, D2-E2 black, F2-B3 white, C3-F3 black, G3-B4 white, C4-F4 black, G4-C5 white, D5-E5 white, F5-H6 white.) The alternative is to store each bit alone, which in this case would mean (A1 white, B1 white, C1 white, D1 white, E1 white, F1 white, G1 white, H1 white, A2 white, B2 white, C2 white, D2 black, E2 black, F2 white, G2 white, H2 white, etc.) Using this alternative method, much more data needs to be processed and stored, but the quality of the image is not improved.

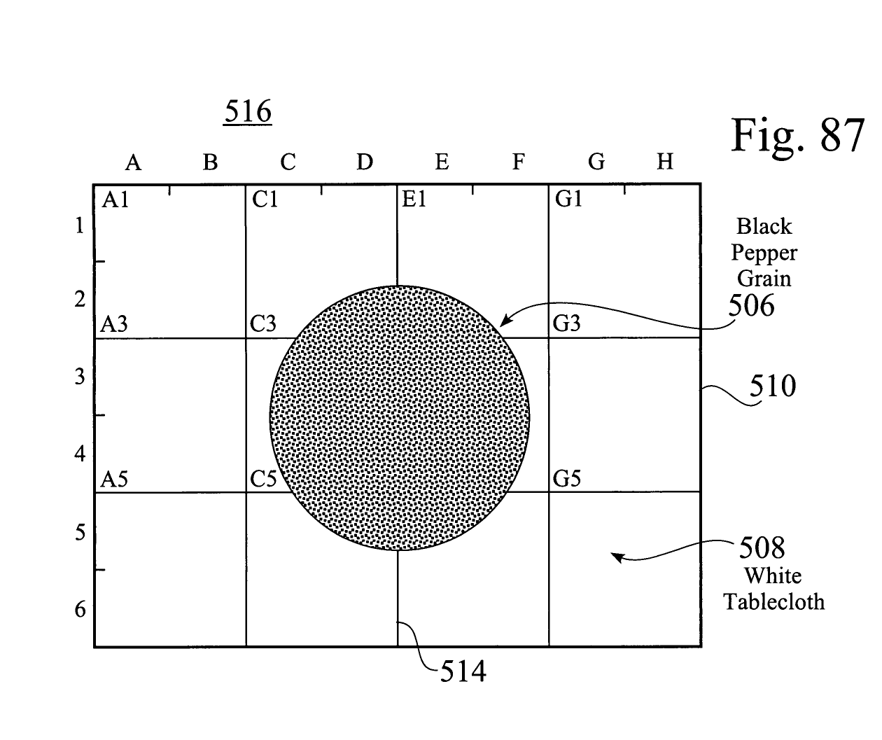

FIG. 87 supplies another view 516, which illustrates how the amount of data the is needed to represent the image changes when a binning method is employed, instead of a compression method. When implementing the binning method, the data produced by neighboring pixels are aggregated together to generate a virtually larger pixel. The binning method generally produces less detail, and results in more sensitive response per “virtual” pixel, so the performance of the camera in lower light conditions is improved. In FIG. 87, the nearest four pixels are joined, and so the signal processor stores and prints the image as (A1-A3 white, C3-E3 black, G3-H5 white). In FIG. 87, a pixel code is used to identify each virtual pixel. As an example, the first virtual pixel in the top right of FIG. 87 is identified as pixel code A1-A3. The pixel code is generated by concatenating the horizontal and vertical coordinates 518 of the top left corner and the lower left corner of each virtual pixel. Accordingly, the codes for the four virtual pixels in the top row of virtual pixels shown in FIG. 87 are A1-A3, C1-C3, E1-E3 and G1-G3.

The method illustrated in FIG. 87 not only improves performance under low light conditions, but also increases image detail, since more photons are captured per virtual pixel. The processing time and storage needs are reduced. This method also reduces the noise created in low light situations when the ISO, or sensitivity of the pixels, is heightened.

### Section 12. Arcuate Array of Mini-Sensors

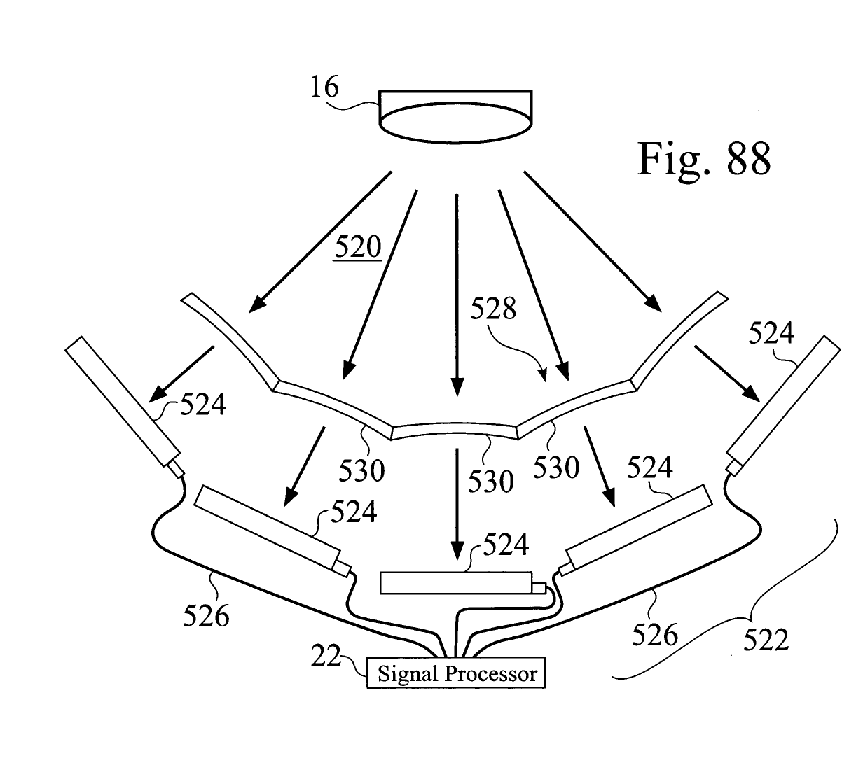

FIG. 88 offers a view 520 of another embodiment of the invention, which includes an arcuate array of individual mini-sensors combined with a corrective optical element. The arcuate array 522 includes a number of mini-sensors 524, which each have an output 526 that is fed to a signal processor 22. Each mini-sensor 524 is aligned along a curve or arc, and is disposed inside the camera. Each mini-sensor 524 is separated by gaps, allowing for ease of construction. A corrective optical element 528 is disposed above the arcuate array 522. The corrective optical element 528 includes a number of contiguous, joined portions 530. Each of these portions 530 is configured so that its thickest portion resides at its center. Each of these portions 530 directs light that emerges from the objective lens 16 to one mini-sensor 524 in the array 522.

This embodiment of the invention achieves all the benefits of a curved or concave sensor, without the need to bend the sensor material and without any moving parts. When a single flat sensor is used in a camera, the light rays travel further and bend sharper to reach the edges of the flat sensor. The result is weaker light at the edges with more chromatic (rainbow effects) aberrations.

In this embodiment, the light rays entering the camera strike the sensors at nearly identical distances from the objective lens. The light rays also strike the sensor at closer to a right angle on average. This embodiment enables lens designers to create faster lenses. Faster lenses capture more photons, which eliminates the need for flash in many low light conditions.

In an alternative embodiment, a number of these arrays may be deployed in parallel.

### Section 13. Enhanced Low Light Photography

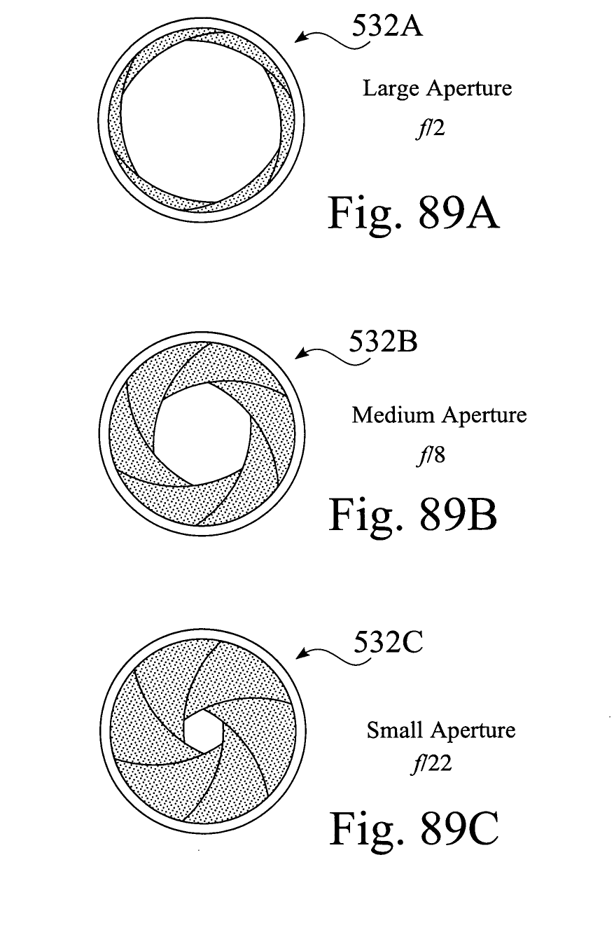

FIGS. 89A, 89B and 89C provide illustrations 532A, 523B and 532C of a shutter mechanism, shown in three different configurations. The largest aperture 532A, which is shown FIG. 89A, allows for the maximum amount of light to enter the camera behind it, pass into the objective lens, and then impinge upon the sensor. The mid-sized aperture 532B, which is shown in FIG. 89B, allows a relatively moderate amount of light to enter the camera. The small aperture 532C, which is shown in FIG. 89C, allows a relatively low amount of light to enter the camera.

In this Specification and in the Claims that follow, the term “low light” generally means XXXX.

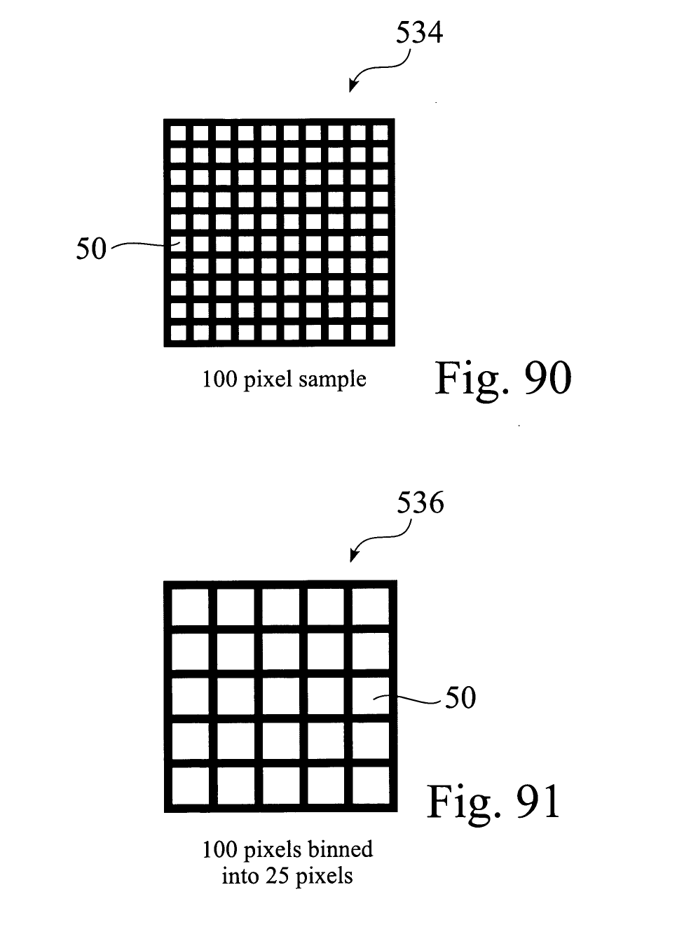

FIG. 90 is a schematic illustration of a first array 534 of pixels 50 on a sensor 12. This first array 534 is ten pixels square, and contains one hundred pixels. This first pixel array 534 may be used for output sampling.

FIG. 91 is a schematic illustration of a second array 536 of pixels 50 on a sensor 12. This second array 536 includes the same one hundred pixels shown in FIG. 90, but now have been binned into twenty-five pixels. Binning is a process which groups a number of pixels together, and then the group is treated, for purposes of signal output, as a single pixel. In an alternative embodiment of the invention, a group of pixels may be binned, and then sampled.

FIGS. 90 and 91 show how pixels are combined by 4× binning. Signal to noise ratios improve with binning. Resolution is sacrificed when binning is increased.

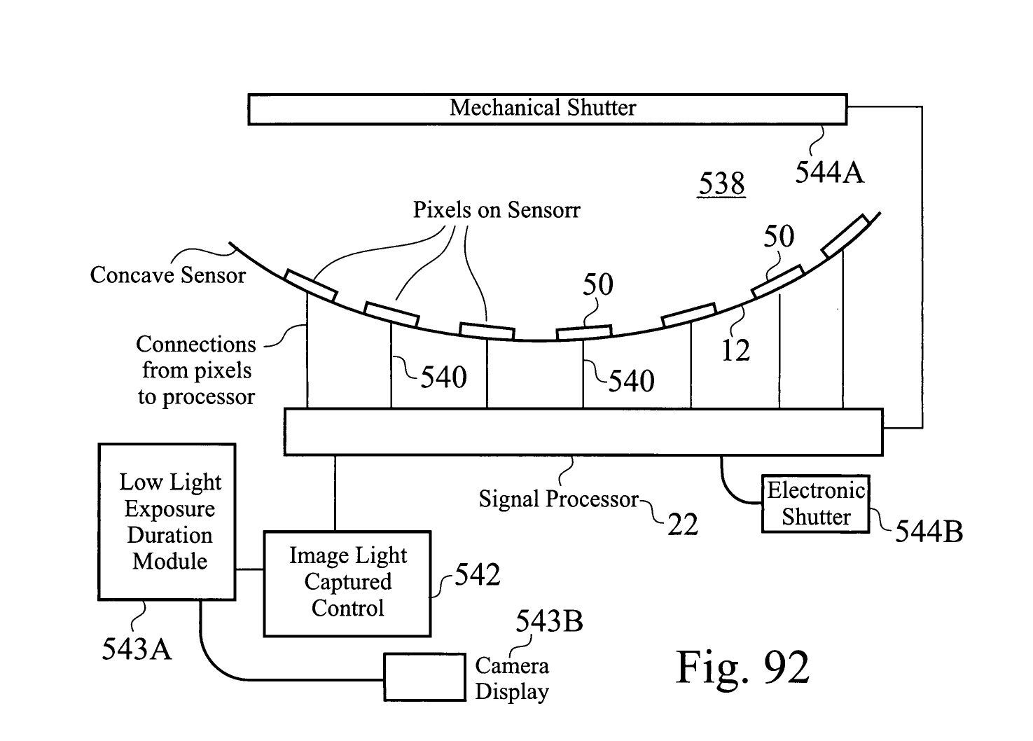

“Output sampling” refers to the method of measuring, monitoring, testing or otherwise evaluating the output of a selected group of pixels. In one embodiment of the present invention, output sampling is implemented by tabulating the percentage of pixel output signals which have changed during an exposure. One embodiment of the invention 538 that implements output sampling is illustrated in FIG. 92. The output of each sampled pixel 50, which is formed on a curved sensor 12, is delivered to signal processor 22 over an output connection 540 during an exposure. The signal processor 22 is also connected to an image light captured control 542, which is used to set a light level intensity for comparison to the light level that is sensed by the pixels during an exposure. The image light captured control 542 may detect a voltage, a current or both. The signal processor 22 is also connected to the shutter in the camera 10. During an exposure, the object which is being photographed may move, or, the image of the object may experience unwanted motion due to jitter or movement by the photographer holding the camera. If this unwanted motion is greater than the threshold set by the image light captured control 542, the exposure will be deferred or canceled. In an alternative embodiment, the camera may alert the photographer that light conditions are not favorable for a photograph. If the unwanted motion is lower than the threshold set by the image light captured control 542, the signal processor 22 communicates with the shutter, and increases the length of the exposure to improve the image captured under low light conditions.

In one embodiment of the invention, the shutter or shutter means is mechanical 544A, and is located over the objective lens of the camera. In an alternative embodiment, the shutter may be located elsewhere within the optical train (path of light in the camera). In another embodiment, the shutter means may be an electronic shutter 544B.

In an alternative embodiment of the invention, the output of a group of pixels may be sampled together. This process is called binning, and is shown in FIG. 91. In yet another alternative embodiment, the output of all the pixels associated with a sensor may be sampled.

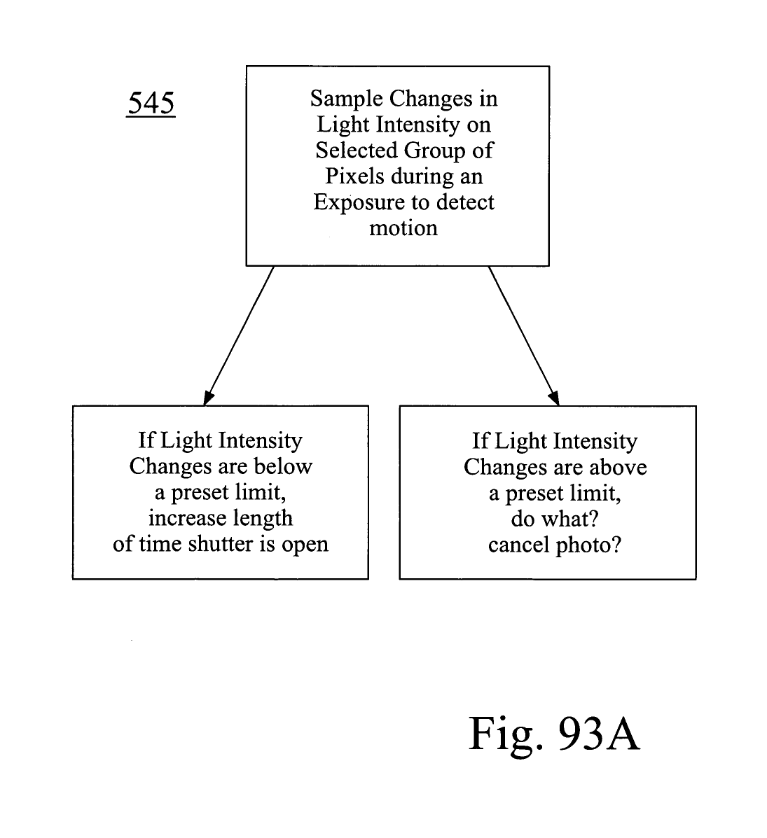

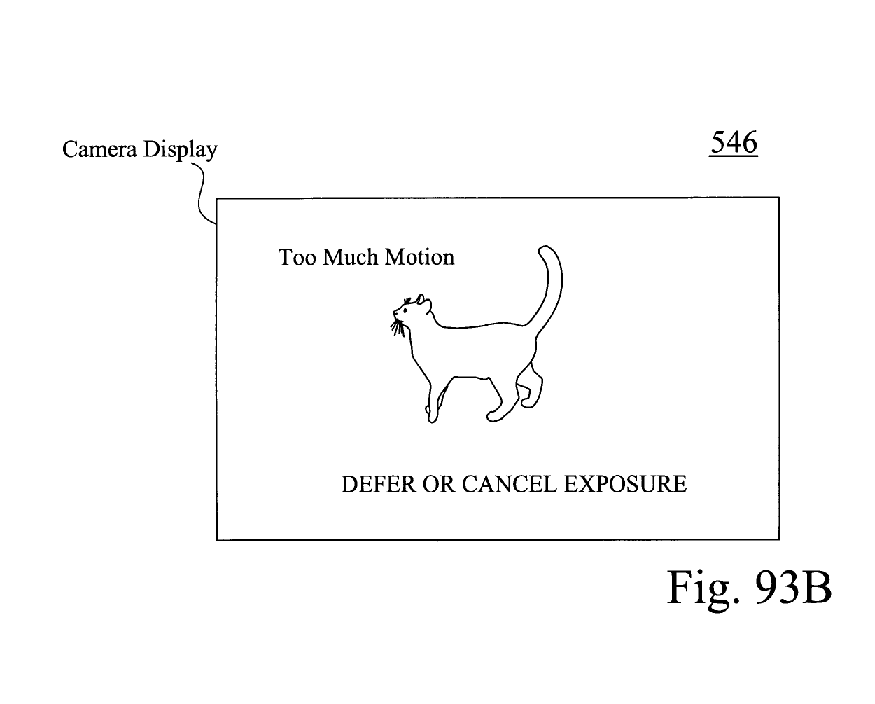

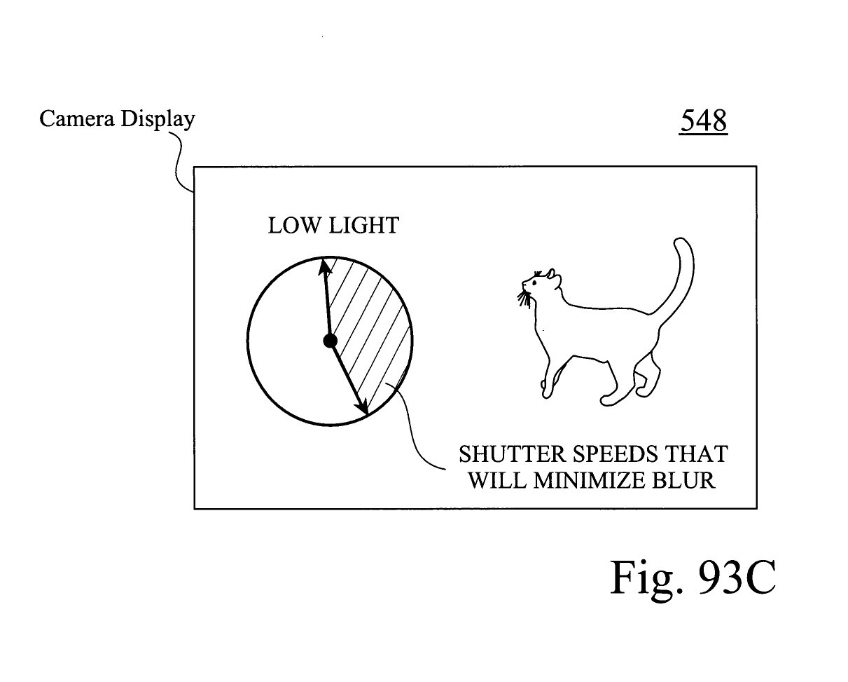

One embodiment of the invention that pertains to output sampling is depicted by the flow chart 545 contained in FIG. 93A. FIG. 93B is an illustration 546 which depicts the camera display, which presents a warning when too much motion is detected under low light conditions. FIG. 93C is another view 548 of the camera display, which presents a message that suggests shutter speeds that will minimize blur during low light conditions.

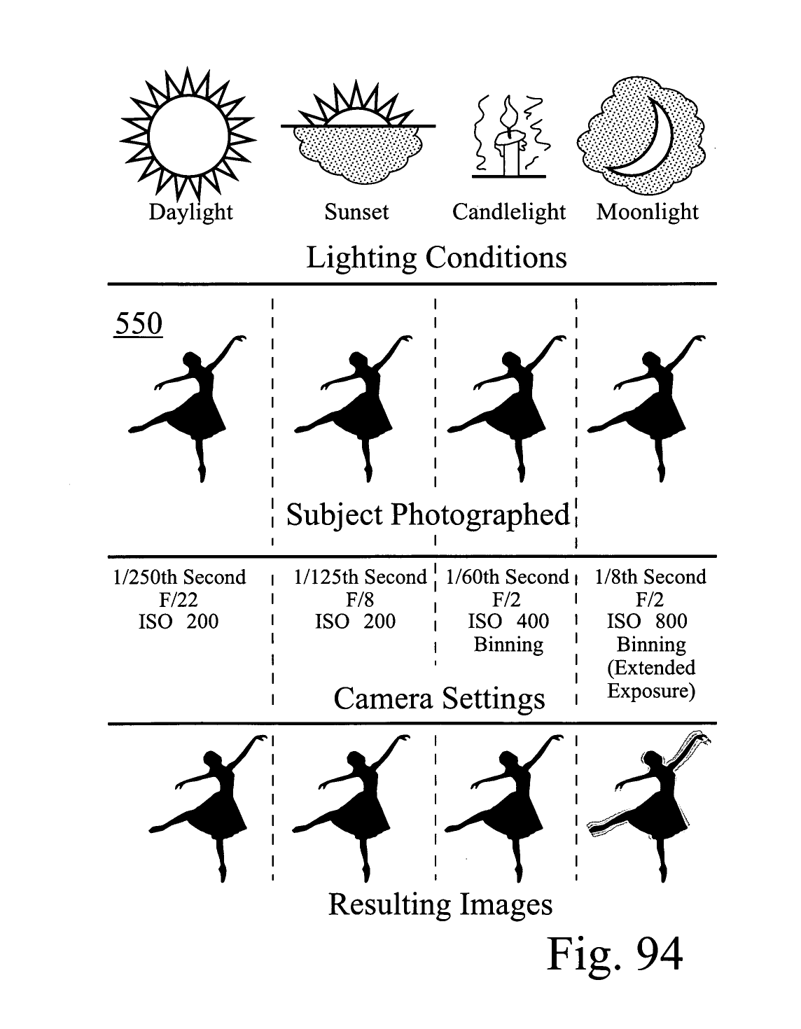

FIG. 94 presents a series of four images 550 of a ballerina that have were captured under varying light conditions. F/3.5 lenses are most common on traditional cameras. F/2 lenses are often available for traditional cameras, but infrequently on smart phones. In April of 2014, the two dominant smart phone cameras use f/2.2 lenses. Traditional camera lenses will close down as far as f/22, including fractions in between. Each f/stop doubles the amount of light passed through in a given time period. F/1.4, f/2, f/2.8, f/4, f/5.6, f/8, f/11, f/16 and f/22 were the standard settings in the past. F11.4 is twice as “fast” as f/2, four times faster than f/2.8, eight times faster than f/4, and sixteen times as fast as f/5.6, etc.

No flash is allowed while these images of the ballerina are captured. When the extended shutter speed is employed to capture sufficient light, her kicking leg blurs. The lens' maximum aperture is f/2. The ISO limit for this particular camera has been set at 800. Some limit has been set on the amount of binning. The camera senses that none of these, set at their limits, allow enough light for an acceptable exposure. As a result, the signal processor sends a signal to the shutter 544A, 544B, which increases the duration of the exposure. In this example, enough pixels have changed during the exposure to let the dancer's leg blur. The rest of the pixels, recording her body, did not change. Her body's image is sharp except for the kicking leg.

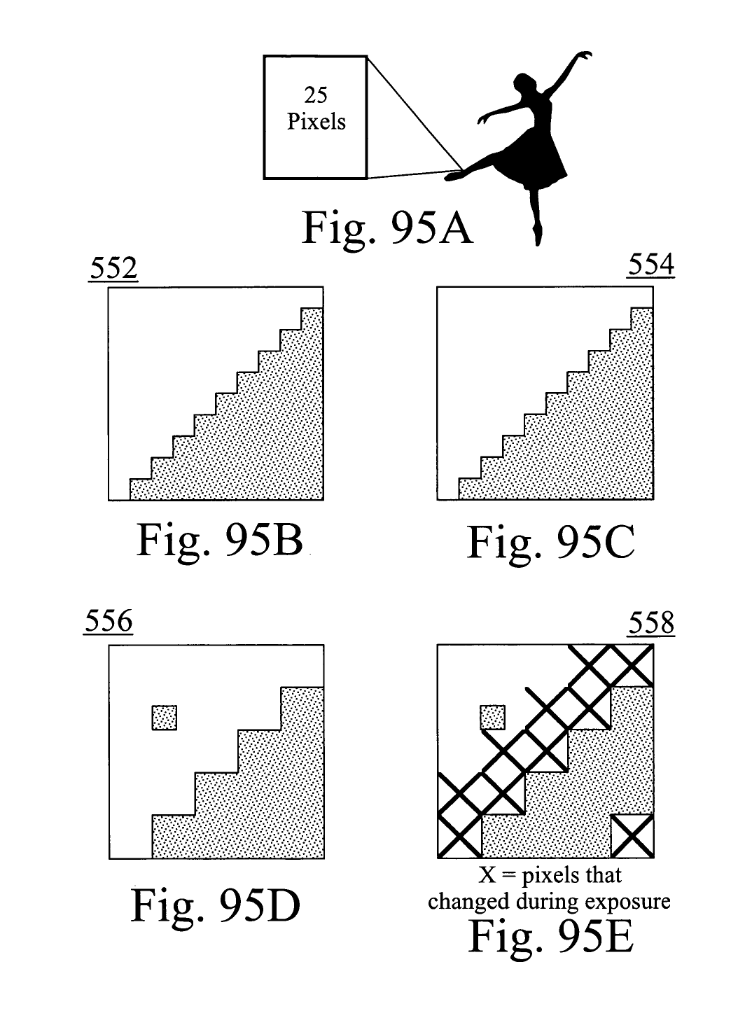

FIGS. 95A, 95B, 95C and 95D depict the images 552, 554, 556 & 558 formed by a group of pixels which correspond to each of the four different lighting conditions shown in FIG. 94. FIGS. 95A, 95B, 95C & 95D each show a tiny section of the image captured by the sensor. This section of the image reveals the ballerina's toe. In the daylight picture, FIG. 95A, the edge of the toe is sharply defined. The settings were 1/250th of a second, f/22, ISO 200, no binning, no flash, no extended shutter speed. In the sunset picture, FIG. 95B, the shutter speed dropped to 1/125th, the aperture opened to f/8 and the ISO stayed at 200. Again, no binning, no flash and no extended shutter speed were used. The edge of the toe remains sharply defined. For the candlelight picture, FIG. 95C, the aperture went wide open at f/2, the speed dropped to 1160th of a second and the ISO jumped up to 400. Again, no binning, no flash and no extended shutter speed were used. The binning begins to show up so the toe will have a less linear edge. One spec, the black spot, appears as a result of noise from the higher ISO. For the moonlight picture, FIG. 95D, the ISO went to 800 and two specs now appear, caused by noise. The shutter setting was over-ridden by the camera when it sensed inadequate light from the ISO, shutter speed and aperture, so it used the extended shutter speed mode, detected little motion overall on the sensor at that instant and so took the picture at ⅛th of a second. The ballerina image will be sharp. She is generally static but kicking out her leg. Her leg will have blurred edges as shown here along the toe.

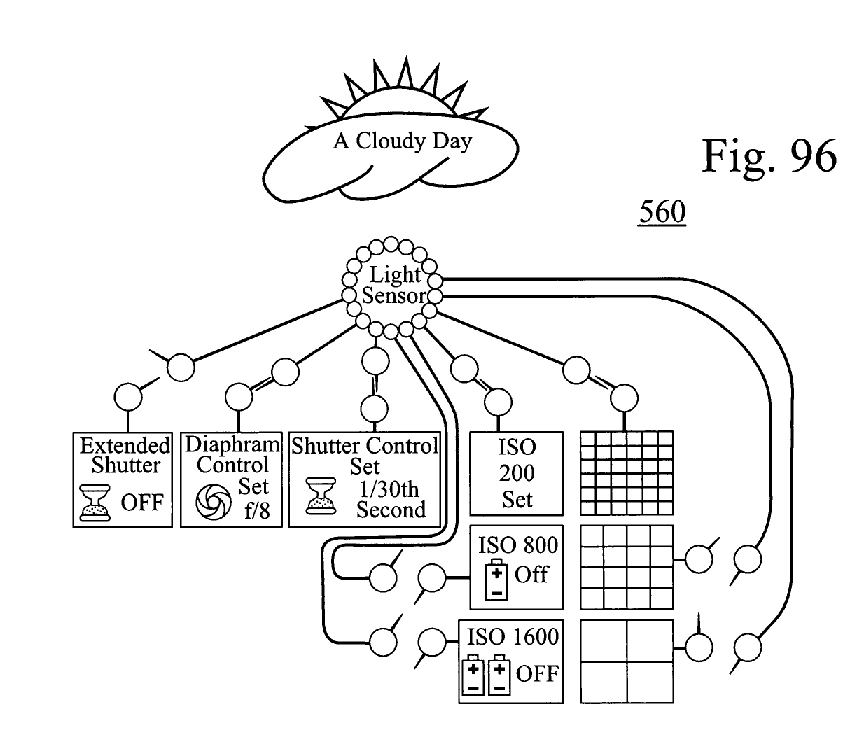

FIG. 96 provides an illustration 560 that shows the effect when the photograph is taken outdoors with clouds limiting the Sun. The photographer knows there's enough light for a good exposure. Or, the camera was pre-set at the factory to sense this condition. In either case, the extended shutter function is turned off and not needed. The aperture is set at a medium opening, f/8. The shutter is set at 1/30 of a second which will be fast enough for an outdoor portrait. The ISO is set at a moderate 200 which creates minimum noise. Since no noise is detected, the binning method is not utilized.

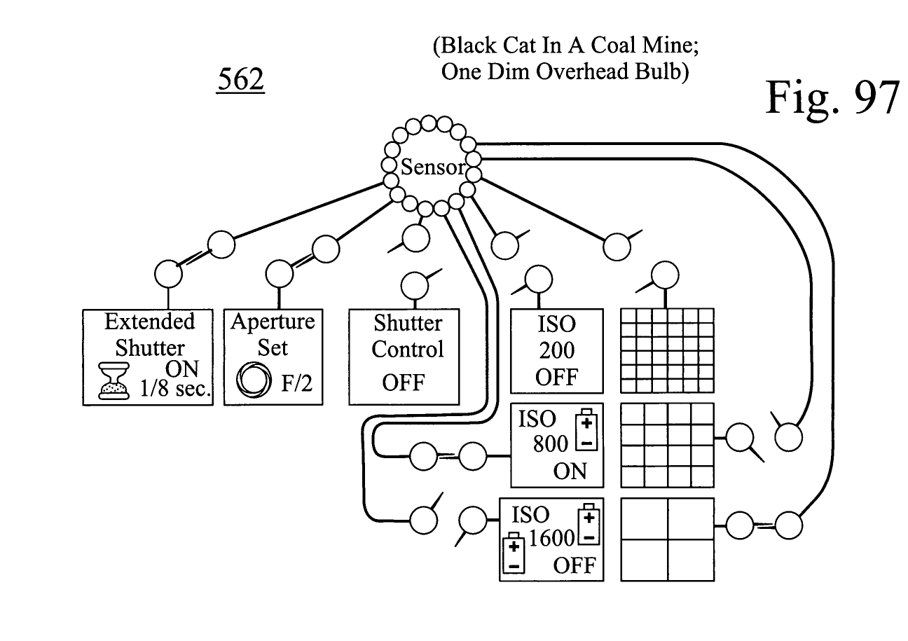

FIG. 97 is an illustration 562 shows an extreme low light situation. There's a black cat in a coal mine. The cat is twenty feet from the photographer. There's a single 30 Watt bulb on the ceiling just above the photographer's head. Either the photographer, or the camera's sensing automation, knows that this is difficult. The extended shutter function is turned on. The aperture goes wide open, for this camera lens, at f/2. The shutter control itself is shut off since the extended shutter will determine the speed to be used by detecting the percentage of pixel changes during the exposure. The camera's sensor, or the photographer, senses just enough light to boost the ISO to 800, which may also be the maximum generally acceptable for this camera model's sensor, or the photographer's taste. The binning, however, takes the pixel count down by nine times. Where there were 36 pixels before there are now four. It also is likely that this is a densely pixilated sensor, which would be susceptible to noise. Therefore, the factor or the photographer, knowing that the images at ISO 200 have excessive detail, chose to bump the binning up significantly. This loses detail from a sensor that normally captures excessive detail.

The exposure is good. The eat's whiskers won't show, but the eyes and tail will be sharp enough. An image is captured that would otherwise be lost. In everyday situations, like a patron sitting quietly in a dimly lit café, this extended shutter time captures a sharper picture than a faster speed could.

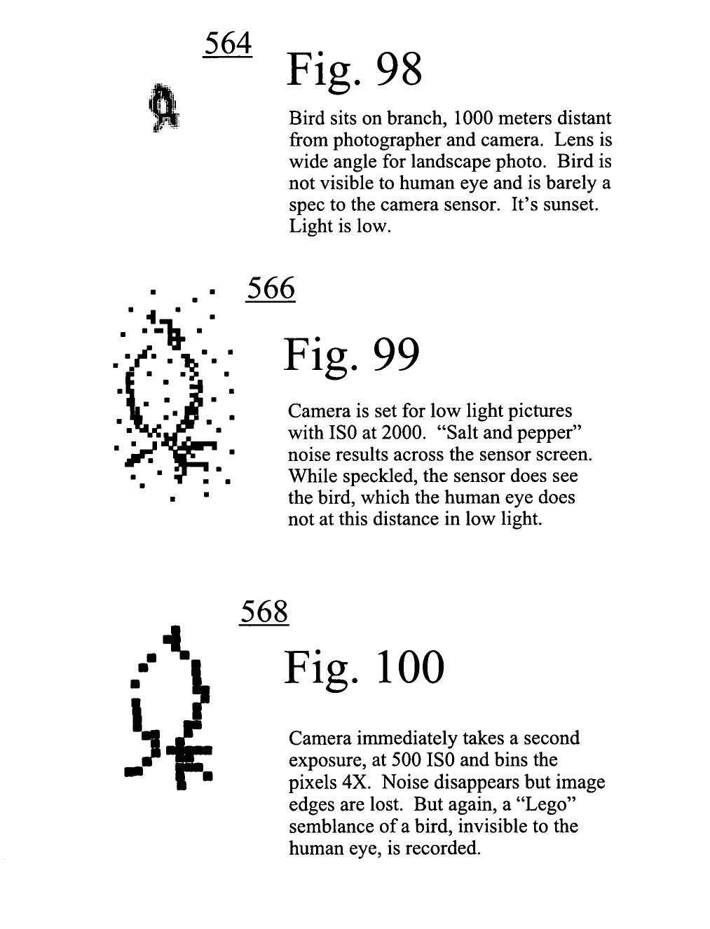

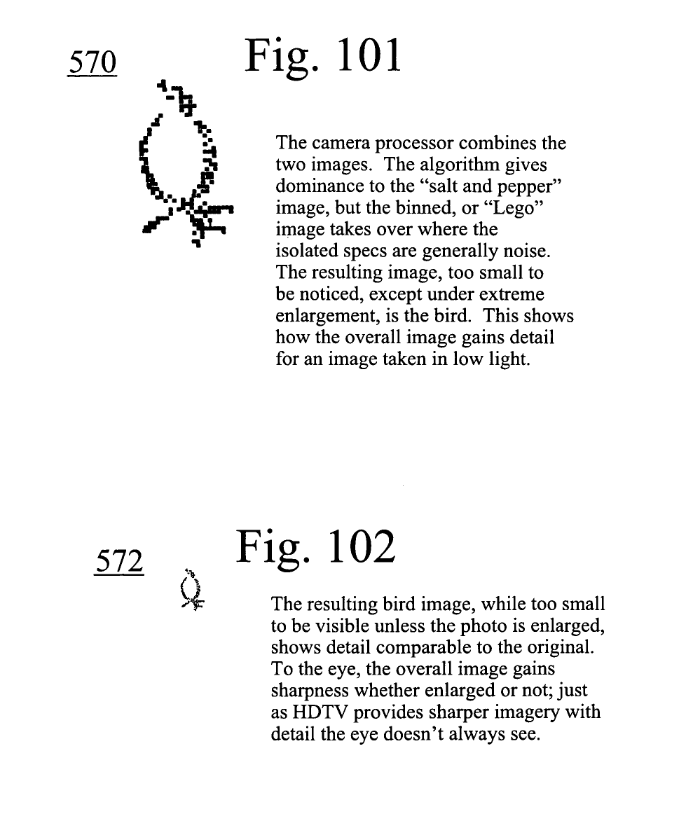

FIGS. 98, 99, 100, 101 and 102 are enlargements 564, 566, 568, 570 and 572 which show a bird at distance. It takes up 1500 pixels. In the average digital camera of 2014, with 8 MP, this means it is covers 1/4000 of the screen. It will not be visible to a human with normal eyesight viewing the picture. But enlarging it here shows the effect of the double exposures, one with high ISO and noise, cleaned up by the recessive second exposure, which changes the image only where a spec of noise is detected. The result is a sharp photo without noise in a low light situation, where capturing the image would otherwise be impossible.

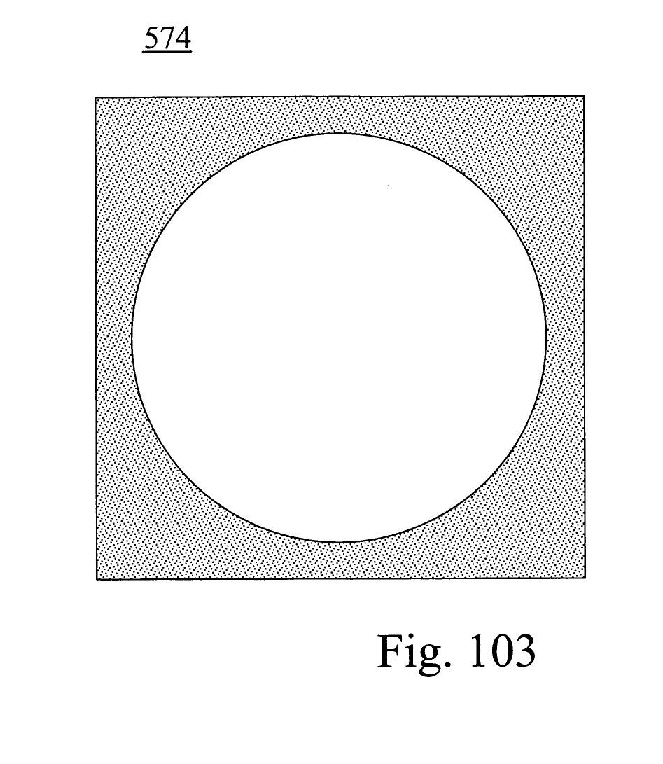

FIG. 103 is an enlarged image 574 of the Moon.

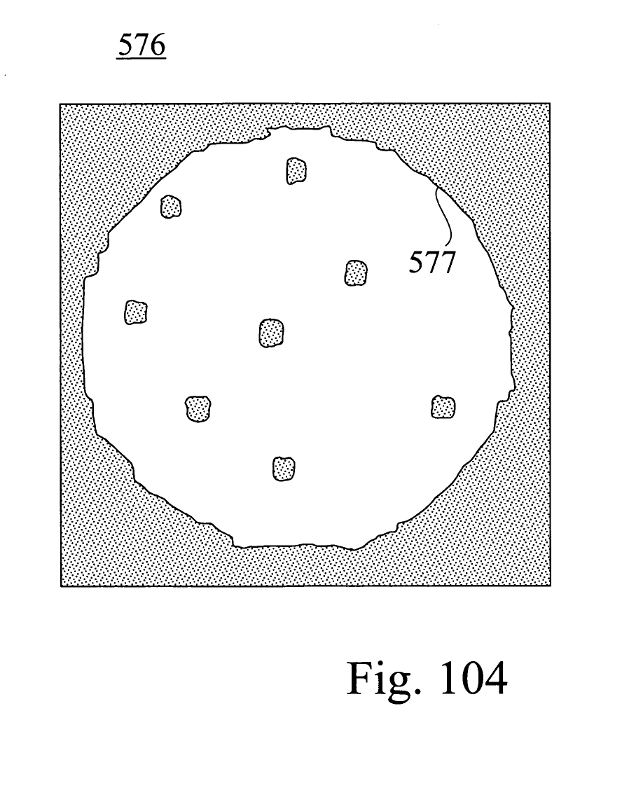

FIG. 104 depicts the Moon's image 576 in an exposure when the ISO is high to compensate for low light. This combination of settings generates noise. The boundary of the image 576 is referred to as the image edge 577.

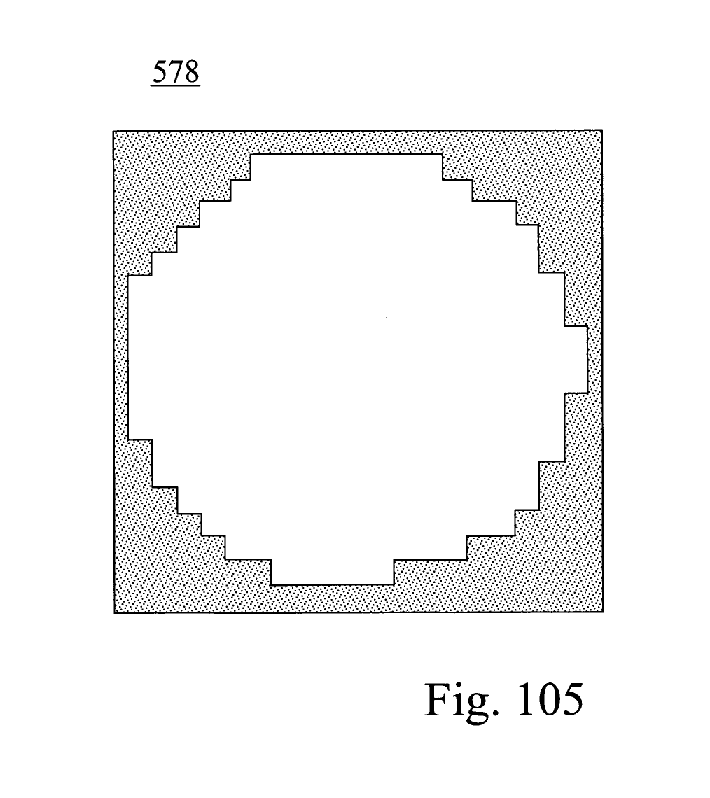

FIG. 105 is an illustration 578 that shows how the Moon's looks in a second exposure with a lower ISO, but the pixels are binned. Noise is reduced, but edge detail is lost.

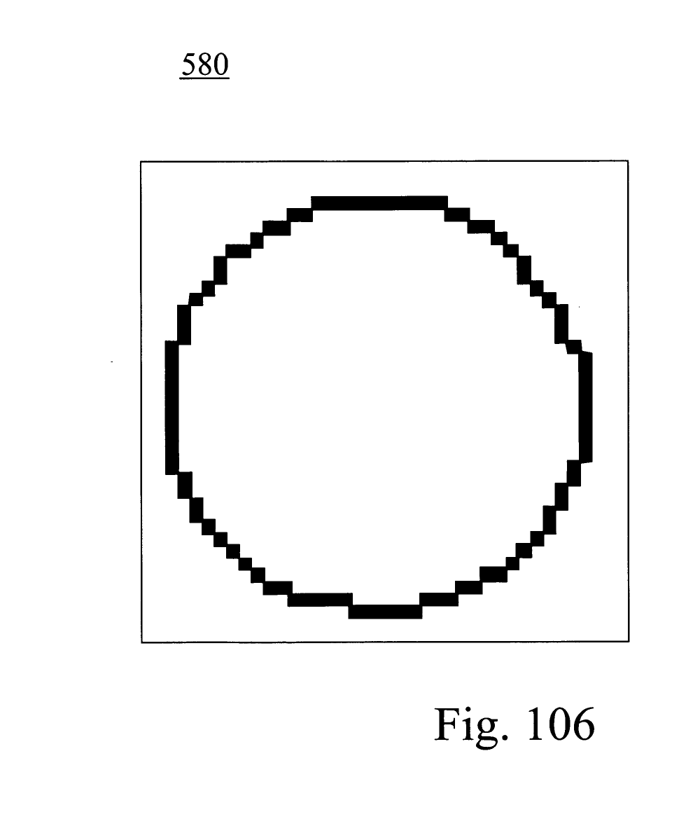

FIG. 106 portrays a template 580 which is formed when the processor isolates the image edges within the high ISO exposure within this tiny portion of the photo.

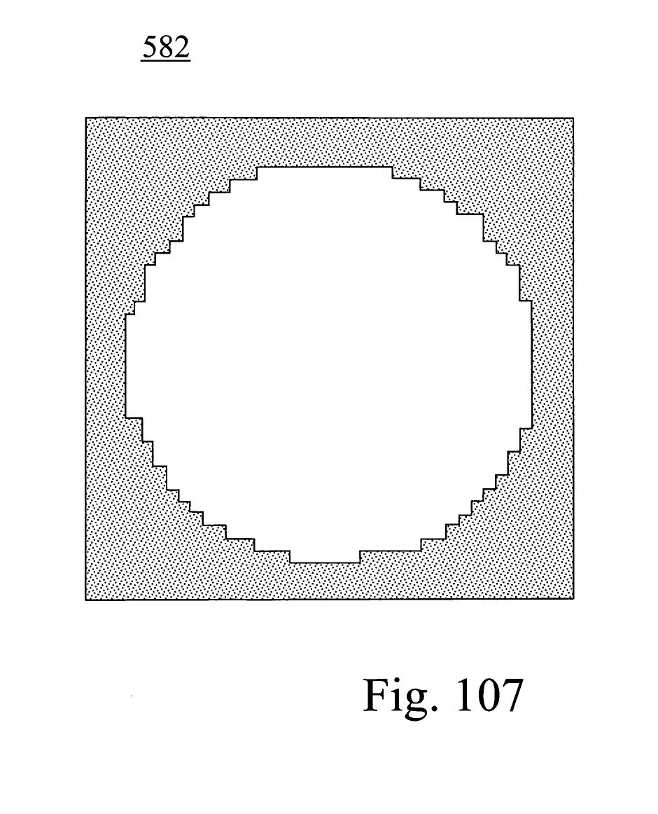

FIG. 107 shows another view of the template 582, which transforms the high ISO image and the binned image into a more accurate photograph than either was by itself, but enlarged, so that the pixel effect is still exaggerated.

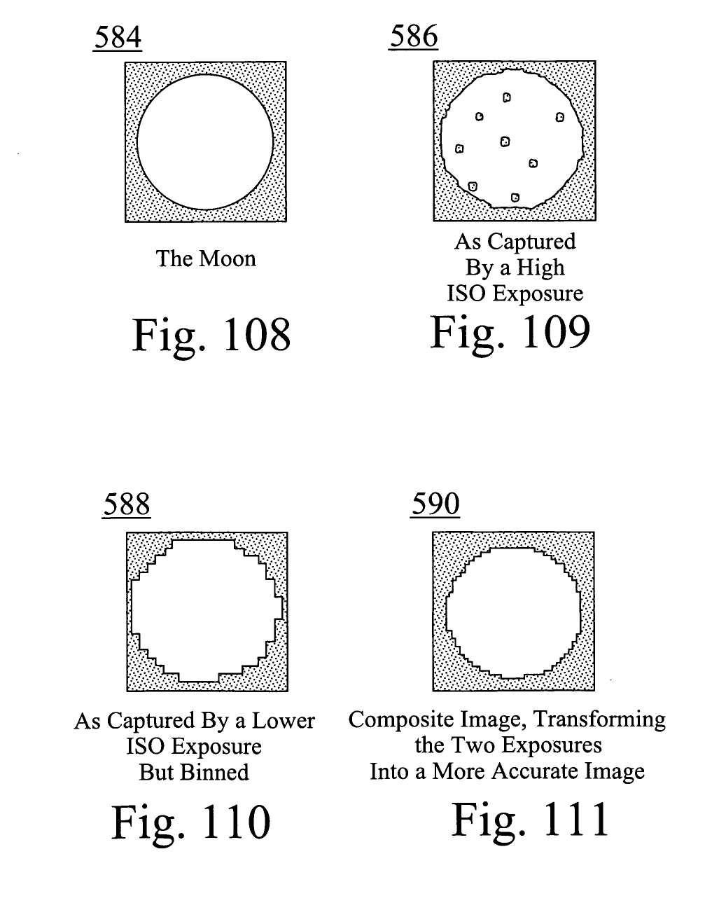

FIG. 108 is an illustration 584 of the reduced, but still enlarged, pixilated Moon.

FIG. 109 is an illustration 586 of the Moon as captured by a high ISO exposure.

FIG. 110 is another illustration 588 of the Moon as captured by a lower ISO exposure, but binned.

FIG. 111 is an illustration 590 that reveals a composite image that transforms the two previous exposures into a more accurate image.

In one embodiment of the invention, the signal processor instructs the shutter 544A, 544B to take a second exposure with a relatively longer exposure time being based on the output sampling.

In another embodiment, a low light exposure duration module 543A, which is connected to said and to the camera display, sends a message which is presented on the camera display 543B. The message is presented during low light conditions, and suggests a range of suggested exposure lengths which will minimize blurring.

In yet another embodiment, the signal processor instructs the shutter 544A, 544B to take a set of two exposures when low light conditions are detected. The second exposure is taken after the first exposure. The first exposure is taken with a relatively high ISO setting to capture a first image. The signal processor then isolates said first image formed after said first exposure to define the edges of said first image. The signal processor bins the pixels during said second exposure to form a second image. Finally, the signal processor combines the first and second images by inserting the second image within the edges of the first image to create a composite photo.

In an alternative embodiment of the invention, the first and second exposures may not be consecutive, meaning that the second exposure may be taken before the first exposure.

In another embodiment of the invention, the first exposure being taken with a relatively low ISO setting to capture the first image.

### SCOPE OF THE CLAIMS

Although the present invention has been described in detail with reference to one or more preferred embodiments, persons possessing ordinary skill in the art to which this invention pertains will appreciate that various modifications and enhancements may be made without departing from the spirit and scope of the Claims that follow. The various alternatives for providing a Enhanced Low Light Photography System that have been disclosed above are intended to educate the reader about preferred embodiments of the invention, and are not intended to constrain the limits of the invention or the scope of Claims.

### LIST OF REFERENCE CHARACTERS

10 Camera with curved sensor
12 Curved sensor
14 Enclosure
16 Objective lens
18 Incoming light
20 Electrical output from sensor
22 Signal processor
24 User controls
26 Battery
28 Memory
30 Camera output
32 Facet
34 Gap between facets
36 Via
38 Backplane
40 Curved sensor formed from adjoining petal-shaped segments
42 Petal-shaped segment
43a First Mandrel
43b Substrate
43c First sheet of deformable material
43d Dome portion of deformable material over mandrel
43e Hemispherical base for curved sensor
43f Second sheet of deformable material
43g Second mandrel
43h Ports
43i Empty region
43j Heater
43k Hemispherical base for curved sensor
43l Sensor after sensor pixels 431 have been formed on the base 43e or 43k.
44 Camera monitor
46 Conventional sensor with generally uniform pixel density
48 Sensor with higher pixel density toward center
50 Pixel
52 Shade retracted
54 Shade extended
56 Multi-lens camera assembly
58 Objective lens
60 Mirrored camera/lens combination
62 Primary objective lens
64 Secondary objective lens
66 First sensor
68 Second sensor
70 Mirror
72 Side-mounted sensor
74 Sensor in original position
76 Sensor in rotated position
78 Sensor in original position
80 Sensor in displaced position
82 Alternative embodiment of sensor
84 Alternative embodiment of sensor
86 Alternative embodiment of sensor
88 Alternative embodiment of sensor
90 View of rear of one embodiment of sensor
92 Spiral-shaped conductor
94 Connection to sensor
96 Connection to processor
98 View of rear of one embodiment of sensor
100 Accordion-shaped conductor
102 Connection to sensor
104 Connection to processor
106 View of rear of one embodiment of sensor
108 Radial conductor
110 Brush
112 Brush contact point
114 Annular ring
116 Center of sensor, connection point to processor
118 Schematic view of wireless connection
120 Transmitter
122 Receiver
124 Processor
150 Camera
154 Enclosure
156 Lens
160 Sensor
162 Facets
164 Gaps
170 Center square
172 Ring of squares
176 Ring of squares
180 Shade extender arrangement
182 Inner shade member
184 Movable shade member
186 Outer, movable shade members
190 Lens moving mechanism
200 Image sequence processor
202 Sensor capture device
204 Auto device
206 Pixel density normalization device
208 Image processing engine
210 Display/LCD controller
212 Compression and storage controller
250 Camera
256 Lens
260 Sensor
270 Central region facet
272 Surrounding region facets
274 Shutter control
280 Lens shade actuator
290 Focus/stabilization actuator
292 Lens moving
300 First embodiment of combined device
300a First embodiment of combined device
300b First embodiment of combined device
302 Housing
304 Micro-controller
305a Front side
305b Back side
306 Display screen
308a Touch screen interface
308b User interface
310 Terminal for power and/or data
314 Speaker
315 Antenna
330 View of alternative embodiment
334 View of alternative embodiment
338 View of alternative embodiment
340 View of alternative embodiment
342 Schematic illustration of moving lens with fixed flat sensor
344 Moving lens
346 Fixed flat sensor
348 Light path
350 Overhead view of FIG. 51
352 Schematic illustration of moving lens with fixed curved sensor
354 Fixed curved sensor
356 Overhead view of FIG. 53
358 Schematic illustration of fixed lens with moving flat sensor
360 Moving flat sensor
362 Fixed lens
364 Overhead view of FIG. 55
365 Schematic depiction of components that impart circular motion to sensor
366 Spinning disc
367 Connecting post
368 Attachment point
370 Electric motor
372 Axis of motor
373 Perspective view of FIG. 57
374 Schematic view of fixed lens over moving curved sensor
376 Moving curved sensor
377 Overhead view of FIG. 59
378 Schematic illustration of components for imparting motion to lens
380 Band
382 Springs
384 Springs connected to cams
386 First cam
388 Second cam
390 First electric motor
392 Second electric motor
394 Series of nine views of rotating sensor
396 Sensor
398 Pixels
400 Lens and sensor combination
402 Lens
404 Flat sensor
406 Central axis
408 Light ray
410 Combination of elements
412 Gaps
414 First exposure
416 Image frame
418 Boy's hand at beginning of exposure
420 Baseball at beginning of exposure
422 Exposure ends
424 Boy's hand at end of exposure
426 Baseball at end of exposure
428 Image at beginning of exposure with image stabilization
430 Image at end of exposure with image stabilization
432 Eye's view of cat
434 Camera sensor
436 Mini-sensor
438 Gaps
440 Cat's image
442 Missing portions of image
444 Portions of cat's image which register with mini-sensors
446 Cross-hatched missing portions
448 Missing portion of image in second exposure
450 Composite image
452 Camera with optical image stabilization
454 Optical image stabilization circuit
456 Camera with electronic image stabilization
458 Flat sensor
460 Electronic image stabilization circuit
462 Electronic image stabilization sensor
464 Actuator
466 Camera with manual zoom and lens shade control
468 Zoom lens
470 Manual zoom control
472 Manually controlled lens shade
474 First embodiment of lens shade control
476 Zoom control
478 Motor
480 First gear mechanism
482 Lens element
484 Motor
486 Second gear mechanism
488 Lens shade
490 Second embodiment of lens shade control
492 Twin track gear mechanism
494 Third embodiment of lens shade control
496 Lever arm
498 Fourth embodiment of lens shade control
500 Single arm lens shade controller
502 Manual zoom and lens shade controller
504 View of black object on white background
506 Black object
508 White background
510 Horizontal and vertical axes
512 View of black object on white background with grid lines
514 Grid lines
516 View of black object on white background showing binned virtual pixels
518 Axes for binned virtual pixels
520 Arcuate array of mini-sensors with corrective optical element
522 Array of mini-sensors
524 Mini-sensor
526 Mini-sensor output
528 Corrective optical element
530 Portion of corrective optical element
532A Large aperture
532B Medium aperture
532C Small aperture
534 100 pixel sample
536 100 pixels binned into 25 pixels
538 Low light photography embodiment
540 Connection between sensor and signal processor
542 Image light captured control
543A Low light exposure duration module
543B Camera display
544A Mechanical shutter
544B Electronic shutter
545 Flow chart illustrating low light exposure photography embodiment
546 Camera display with excess motion warning
548 Camera display with low light warning
550 Lighting conditions, subject photographed, camera settings and resulting images
552 Portion of image taken during daylight shown in FIG. 94
554 Portion of image taken during sunset shown in FIG. 94
556 Portion of image taken in candle light shown in FIG. 94
558 Portion of image taken in moon light shown in FIG. 94
560 Image showing effect when photograph is taken outdoors with clouds limiting the Sun
562 Image showing an extreme low light situation
564 Image of bird, 1000 meters distant
566 Image of bird, first exposure, ISO=2000
568 Image of bird, second exposure, ISO=500
570 Combined first and second images of bird
572 Resulting image of bird
574 Enlarged image of the Moon
576 Moon's image in an exposure when the ISO is high to compensate for low light
577 Edge of image
578 Moon's looks in a second exposure with a lower ISO
580 Template which is formed when the processor isolates the image edges within the high ISO exposure within this tiny portion of the photo
582 Template transformed by the high ISO image and the binned image into a more accurate photograph than either was by itself, but enlarged, so that the pixel effect is still exaggerated
584 Image of the Moon
586 Image of the Moon, high ISO
588 Image of the Moon, low ISO
590 Complete image of the Moon

1. An apparatus comprising:
a camera enclosure;
said camera enclosure including a camera display;
an optical element;
said optical element being mounted on said enclosure;
said optical element for conveying a stream of radiation; and
a curved sensor; said curved sensor including a plurality of pixels;
said plurality of pixels being formed on the side of said curved sensor facing said optical element;
said curved sensor being mounted inside said enclosure;
said curved sensor being aligned with said optical element;
a signal processor connected to each of said plurality of pixels;
a portion of said plurality of pixels being selected for an output sampling;
said output sampling being accomplished by said signal processor;
an image light captured control; said image light captured control being mounted on said enclosure; said image light captured control for establishing an unwanted motion setting which corresponds to a predetermined acceptable level of unwanted motion which may be detected during an exposure;
a shutter means for controlling incident light;
a shutter means control; said shutter means control being connected to said shutter means; said shutter means control for determining the length of an exposure;
said signal processor for automatically increasing the duration of an exposure if said output sampling signal is less than said unwanted motion setting.

2. An apparatus as recited in claim 1, in which:
an output of all the pixels in said plurality of pixels are sampled to detect unwanted motion of an image during an exposure.

3. An apparatus as recited in claim 1, in which:
said sensor generally includes a plurality of segments.

4. An apparatus as recited in claim 3, in which:
said plurality of segments are disposed to approximate a curved surface.

5. An apparatus as recited in claim 3, in which:
said plurality of segments forms a gap between each of said plurality of segments; and
said gap is used as a pathway for an electrical connector.

6. An apparatus as recited in claim 3, in which:
said plurality of segments are joined together at a single common point.

7. An apparatus as recited in claim 3, in which:
said plurality of segments are generally fused together at their edges to form an integral curved surface.

8. An apparatus as recited in claim 1, in which:
said signal processor instructs said shutter means to take a second exposure with a relatively longer exposure time being based on said output sampling signal.

9. An apparatus as recited in claim 1, in which:
said output sampling signal is conducted using generally from one to five percent of said pixels in a single contiguous spot of all of said pixels on said sensor.

10. An apparatus as recited in claim 1, in which:
said output sampling is conducted using a group of pixels that are generally located in the center of said sensor.

11. An apparatus as recited in claim 1, in which:
said output sampling is conducted by computing a average output across a portion of said pixels on said sensor which are illuminated with an image.

12. An apparatus as recited in claim 1, in which:
said output sampling is conducted by computing a median output across a portion of said pixels on said sensor which are illuminated with an image.

13. An apparatus as recited in claim 1, further comprising:
a low light exposure duration module;
said low light exposure duration module being connected to said image light captured control;
said low light exposure duration module also being connected to said camera display;
said low light exposure duration module sending a message to be presented on said camera display during low light conditions; said message including a range of suggested exposure lengths which minimize a blurred image during low light conditions.

14. An apparatus as recited in claim 1, in which:
said signal processor instructs said shutter means to take a plurality of exposures when low light conditions are detected;
said a plurality of exposures including a first and a second exposure;
said first exposure being taken with a relatively high ISO setting to capture a first image;
said signal processor isolating said first image formed after said first exposure to define the image edges within said first image;
said signal processor binning said pixels before said second exposure to form a second image;
said signal processor combining said first and said second images by inserting said second image within the edges of said first image to create a composite photo.

15. An apparatus as recited in claim 1, in which:
said signal processor instructs said shutter means to take a plurality of exposures when low light conditions are detected;
said a plurality of exposures including a first and a second exposure;
said first exposure being taken with a relatively low ISO setting and said plurality of pixels are binned to capture a first image;
said signal processor isolating said first image formed after said first exposure taken at a relatively low ISO;
said second exposure being taken with a relatively higher ISO to define the image edges within said first image;
said signal processor combining said first and said second images by inserting said first image within the edges of said second image to create a composite photo.

16. A method comprising the steps of:
providing a camera enclosure;
providing a camera display affixed to said camera enclosure;
providing an optical element;
said optical element being mounted on said enclosure;
said optical element for conveying a stream of radiation; and
providing a curved sensor;
forming a plurality of pixels on said curved sensor; said plurality of pixels being formed on the side of said curved sensor which faces said optical element;
said curved sensor being mounted inside said enclosure;
said curved sensor being aligned with said optical element;
providing a signal processor; said signal processor being connected to each of said plurality of pixels;
sampling the output of a portion of said plurality of pixels using said signal processor;
providing an image light captured control; said image light captured control being mounted on said enclosure; said image light captured control for establishing an unwanted motion setting which corresponds to a predetermined acceptable level of unwanted motion which may be detected during an exposure; and
providing a shutter means control; said shutter means control for determining the length of an exposure;
said signal processor for automatically increasing the duration of an exposure if said output sampling signal is less than said unwanted motion setting.

17. An apparatus as recited in claim 16, in which:
an output of all the pixels in said plurality of pixels are sampled to detect unwanted motion of an image during an exposure.

18. An apparatus as recited in claim 16, in which:
said sensor generally includes a plurality of segments.

19. An apparatus as recited in claim 16, in which:
said plurality of segments are disposed to approximate a curved surface.

20. An apparatus as recited in claim 18, in which:
said plurality of segments forms a gap between each of said plurality of segments; and
said gap is used as a pathway for an electrical connector.

21. An apparatus as recited in claim 18, in which:
said plurality of segments are joined together at a single common point.

22. An apparatus as recited in claim 18, in which:
said plurality of segments are generally fused together at their edges to form an integral curved surface.

23. A method as recited in claim 16, comprising the additional step of:
using said signal processor to instruct said shutter means to take a second exposure with an exposure time being based on said output sampling signal.

24. A method as recited in claim 16, comprising the additional step of:
conducting said output sampling using generally from one to five percent of said pixels in a single contiguous spot of said pixels on said sensor.

25. A method as recited in claim 16, comprising the additional step of:
conducting said output sampling using a group of pixels that are generally located in the center of said sensor.

26. A method as recited in claim 16, comprising the additional step of:
said output sampling is conducted by computing a average output across a portion of said pixels on said sensor which are illuminated with an image.

27. A method as recited in claim 16, comprising the additional step of:
said output sampling is conducted by computing a median output across a portion of said pixels on said sensor which are illuminated with an image.

28. A method as recited in claim 16, further comprising the steps of:
providing a low light exposure duration module;
said low light exposure duration module being connected to said image light captured control;
said low light exposure duration module also being connected to said camera display;
sending a message from said low light exposure duration module to said camera display during low light conditions; said message including a range of suggested exposure lengths which minimize a blurred image during low light conditions.

29. A method as recited in claim 16, further comprising the steps of:
instructing said shutter means to take a plurality of exposures when low light conditions are detected;
said a plurality of exposures including a first and a second exposure;
taking said first exposure with a relatively high ISO setting to capture a first image;
isolating said first image formed after said first exposure to define the edges of said first image;
binning said pixels during said second exposure at a relatively lower ISO to form a second image;
combining said first and said second images by inserting said second image within the edges of said first image to create a composite photo.

30. An apparatus as recited in claim 16, in which:
instructing said shutter means to take a plurality of exposures when low light conditions are detected;
said a plurality of exposures including a first and a second exposure;
taking said first exposure with a relatively low ISO setting and with said plurality of pixels binned to capture a first image;
isolating said first image formed after said first exposure;
taking said second exposure with a relatively higher ISO;
binning said pixels during said second exposure to form a second image;
combining said first and said second images by inserting said first image within the image edges of said second image to create a composite photo.

31. An apparatus comprising:
a camera enclosure;
said camera enclosure including a camera display;
an optical element;
said optical element being mounted on said enclosure;
said optical element for conveying a stream of radiation; and
a curved sensor; said curved sensor including a plurality of pixels;
said plurality of pixels being formed on the side of said curved sensor opposite said optical element;
said curved sensor being mounted inside said enclosure;
said curved sensor being aligned with said optical element;
a signal processor connected to each of said plurality of pixels;
a portion of said plurality of pixels being selected for an output sampling;
said output sampling being accomplished by said signal processor;
a light intensity limit control; said light intensity limit control being mounted on said enclosure; said light intensity limit control for establishing an unwanted motion setting which corresponds to a predetermined acceptable level of unwanted motion which may be detected during an exposure;
a shutter means for controlling incident light;
a shutter means control; said shutter means control being connected to said shutter means; said shutter means control for determining the length of an exposure;
said signal processor for automatically increasing the duration of an exposure if said output sampling signal is less than said unwanted motion setting.

32. An apparatus as recited in claim 31, in which:
an output of all the pixels in said plurality of pixels are sampled to detect unwanted motion of an image during an exposure.

33. An apparatus as recited in claim 31, in which:
said sensor generally includes a plurality of segments.

34. An apparatus as recited in claim 33, in which:
said plurality of segments are disposed to approximate a curved surface.

35. An apparatus as recited in claim 33, in which:
said plurality of segments forms a gap between each of said plurality of segments; and
said gap is used as a pathway for an electrical connector.

36. An apparatus as recited in claim 33, in which:
said plurality of segments are joined together at a single common point.

37. An apparatus as recited in claim 33, in which:
said plurality of segments are generally fused together at their edges to form an integral curved surface.

38. An apparatus as recited in claim 31, in which:
said signal processor instructs said shutter means to take a second exposure with a relatively longer exposure time being based on said output sampling signal.

39. An apparatus as recited in claim 31, in which:
said output sampling is conducted using generally from one to five percent of said pixels in a single contiguous spot of said pixels on said sensor.

40. An apparatus as recited in claim 31, in which:
said output sampling is conducted using a group of pixels that are generally located in the center of said sensor.

41. An apparatus as recited in claim 31, in which:
said output sampling is conducted by computing a average output across a portion of said pixels on said sensor which are illuminated with an image.

42. An apparatus as recited in claim 31, in which:
said output sampling is conducted by computing a median output across a portion of said pixels on said sensor which are illuminated with an image.

43. An apparatus as recited in claim 31, further comprising:
a low light exposure duration module;
said low light exposure duration module also being connected to said camera display;
said low light exposure duration module sending a message to be presented on said camera display during low light conditions; said message including a range of suggested exposure lengths which minimize a blurred image during low light conditions.

44. An apparatus as recited in claim 31, in which:
said signal processor instructs said shutter means to take a plurality of exposures when low light conditions are detected;
said a plurality of exposures including a first and a second exposure;
said first exposure being taken with a relatively low ISO setting and said plurality of pixels are binned to capture a first image;
said signal processor isolating said first image formed after said first exposure to define the edges within said first image;
said signal processor binning said pixels during said second exposure taken at a relatively lower ISO to form a second image;
said signal processor combining said first and said second images by inserting said second image within the edges of said first image to create a composite photo.

45. An apparatus as recited in claim 31, in which:
said signal processor instructs said shutter means to take a plurality of exposures when low light conditions are detected;
said a plurality of exposures including a first and a second exposure;
said first exposure being taken with a relatively low ISO setting to capture a first image;
said signal processor isolating said first image formed after said first exposure to define the edges within said first image;
said signal processor isolating said first image formed after said first exposure taken at a relatively low ISO to define the image edges within said first image;
said second exposure being taken with a relatively higher ISO;
said signal processor binning said pixels during said second exposure to form a second image;
said signal processor combining said first and said second images by inserting said second image within the edges of said first image to create a composite photo.

46. A method comprising the steps of:
providing a camera enclosure;
providing a camera display affixed to said camera enclosure;
providing an optical element;
said optical element being mounted on said enclosure;
said optical element for conveying a stream of radiation; and
providing a curved sensor;
forming a plurality of pixels on said curved sensor; said plurality of pixels being formed on the side of said curved sensor is opposite said optical element;
said curved sensor being mounted inside said enclosure;
said curved sensor being aligned with said optical element;
providing a signal processor; said signal processor being connected to each of said plurality of pixels;
sampling the output of a portion of said plurality of pixels using said signal processor;
providing an image light captured control; said image light captured control being mounted on said enclosure; said image light captured control for establishing an unwanted motion setting which corresponds to a predetermined acceptable level of unwanted motion which may be detected during an exposure;
providing a shutter means for controlling incident light;
providing a shutter means control; said shutter means control for determining the length of an exposure; and
said signal processor for automatically increasing the duration of an exposure if said output sampling signal is lower than said unwanted motion setting.

47. An apparatus as recited in claim 46, in which:
an output of all the pixels in said plurality of pixels are sampled to detect unwanted motion of an image during an exposure.

48. An apparatus as recited in claim 46, in which:
said sensor generally includes a plurality of segments.

49. An apparatus as recited in claim 46, in which:
said plurality of segments are disposed to approximate a curved surface.

50. An apparatus as recited in claim 48, in which:
said plurality of segments forms a gap between each of said plurality of segments; and
said gap is used as a pathway for an electrical connector.

51. An apparatus as recited in claim 48, in which:
said plurality of segments are joined together at a single common point.

52. An apparatus as recited in claim 48, in which:
said plurality of segments are generally fused together at their edges to form an integral curved surface.

53. A method as recited in claim 46, comprising the additional step of:
using said signal processor to instruct said shutter means to take a second exposure with an exposure time being based on said output sampling signal.

54. A method as recited in claim 46, comprising the additional step of:
conducting said output sampling using generally from one to five percent of said pixels in a single contiguous spot of said pixels on said sensor.

55. A method as recited in claim 46, comprising the additional step of:
conducting said output sampling using a group of pixels that are generally located in the center of said sensor.

56. A method as recited in claim 46, comprising the additional step of:
conducting said output sampling by computing a average output across a portion of said pixels on said sensor which are illuminated with an image.

57. A method as recited in claim 46, comprising the additional step of:
said output sampling is conducted by computing a median output across a portion of said pixels on said sensor which are illuminated with an image.

58. A method as recited in claim 46, further comprising the steps of:
providing a low light exposure duration module;
said low light exposure duration module being connected to said;
said low light exposure duration module also being connected to said camera display;
sending a message from said low light exposure duration module to said camera display during low light conditions; said message including a range of suggested exposure lengths which minimize a blurred image during low light conditions.

59. A method as recited in claim 46, further comprising the steps of:
instructing said shutter means to take a plurality of exposures when low light conditions are detected;
said a plurality of exposures including a first and a second exposure;
taking said first exposure with a relatively high ISO setting to capture a first image;
isolating said first image formed after said first exposure to define the edges of said first image;
binning said pixels during said second exposure at a relatively lower ISO to form a second image;
combining said first and said second images by inserting said second image within the edges of said first image to create a composite photo.

60. An apparatus as recited in claim 46, in which:
instructing said shutter means to take a plurality of exposures when low light conditions are detected;
said plurality of exposures including a first and a second exposure;
taking said first exposure with a relatively low ISO setting to capture a first image;
isolating said first image formed after said first exposure to define the edges of said first image;
taking said second exposure with a relatively higher ISO;
binning said pixels during said second exposure to form a second image;
combining said first and said second images by inserting said second image within the edges of said first image to create a composite photo.

61. An apparatus comprising:
a camera enclosure;
said camera enclosure including a camera display;
an optical element;
said optical element being mounted on said enclosure;
said optical element for conveying a stream of radiation; and
a generally flat sensor; said generally flat sensor including a plurality of pixels;
said generally flat sensor being mounted inside said enclosure;
said generally flat sensor being aligned with said optical element;
a signal processor connected to each of said plurality of pixels;
a portion of said plurality of pixels being selected for an output sampling;
said output sampling being accomplished by said signal processor;
a light intensity limit control; said image light captured control being mounted on said enclosure; said image light captured control for establishing an unwanted motion setting which corresponds to a predetermined acceptable level of unwanted motion which may be detected during an exposure;
a shutter means for controlling incident light;
a shutter means control; said shutter means control being connected to said shutter means; said shutter means control for determining the length of an exposure;
said signal processor for automatically increasing the duration of an exposure if said output sampling signal is lower than said unwanted motion setting.

62. An apparatus as recited in claim 61, in which:
an output of all the pixels in said plurality of pixels are sampled to detect unwanted motion of an image during an exposure.

63. An apparatus as recited in claim 61, in which:
said signal processor instructs said shutter means to take a second exposure with a relatively longer exposure time being based on said output sampling.

64. An apparatus as recited in claim 61, in which:
said output sampling is conducted using generally from one to five percent of said pixels in a single contiguous spot percent of said pixels on said sensor.

65. An apparatus as recited in claim 61, in which:
said output sampling is conducted using a group of pixels that are generally located in the center of said sensor.

66. An apparatus as recited in claim 61, in which:
said output sampling is conducted by computing a average output across a portion of said pixels on said sensor which are illuminated with an image.

67. An apparatus as recited in claim 61, in which:
said output sampling is conducted by computing a median output across a portion of said pixels on said sensor which are illuminated with an image.

68. An apparatus as recited in claim 61, further comprising:
a low light exposure duration module;
said low light exposure duration module being connected to said;
said low light exposure duration module also being connected to said camera display;
said low light exposure duration module sending a message to be presented on said camera display during low light conditions; said message including a range of suggested exposure lengths which minimize a blurred image during low light conditions.

69. An apparatus as recited in claim 61, in which:
said signal processor instructs said shutter means to take a plurality of exposures when low light conditions are detected;
said a plurality of exposures including a first and a second exposure;
said first exposure being taken with a relatively high ISO setting to capture a first image;
said signal processor isolating said first image formed after said first exposure to define the edges of said first image;
said signal processor binning said pixels during said second exposure to form a second image;
said signal processor combining said first and said second images by inserting said second image within the edges of said first image to create a composite photo.

70. An apparatus as recited in claim 61, in which:
said signal processor instructs said shutter means to take a plurality of exposures when low light conditions are detected;
said a plurality of exposures including a first and a second exposure;
said first exposure being taken with a relatively low ISO setting to capture a first image;
said signal processor isolating said first image formed after said first exposure to define the edges of said first image;
said second exposure being taken at a relatively higher ISO;
said signal processor binning said pixels during said second exposure to form a second image;
said signal processor combining said first and said second images by inserting said second image within the edges of said first image to create a composite photo.

71. A method comprising the steps of:
providing a camera enclosure;
providing a camera display affixed to said camera enclosure;
providing an optical element;
said optical element being mounted on said enclosure;
said optical element for conveying a stream of radiation; and
providing a generally flat sensor;
forming a plurality of pixels on said generally flat sensor; said plurality of pixels being formed on the side of said generally flat sensor is opposite said optical element;
said generally flat sensor being mounted inside said enclosure;
said generally flat sensor being aligned with said optical element;
providing a signal processor; said signal processor being connected to each of said plurality of pixels;
sampling the output of a portion of said plurality of pixels using said signal processor;
providing a image light captured control; said image light captured control being mounted on said enclosure; said image light captured control for establishing an unwanted motion setting which corresponds to a predetermined acceptable level of unwanted motion which may be detected during an exposure;
providing a shutter means for controlling incident light; and
providing a shutter means control; said shutter means control for determining the length of an exposure;
said signal processor for automatically increasing the duration of an exposure if said output sampling signal is lower than said unwanted motion setting.

72. An apparatus as recited in claim 71, in which:
an output of all the pixels in said plurality of pixels are sampled to detect unwanted motion of an image during an exposure.

73. A method as recited in claim 71, comprising the additional step of:
using said signal processor to instruct said shutter means to take a second exposure with an exposure time being based on said output sampling signal.

74. A method as recited in claim 71, comprising the additional step of:
conducting said output sampling using a single pixel.

75. A method as recited in claim 71, comprising the additional step of:
conducting said output sampling using a group of pixels that are generally located in the center of said sensor.

76. A method as recited in claim 71, comprising the additional step of:
conducting said output sampling by computing a average output across a portion of said pixels on said sensor which are illuminated with an image.

77. A method as recited in claim 71, comprising the additional step of:
said output sampling is conducted by computing a median output across a portion of said pixels on said sensor which are illuminated with an image.

78. A method as recited in claim 71, further comprising the steps of:
providing a low light exposure duration module;
said low light exposure duration module being connected to said image light captured control;
said low light exposure duration module also being connected to said camera display;
sending a message from said low light exposure duration module to said camera display during low light conditions; said message including a range of suggested exposure lengths which minimize a blurred image during low light conditions.

79. A method as recited in claim 71, further comprising the steps of:
instructing said shutter means to take a plurality of exposures when low light conditions are detected;
said plurality of exposures including a first and a second exposure;
taking said first exposure with a relatively high ISO setting to capture a first image;
isolating said first image formed after said first exposure to define the edges of said first image;
binning said pixels during said second exposure to form a second image;
combining said first and said second images by inserting said second image within the edges of said first image to create a composite photo.

80. An apparatus as recited in claim 71, in which:
instructing said shutter means to take a plurality of exposures when low light conditions are detected;
said plurality of exposures including a first and a second exposure;
taking said first exposure with a relatively low ISO setting to capture a first image;
isolating said first image formed after said first exposure to define the edges of said first image;
taking said second exposure with a relatively high ISO;
binning said pixels during said second exposure to form a second image;
combining said first and said second images by inserting said second image within the edges of said first image to create a composite photo.

81. An apparatus as recited in claim 1, in which
said shutter means for controlling incident light is a mechanical shutter located in the optical train of said camera.

82. An apparatus as recited in claim 16, in which
said shutter means for controlling incident light is a mechanical shutter located in the optical train of said camera.

83. An apparatus as recited in claim 31, in which
said shutter means for controlling incident light is a mechanical shutter located in the optical train of said camera.

84. An apparatus as recited in claim 46, in which
said shutter means for controlling incident light is a mechanical shutter located in the optical train of said camera.

85. An apparatus as recited in claim 1, in which
said shutter means for controlling incident light is an electronic shutter.

86. An apparatus as recited in claim 16, in which
said shutter means for controlling incident light is an electronic shutter.

87. An apparatus as recited in claim 31, in which
said shutter means for controlling incident light is an electronic shutter.

88. An apparatus as recited in claim 46, in which
said shutter means for controlling incident light is an electronic shutter.
